(19) United States
(12) Patent Application Publication
(10) Pub. No.: US 2025/0151721 A1
(43) Pub. Date: May 15, 2025

(54) MOSQUITO ATTRACTANT COMPOSITIONS THAT MIMIC HUMAN ODOR IN THE MOSQUITO BRAIN

(71) Applicant: TRUSTEES OF PRINCETON UNIVERSITY, Princeton, NJ (US)

(72) Inventors: Carolyn S. McBride, Princeton, NJ (US); Zhilei Zhao, Princeton, NJ (US)

(21) Appl. No.: 18/691,806

(22) PCT Filed: Sep. 16, 2022
(86) PCT No.: PCT/US2022/076556

§ 371 Date: Mar. 13, 2024

Related U.S. Application Data
(60) Provisional application No. 63/244,779, filed on Sep. 16, 2021.

(51) Int. Cl. A01N 31/02; A01N 25/02; A01N 35/02; A01P 19/00

(52) U.S. Cl. CPC A01N 31/02; A01N 25/02; A01N 35/02; A01P 19/00

(57) ABSTRACT

Mosquito attractant compositions that mimic the neural activity evoked by real human odor in the mosquito brain. The attractant compositions comprise 1-hexanol and linear long chain aldehydes that mimic human attractant odors and that differentiate humans from other animals. Methods for controlling malaria and dengue virus transmission as well as other diseases that are transmitted using mosquitos as vectors are included as are general methods and devices for attracting, killing, and controlling populations of mosquitos.

### CROSS-REFERENCE TO RELATED APPLICATIONS

This application claims priority to U.S. Patent Application Ser. No. 63/244,779 filed on Sep. 16, 2021, the disclosure of which is incorporated herein by reference in its entirety.

### GRANT REFERENCE

This invention was made with government support under Grant No. NIDCD (R00DC012069) and NIAID (DP2AI144246) awarded by the National Institutes of Health. The Government has certain rights in the invention.

### FIELD OF THE DISCLOSURE

The present disclosure concerns mosquito attractant compositions and methods of using the same.

### BACKGROUND

Mosquitoes serve as vectors for the spread of several diseases that severely impact the health of humans, pets, and livestock. For example, the mosquito is the principal vector responsible for the spread of several viruses pathogenic to humans, including dengue, Zika and yellow fever viruses. Dengue fever is a major public health problem in tropical regions worldwide. The World Health Organization estimates that 51 million infections with the dengue fever occur annually and 2.5-3 billion people are at risk in the 100 countries where dengue fever occurs. There has been a dramatic rise in the number of cases of dengue hemorrhagic fever in Asia, and recently dengue fever has been introduced into Central and South America.

Most mosquito species are generalist biters, but a few have evolved to specialize in biting humans and thus have become dangerously efficient vectors of human disease. Specialist females rely heavily on their sense of smell to discriminate among hosts and strongly prefer human odor over the odor of non-human animals. Vertebrate odors are complex blends of tens to hundreds of compounds that overlap extensively in chemical composition. Human odor in particular is not known to contain any unique odorants, and mosquitoes likely rely on multi-component blends for attraction and discrimination.

A globally invasive form of the mosquito Aedes aegypti is one such mosquito that has evolved to specialize in biting humans. Host-seeking Aedes aegypti females identify humans by smell, strongly preferring human odor over the odor of non-human animals. Exactly how they discriminate, however, is unclear. This presents significant challenges in sensory coding mosquito vector control strategies seek to manage the population of mosquitoes to reduce their damage to human health, economies and enjoyment, and to halt the transmission cycle of mosquito-borne diseases. Mosquito control is a vital public-health practice throughout the world and particularly in the tropics where the spread of diseases, such as malaria, by mosquitoes is especially prevalent.

Many measures have been tried for mosquito control, including the elimination of breeding places, exclusion via window screens and mosquito nets, biological control with parasites such as fungi and nematodes, chemical control with mosquito killing agents, such as pesticides, or control through the action of predators, such as fish, copepods, dragonfly nymphs and adults, and some species of lizards.

In order to allow for the successful control of mosquitoes, for example, when using methods having a direct effect, such as when using chemical or biological agents, it is first necessary to attract mosquitoes so that they are brought into proximity or contact with the relevant agent and, in some cases, to induce the mosquitoes to consume a sufficient amount of that agent in order for it to take effect. To this end, various chemical compounds and formulations have been developed which have a mosquito attractant effect. These compounds and formulations are often combined with mosquito trapping devices, which are designed to lure and retain (e.g. by killing) the mosquito.

Nevertheless, the mosquito attractant formulations known in the art have several limitations. In particular, compounds and formulations known in the art are found to have only a limited attractant effect, which may diminish rapidly over time.

Moreover, known mosquito control agents, such as chemical and biological control agents, often suffer from poor efficacy due to difficulties in ensuring an adequate level of consumption of such agents by the target organism. Thus, there exists a significant need for improved methods for attracting mosquitoes to control their location and to entice them to lethal traps or compounds.

There is a continuing need in the art for compositions and methods for monitoring, affecting the behavior of, and/or controlling mosquito populations, particularly those with a preference for humans.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to those skilled in the art and having the benefit of this disclosure.

FIGS. 1A, 1B, 1C, 1D, 1E, and 1F illustrate the preference of Aedes aegypti mosquitoes for human odor and possible coding mechanisms. 1A and 1B, Response of female Ae. aegypti mosquitoes to human and animal odors in no-choice (A,B) and choice (C,D) olfactometer trials. Bars (or circles) and lines represent means and 95% confidence intervals from beta-binomial mixed models (n=9-14 trials/treatment evenly spread across 6 humans, 2 rats, 2 guinea pigs, 1 quail, wool from 1 sheep, and hair from 4 dogs). Response to exhaled human breath (A, top), synthetic CO₂ (B, top), or unworn control sleeves (B, second from top) was minimal in the absence of human or animal odor. 1E, All olfactory sensory neurons that express the same receptor complex (same shade) send axons to a single glomerulus in the antennal lobe. 1F, Schematics show several ways in which the neural activity evoked by human and animal odors in the antennal lobe may differ, allowing mosquitoes to discriminate between them. Shade of grey indicate different levels of neural activity.

FIGS. 2A, 2B, 2C, 2D, 2E, 2F, 2G, and 2H illustrate novel reagents and methods for imaging Ae. aegypti olfactory circuits. 2A, Gene-targeting strategy used to drive GCaMP6f expression in Orco+ sensory neurons while preserving orco function. 2B, Antibody staining of orco-T2A-QF2-QUAS-GCaMP6f adult female brain, with zoom of antennal lobe (upper right) and 3D reconstruction of ˜34 Orco+ and ˜20 Orco-glomeruli (lower right). Scale bar, 100 μm. 2C, Schematic of mosquito preparation and stack of movies from fast volumetric imaging. 2D, Novel analysis pipeline. The final glomerulus-matching step can be completed manually or via an automated algorithm. 2E, Odour sampling set-ups for live animals/milkweed (top), humans (middle), and animal hair/honey (bottom). 2F, Schematic of two-stage thermal desorption for delivery of complex odour samples. 2G, Verification of the concentration-matching procedure for four representative odour samples. Total volatile content was quantified via GC-MS before (left) and after (right) matching. 2H, GC-MS chromatograms of 5 consecutive puffs of the same human sample demonstrating consistency of blend ratios and absolute abundance. Arbitrary y-axis units not shown.

FIGS. 3A, 3B, 3C, 3D, 3E, 3F, 3G, 3H, and 3I illustrate how human and animal odours activate unique combinations of antennal lobe glomeruli. 3A, Antennal lobe reconstructions highlighting Orco+ glomeruli (top, grey), three focal glomeruli (middle, with a few anterior glomeruli removed to reveal B and A), and the angle from which they are viewed in 3D renderings (bottom). H, human-sensitive; B, broadly tuned; A, animal-sensitive. 3B, 3C, and 3D, 3D renderings of the response of a single representative female mosquito to human, rat, and sheep odour. Arrowheads indicate focal glomeruli from (A). Dashed circles outline glomeruli responding strongly at 5× total concentration. 3E and 3F, Mean response of focal glomeruli to stimuli in 3B, 3C, and 3D as heat map (3E) or relative activation of each glomerulus (3F; dot size, dose; shading around dots, SEM). n=4 mosquitoes. 3G, 3H, and 3I, Same as 3E and 3F but showing response to the odour of 8 individual humans, 5 animal species, and 2 nectar stimuli at 1× total concentration. n=5 mosquitoes. Human subject numbers correspond to those in FIGS. 4A and 4B. Neural responses were quantified by integrating the area under df/f curve and normalizing to highest response in each brain.

FIGS. 4A, 4B, 4C, 4D, and 4E illustrate how human and animal odour blends differ in the relative concentration of key compounds. 4A, Odour profiles for humans, animals, and nectar-related stimuli. Named compounds made up >10% of at least one sample or an average of >1% across samples. Question marks indicate tentative identifications. Animal samples were pooled by species prior to analysis (n=4 dogs, 2 guinea pigs, 1 sheep, 2 rats, 2 quail). Numbers beneath human samples indicate those used for imaging (FIGS. 3G and 3H). 4B, Unscaled principal components analysis of host odour data from 4A. 4C, Top ten loadings on first two principal components from 4B. 4D, Proportion of human sebum made up of sapienic acid and squalene. Oxidation of the two lipids produces volatile compounds enriched in human odour. 4E, P-values from Kolmogorov-Smirnov tests for a difference in the relative abundance of each odorant between humans and animals (with Benjamini-Hochberg multiple test correction). Values extend up or down from zero for human- or animal-biased odorants, respectively. Dashed lines mark P=0.05.

FIGS. 5A, 5B, 5C, 5D, 5E, 5F, and 5G illustrate how tuning of focal glomeruli to major host odorants can explain response to blends. 5A, Single-odorant delivery system and procedure used to calibrate vapour-phase concentrations. 5B, Vapour-phase concentration of 3-sec puffs of major human odorants (delivered singly or as a ‘combo’ mixture) calibrated to match those found in 1× human odour (vertical lines). Arbitrary units (a.u.) reflect GC-MS peak area. Odorant names as in 5C. Acetoin was excluded from the mixture (dark grey arrowhead). n=4-5 puffs. 5C, Mean normalized response to stimuli from 5B, n=4 mosquitoes. 5D, Time traces for H response to aldehydes and combo from 5B and 5C plus 1× human odour delivered by thermal desorption. 5E, 3D rendering of the response to the combo, acetoin, and 1× human odour in a representative mosquito. Arrowheads point to H (top-most) and B (bottom-most). 5F, Mean normalized response to single-odorant stimuli delivered at equal vapour-phase concentrations. Dots before names indicate human-biased and animal-biased compounds from our blends. n-4-5 mosquitoes. 5G, Time traces for H response to aldehydes from 5F. Bars/black lines in 5B and lines/grey shading in 5D and 5G indicate mean±SEM.

FIGS. 6A, 6B, 6C, 6D, 6E, 6F, 6G, 6H, 6I, 6J, 6K, 6L, and 6M illustrate how activation of the H glomerulus enhances host-seeking behavior. 6A, Human and animal odor can be reliably separated by a simple neural code, wherein animal odor strongly activates B, but human odor strongly activates both B and H. 6B, Single-trial data from the blend-imaging experiments (FIG. 3) illustrating separation of human and animal odor based on signalling in B and H. Darker symbols, variable doses (FIG. 3E); lighter symbols, 1× dose (FIG. 3H); 6C, Neural responses to 1-hexanol, decanal and their binary mixture at concentrations calibrated to activate B and H glomeruli at approximately equal levels, as does odor from a representative human. 6D, Wind-tunnel flight arena. 6E, Example single-mosquito flight trajectories. 6F, 6G, 6H, 6I, 6J, 6K, 6L, and 6M, Response of female mosquitoes to increasing concentrations of the binary blend (6F, 6G, 6H and 6I) or the ⅕× binary blend and its individual components (6J, 6K, 6L, and 6M). Responses quantified as fraction mosquitoes reaching various positions within the wind-tunnel (6F and 6J), fraction showing at least a single bout of host-seeking flight according to a human observer (6G and 6K) or an automated analysis (6H and 6L), and the number of 10-second segments during which each mosquito showed host-seeking flight per the automated analysis (61 and 6M; horizontal/vertical lines show median/quartiles). Survival analysis (6F and 6J) chi-square (6G, 6H, 6K, and 6L), and Mann-Whitney (61 and 6M) tests compare binary blend to solvent (6F, 6G, 6H, and 6I) or binary blend to each individual component (6J, 6K, 6L, and 6M). n=30 mosquitoes/treatment. *, P<0.05; **, P<0.01; ***, P<0.001.

FIGS. 7A, 7B, 7C, 7D, 7E, 7F, 7G, 7H, 7I, 7J, 7K, and 7L illustrates how orco-T2A-QF2-QUAS-GCaMP 6f labels chemosensory neurons in peripheral organs that project to the brain. 7A, 7B, and 7C, Antibody staining in female (7A and 7B) and male (7C) brains showing GCaMP in sensory neurons that innervate the antennal lobe (AL) and suboesophageal zone (SEZ). SEZ in 7B and the inset of 7C are viewed from posterior to better visualize GCaMP signal. 7D, 7E, 7F, and 7G, Intrinsic GCaMP fluorescence in sensory neurons of adult female antenna (7D), maxillary palp (7E), labella (7F) and larval antennae (7G, arrowheads). All scale bars 100 μm.

FIGS. 8A, 8B, 8C, 8D, 8E, 8F, and 8G illustrate automated analysis of volumetric antennal lobe imaging data. 8A, 8B, and 8C, Analysis pipeline schematic. After registration and unsupervised segmentation of all brains in a given data set (8A), one brain was chosen as the reference and glomeruli from other brains were matched to those in the reference either manually (8B) or using an automated pipeline (8C). Shades in (8B, and 8C) show matched glomeruli (unmatched in white). 8D, Reference odorants were chosen from among 60 candidates based on their ability to account for a large part of the observed signal variance/neural activity. 8E, Response of glomeruli from one mosquito to the final 14 reference odorants delivered at high concentrations. 8F, Evaluation of automated glomerulus matching. Glomeruli from 6 brains were matched as in 8C. 8G, Same as 8F except showing the mean of the observed distribution (line) and the distribution of means from 2000 shuffled datasets.

FIGS. 9A, 9B, 9C, 9D, 9E, 9F, and 9G provide characterization of the thermal-desorption odour-delivery system. 9A, Puff shape for hexanal, measured with a photoionization detector (PID) at the location of mosquito antennae in imaging set-up (n=3 puffs). Time-0 indicates the onset of focusing-trap desorption. It takes ˜3 sec for the desorbed odour to reach the mosquito. 9B, Puff shape for hexanal, methyl laurate, and their mixture, showing that the temporal dynamics of odour release are similar for odorants with markedly different volatility (n=3 puffs each). 9C, Puff shape for human odour delivered via thermal desorption and detected using a PID. 9D, GC-MS traces showing the composition of replicate puffs of human odour collected for a period of 10, 20, 40, or 85 seconds following the onset of trap desorption. Inset shows focusing-trap temperature across each interval. 9E, Fraction of major aldehydes that were released within the given intervals (calculated from 9D). 9F, Schematic of process for pooling (‘stacking’) odour samples and matching their concentrations before use in imaging. 9G, Concentration of five replicate puffs of hexanal delivered from each of four sample tubes (different shades) demonstrating repeatability of the delivered stimulus.

FIGS. 10A, 10B, and 10C illustrate temporal features of glomerular response to complex odour extracts. 10A, Response of three target glomeruli to 1× concentrations of the given stimuli. Lines and grey shading show mean±SEM response (n=5 mosquitoes). Arrows under each trace mark desorption (heating) onset. Y-axis scale bars indicate normalized df/f. 10B, Overlay of H responses from 10A to distinguish the early and late peaks. 10C, Correlations between the area under the peaks in 10B and the relative abundance of major aldehydes in the respective stimuli. Dashed lines show linear regressions. The early H peaks are significantly correlated with the abundance of medium-chain aldehydes (which are fully released within the first 10 sec), while late H peaks are correlated with the abundance of long-chain aldehydes (which take 20-40 sec to fully desorb). Taken together, the biphasic response of the H glomerulus is therefore likely caused by the different release dynamics of medium- and long-chain aldehydes.

FIGS. 11A, 11B, 11C, 11D, and 11E illustrate automated analysis of response to human and animal odours is consistent with targeted analysis of B, H, and A glomeruli. 11A, Human and animal odors were cleanly separated along the first three axes of an across-matrix PCA of unmatched signal clusters from all mosquitoes. Symbols denote individual mosquitoes (n=5); shades of grey (as opposed to black) denote odor from different human subjects (n=8). 11B, 11C, 11D, and 11E, Human and animal odors were also cleanly separated in an analysis of signal clusters matched by the automated algorithm. 11B shows signal clusters from the segmented antennal lobe of the reference mosquito, with key glomeruli highlighted. 11C shows the mean normalized response to odor extracts (top) and select reference odorants (bottom) for those signal clusters (numbered across the bottom) that could be 1577 matched in the brains of at least 3 of 5 mosquito replicates. 11D and 11E show a principal components analysis of data from 11C.

FIGS. 12A, 12B, 12C, 12D, 12E, 12F, 12G, and 12H illustrate quantitative analysis of human and animal odors. 12A, Analysis pipeline for GC-MS data. 12B, Total number of compounds found in each odour extract. 12C, Number of compounds found exclusively in the given combination of odour extracts. 12D, Cumulative distribution of odorants in each odour profile. 12E, Unscaled principal components analysis of human and animal odour profiles including 2-4 replicate odour extractions for three of the human subjects. The subjects with replicate data are denoted by triangles, squares, and diamonds, respectively; all other subjects are represented by light grey circles. 12F, Violin plots showing on a log scale the relative abundance of odorants that passed the significance threshold in FIG. 4E. 12G and 12H, Alternative analysis of human and animal odours using the program xcms, which matches the component ions of compounds across samples.

FIGS. 13A, 13B, and 13C illustrate the design and characterization of the single-odorant delivery system. 13A, Design schematic. Filtered air is split into 5 streams, each regulated by a mass flow controller (MFC). The humidified carrier stream flows continuously through the mixing manifold to the mosquito. 13B, Shape of odour puffs delivered by the system, featuring fast rise/decay and stable peak height. Five replicate 3-sec puffs of 2-heptanone (10-2 in paraffin oil) were aligned to the command onset (time=0). 13C, Long-term stability of odour puffs delivered by the system. A 3-sec puff of 2-heptanone (10-2) was delivered every 5 min for 75 min.

FIGS. 14A, 14B, and 14C illustrate the response of three target glomeruli to single odorants. 14A, Mean response to major components of human odour delivered at their respective concentrations in a 1× human sample. Combo is a mix of all the individual components except acetoin. 14B, Mean response to individual odorants delivered at equal vapour-phase concentration (but see a few exceptions in 14C). 14C, Vapour-phase concentration (estimated via GC-MS peak area, arbitrary units) of single-odorant puffs coming off the headspace of a 10-2 v/v liquid dilution or an adjusted dilution calibrated individually for each odorant to generate a uniform target vapour-phase concentration (vertical lines). Bars and black lines indicate mean±SEM (n=2-11 replicate puffs per odorant). Odorants ordered as in 14B. Light-grey bars in 14C indicate high or low volatility odorants for which the 10-2 data are an extrapolation from a different initial, pre-calibration dilution (anywhere from neat to 106 v/v), which was necessary to match the dynamic range of the GC-MS.

FIGS. 15A, 15B, 15C, 15D, 15E, 15F, 15G, and 15H provide support for analyses of the wind tunnel experiments. 15A, 15B, 15C, and 15D, Data supporting the automated analysis of host seeking presented in FIG. 6. 15A, Flight parameters for the identification of host-seeking behaviour. Values of all variables were standardized as z-scores, making the plotted regression coefficients directly comparable. Dots and lines indicate mean±SEM. 15B, Distribution of proportion-in-plume z-scores for human-worn sock and solvent segments. 15C and 15D, Flight trajectories for individual mosquitoes visualized as the proportion of each consecutive 10-second segment spent in the plume. 15E, 15F, 15G, and 15H, Complementary analysis of wind-tunnel data that identifies host-seeking segments based on k-means clustering with all 5 flight variables.

FIGS. 16A, 16B, 16C, 16D, 16E, 16F, and 16G illustrate antennal lobe response to human and animal odours during pan-neuronal imaging. 16A, Antibody staining of mosquito antennal lobe in an animal expressing jGCaMP7s under the control of the brp pan-neuronal driver. All glomeruli are strongly labelled with jGCaMP7s. Scale bar 50 μm. 16B, AL reconstruction from confocal imaging highlighting Orco+ and Orco-glomeruli (top), five focal glomeruli discussed below (middle), and the viewing angle used in 16C (bottom). 16C, 3D renderings of the response of a single representative female mosquito to human, rat, and sheep odour. Dashed circles outline glomeruli that responded strongly at 5×. Arrowheads highlight key glomeruli, including an non-Orco glomerulus adjacent to H that responded strongly to both human and animal odour in most replicate mosquitoes. 16D, 16E, 16F, and 16G, Automated analysis of pan-neuronal imaging data, showing segmented antennal lobe of the reference mosquito 16D, mean normalized response for all signal clusters that could be matched in the brains of at least 3 of 4 replicate mosquitoes 16E, and principal components analysis of mean responses 16F and 16G. Dark and light shades highlight source and shadow clusters, respectively, in 16E and 16G.

FIGS. 17A and 17B depict correlations between preference for individual humans and their aldehyde profiles. 17A, Relationship between the extent to which a given human subject was ‘preferred’ (over animals in live-host preference assays) and the long-chain aldehyde content of the subject's body odour. The long-chain aldehyde index is the ratio of long-chain aldehydes to total aliphatic aldehydes in a subject's body odour. Dashed line indicates the average index across the n=16 humans analysed in FIG. 4A. 17B, Same as 17A, except x-axis now represents the difference between a subject's long-chain aldehyde index and the average human index (arrows in 17A). Line shows linear regression.

### SUMMARY

Provided herein are mosquito attractant compositions that mimic the neural activity evoked by human odor in the mosquito brain and differentiation humans from other vertebrate animals. In an embodiment, the formulation comprises a first component capable of activating a broadly-tuned glomerulus of a mosquito, a second component capable of activating a human-sensitive glomerulus of the mosquito, and a solvent. In some embodiments, the first component is 1-hexanol. In some embodiments, the second component is a long chain aldehyde.

According to the disclosure human odor is particularly enriched for the ketones sulcatone, and geranylacetone. Human odour also stands out for its high relative abundance of the long-chain aldehyde decanal (10 carbons) and low relative abundance of the short-chain aldehydes hexanal and heptanal (6 and 7 carbons) as compared to other animal odors. Interestingly, the two ketones and decanal are the respective breakdown products of squalene and sapienic acid, unique components of human sebum that may play a role in skin protection and could provide other potential odorant compounds. Thus, in an embodiment the attractant compositions of the disclosure include one or more of a long-chain aldehyde. In some embodiments, the long-chain aldehyde is decanal. In some embodiments, the attractant composition further comprises sulcatone and/or geranyl acetone.

The present disclosure also provides methods for controlling malaria and dengue virus transmission as well as other diseases that are transmitted using mosquitos as vectors, comprising the step of applying a composition described herein in an area where the mosquitoes are to be controlled. In specific embodiments, the mosquitoes comprise Anopheles and/or Aedes mosquitoes. In more specific embodiments, the Anopheles mosquitoes comprise Anopheles gambiae mosquitoes. In other embodiments, the Aedes mosquitoes comprise Aedes aegypti mosquitoes.

In another aspect, the disclosure provides a mosquito trap comprising a trapping chamber or adhesive, and a composition comprising 1-hexanol, an aldehyde component of one or more aldehydes, and a solvent, the composition positioned to attract the mosquito.

### DETAILED DESCRIPTION

So that the present disclosure may be better understood, certain terms are first defined.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “about” refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from an initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

“Mosquito” as used herein encompasses any type of mosquito (e.g., Anopheles, Aedes, Ochlerotatus, and Culex), including but not limited to Tiger mosquitoes, Aedes aborigines, Aedes Aegypti, Aedes albopictus, Aedes cantator, Aedes sierrensis, Aedes sollicitans, Aedes squamigeer, Aedes sticticus, Aedes vexans, Anopheles quadrimaculatus, Culex pipiens, Culex quinquefaxciatus, and Ochlerotatus triseriatus.

The term “substantially free” may refer to any component that the composition of the disclosure or a method incorporating the composition lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, references to the compounds hexanal, heptanal, octanal, nonanal, decanal, and undecanal will be understood to refer the linear (i.e. non-branched) aldehydes, which may alternatively be referred to as n-octanal, n-nonanal and n-decanal, respectively.

Disclosed herein are mosquito attractant compositions that mimic human odor in the mosquito brain. These compositions may be formulated as mosquito attractants as well as repellents. The disclosed methods may be employed to attract and trap mosquitoes, as a method of mosquito control. The pattern of activity recorded in the mosquito brain when exposed to human odor can further be used to develop additional mosquito attractants and repellents.

It is known that host-seeking mosquitoes are most attracted to a blend of compounds with characteristic ratios, rather than single compounds. However, it is difficult to rationally design mosquito attractants that are composed of a blend of compounds, since the number of combinations of compounds is virtually infinite, and not all compounds are detected by mosquitoes and therefore contribute to the host-seeking behavior.

The present disclosure solves this problem by utilizing the pattern of neural activity in the brain of mosquitoes when exposed to human and animal odor. It was observed that Aedes aegypti mosquitoes strongly prefer human odor over animal odor. Genetic reagents and imaging methods to record neural activity in the olfactory center of mosquito brain were developed. It was found that human odor has unique and robust representation in the mosquito brain, compared to animal odor. Two components of human odor (long-chain aldehydes decanal and undecanal) help generate the unique representation of human odor. A synthetic binary blend that mimics human odor in the mosquito brain was formulated. It was demonstrated with wind-tunnel experiments that this blend is attractive to mosquitoes and evokes strong hostseeking behavior. It may be effective as a mosquito attractant in the field.

### Compositions

In an embodiment, the mosquito attractant that mimics human odor in the mosquito brain has the following recipe:

TABLE 1

| | | | Dilution Ration |
|---|---|---|---|
| Compound | CAS | Solvent | (v:v) |
| Decanal | 112-31-2 | Paraffin oil | 8.27E−4 |
| 1-hexanol | 111-27-3 | Paraffin oil | 1.30E−4 |

In some embodiments, the mosquito attractant has components that activate 2 key sets of neurons in the mosquito brain. One having skill in the art would understand from the present disclosure that the information disclosed herein may be used to develop additional mosquito attractants (activate both sets of neurons) and repellents (inhibit one or both sets of neurons). It is possible to add other compounds to enhance activation of the odorant receptor (OR) pathway or activate the ionotropic receptor (IR) pathway to evoke more robust host-seeking behavior. Thus, the composition is not limited to the formulation presented in Table 1.

The mosquito attractant formulations include an aldehyde component enriched in long chain linear fatty aldehydes that mimic human odor. These include aldehydes with a C8 to C11 carbon chain length, including but not limited to octanal, nonanal, decanal and/or undecanal. In an embodiment the composition includes lesser amounts or are substantially free of hexanal and heptanal. The total aldehyde component includes 50 wt. % or more of one or more C8 to C11 carbon chain aldehydes which mimic human odors as compared to C6 and/or C7 aldehydes which mimic the odors of other vertebrate animals such as quail, rat, guinea pig, sheep, or dog. in further embodiments, the aldehyde component comprises at least decanal and/or undecanal. In a preferred embodiment the composition is free of terpenes such as limonene and pinene typically associated with nectar odors.

The compositions may further include a ketone component which is typically enriched in human odors including one or more of sulcatone and/or geranylacetone.

The composition may comprise a blend of compounds. When more than one compound is used, the compounds may be present in effective ratios. For example, the compounds may be present in a ratio similar to that found in nature, as described herein. For example, the composition may comprise a blend of sulcatone, geranylacetone, decanal and undecanal in weight ratios that mimic those of typical human odor. Using more than one compound may extend the range of effective dosages and/or may reduce the amount of total attractant or of a specific attractant effective to attract and/or arrest mosquitoes.

The composition may be provided in a concentrated form (i.e., in a form that requires dilution prior to use, or which is diluted upon delivery to the site of use) or in a dilute form that is suitable for use in the methods without dilution.

The Examples include detail as to how one would go about determining the dose-response of attractant by particular species of mosquitoes as a function concentration. Thus, using the teachings provided herein, it is well within the ability of one skilled in the art to determine an effective concentration for use in the methods of the disclosure.

For example, the methods of the disclosure, which optionally may be carried out using the compositions of the disclosure, may employ final concentrations of at least about 1 ng, at least about 10 ng, at least about 100 ng, at least about 0.001 mg, at least about 0.01 mg, or at least about 0.1 mg with respect to a single compound or the total of two or more compounds. The composition may comprise less than about 1 mg, less than about 0.1 mg, less than about 0.01 mg, less than about 0.001 mg, less than about 100 ng, or less than about 10 ng of total compound. The methods may employ compounds in a concentration of from about 1 ng to about 100 ng of total compound. The methods may employ final concentrations of compound at the target of at least about 0.03 ng/ml, at least about 0.3 ng/mL, at least about 3.0 ng/ml, or at least about 30 ng/mL. The methods may employ compound in a final concentration of at the target of less than about 300 ng/mL, less than about 30 ng/ml, or less than about 3.0 ng/mL. The methods may employ compound such that the final concentration of compound at the target is about 0.03 to about 3.33 ng/mL.

The skilled person will understand that references herein to a mosquito attractant effect (or to formulations capable of mosquito attraction, mosquito lures or bait, and the like) will refer to an ability to alter the behavior of one or more mosquitoes such that their direction of travel is altered by movement thereto.

For example, such a mosquito attractant effect may be characterized by an increase in the propensity of a sample of mosquitoes to travel in a direction as affected by the presence of the substance(s) (e.g. the formulation, such as the formulation of the first aspect of the invention) having that effect.

Such an increase may be qualitative (e.g. an observation of a general change in mosquito behavior) or, in particular, may be quantitative (i.e. measurable). In such circumstances, such an effect may be characterized by at least a 10% (e.g. at least a 20%, such as at least a 30% or, particularly at least a 50% or, more particularly, at least a 100%) increase in the propensity of a sample of mosquitoes to adjust the direction of travel thereto.

Alternatively, the skilled person will be aware of various means by which such effects may be assessed (e.g. measured) by experiments performed in a controlled setting, such as may be described in more detail herein. For example, such experiments may assess the increased bias of mosquitoes to travel towards (e.g. along a predefined pathway towards) and/or land upon the substance the substance having the mosquito attractant effect. In such circumstances, such an effect may be characterized by at least a 10% (e.g. at least a 20%, such as at least a 30% or, particularly at least a 50%) increase in said bias.

The attractant composition may be in any suitable form, including but not limited to liquid, gas, or solid forms or shapes known in the art such as pellets, particles, beads, tablets, sticks, pucks, briquettes, pellets, beads, spheres, granules, micro-granules, extrudates, cylinders, ingot, and the like. In some embodiments, the composition may be provided in a quick-release composition, an extended release composition, or a combination thereof.

### Additional Functional Ingredients

The compositions may also include additional components or agents, such as additional functional ingredients. The functional materials provide desired properties and functionalities to the compositions. For the purpose of this application, the term “functional materials” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and a broad variety of other functional materials may be used.

The compositions of the disclosure may comprise the attractant compounds encapsulated within, deposited on, or dissolved in a carrier. As used herein, a carrier may comprise a solid, liquid, or gas, or combination thereof. Suitable carriers are known by those of skill in the art. For example, liquid carriers may include, but are not limited to, water, media, paraffin oil, glycerol, or other solution. In other embodiments, a water-soluble solvent, such as alcohols and polyols, can be used as a carrier. These solvents may be used alone or with water. Some examples of suitable alcohols include methanol, ethanol, propanol, butanol, and the like, as well as mixtures thereof. Some examples of polyols include glycerol, ethylene glycol, propylene glycol, diethylene glycol, and the like, as well as mixtures thereof. The carrier selected can depend on a variety of factors, including, but not limited to the desired functional properties of the compositions, and/or the Intended use of the compositions.

In some embodiments, the compositions are not meant to be diluted, but are rather ready to use solutions. In some embodiments, the compositions can include at least about 80 wt %, at least about 85 wt %, at least about 90 wt %, or at least about 95 wt % of a carrier. It is to be understood that all ranges and values between these ranges and values are included in the present compositions.

In certain embodiments, the formulation is provided in conjunction with a suitable solid or semi-solid carrier. Suitable solid carriers may include, but are not limited to, biodegradable polymers, talcs, attapulgites, diatomites, fullers earth, montmorillonites, vermiculites, synthetics (such as Hi-Sil or Cab-O-Sil), aluminum silicates, apatites, bentonites, limestones, calcium sulfate, kaolinities, micas, perlites, pyrophyllites, silica, tripolites, and botanicals (such as corn cob grits or soybean flour), and variations thereof that will be apparent to those skilled in the art.

The solid carrier can be a macromer, including, but not limited to, ethylenically unsaturated derivatives of poly(ethylene oxide) (PEG) (e.g., PEG tetraacrylate), polyethylene glycol (PEG), polyvinyl alcohol (PVA), poly (vinylpyrrolidone) (PVP), poly (ethyloxazoline) (PEOX), poly (amino acids), polysaccharides, proteins, and combinations thereof. Carriers may also include plaster.

Polysaccharide solid supports include, but are not limited to, alginate, hyaluronic acid, chondroitin sulfate, dextran, dextran sulfate, heparin, heparin sulfate, heparin sulfate, chitosan, gellan gum, xanthan gum, guar gum, water soluble cellulose derivatives, carrageenan, and combinations thereof.

Protein solid supports include, but are not limited to, gelatin, collagen, albumin, and combinations thereof.

In more particular embodiments, the suitable solid or semi-solid carrier is: a wax, wax-like, gel or gel like material; an absorbent solid material or material capable of having the formulation adsorbed thereon; or a solid matrix capable of having the formulation contained therein.

For example, in particular embodiments, the formulation is provided in conjunction with a wax or wax-like carrier (e.g. a wax), particularly wherein the formulation is evenly distributed throughout the wax or wax-like carrier. Particular wax-like carriers that may be mentioned include paraffin (which may be referred to as paraffin wax).

Alternatively, the formulation may be provided in conjunction with an absorbent solid material, such as in a form wherein said formulation is absorbed in (i.e. impregnated in) said solid.

For example, the formulation may be absorbed in an absorbent paper or paper-like material, or a fabric material (e.g. a fabric constructed from natural fibers, such as a cotton fabric).

Further, in embodiments wherein the formulation is provided in conjunction with an absorbent solid material, such conjunctions of materials may be prepared by absorbing said formulation into said solid material. Such conjunctions of absorbent solid material and formulations (e.g. formulations of the first aspect of the invention) may be provided by absorbing the formulation into the solid material, particularly where the formulation comprises a suitable (e.g. volatile) solvent and, following absorption, said solvent is allowed to evaporate to result in an absorbed formulation comprising a lower amount of (or essentially none of) that solvent.

Alternatively, the formulation may be adsorbed on a solid material and/or contained within a solid matrix of a solid material.

For example, the formulation may be adsorbed and/or contained within a plurality of solid beads, such as suitable plastic beads. Particular plastic bead-based carrier systems that may be used include that marketed by Biogents® as the BG-Lure® system/carriage. As described herein, formulations of the invention may be suitable for use in attracting mosquitoes, such as those mosquitoes known to act as vectors for the transmission of diseases, such as malaria, in humans.

The compositions may also include a thickening agent. Thickening agents can be added to the compositions to reduce the misting of the compositions. Thickening agents suitable for use in the present compositions include, but are not limited to, xanthan gum, guar gum, polyethylene oxide, polyvinyl pyrrolidone, polyvinyl alcohol, clay thickener, bentonite, carboxyl methyl ether cellulose, kaolin, soy protein and mixtures thereof. When a thickening agent is included in the compositions, the thickening agent may constitute between about 0.01 wt % and about 1.0 wt %, about 0.05 wt % and about 0.5 wt %, or about 0.1 wt % of the compositions.

The compositions may also include an additional ingredient selected from an essential oil, 2-phenyl ethyl propionate, a residual insecticide (viz. an insecticide that is efficacious even after drying), and mixtures thereof. The compositions may also include an additional insecticide, for example, a reduced risk pesticide as classified by the Environmental Protective Agency. Reduced risk pesticides include pesticides with characteristics such as very low toxicity to humans and non-target organisms, including fish and birds, low risk of ground water contamination or runoff, and low potential for pesticide resistance. Exemplary active ingredients for reduced risk pesticides include but are not limited to, castor oil, cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemon grass oil, linseed oil, malic acid, mint and mint oil, peppermint and peppermint oil, 2-phenethyl propionate (2-phenyethyl propionate), potassium sorbate, putrescent whole egg solids, rosemary and rosemary oil, sesame and sesame oil, sodium chloride, sodium lauryl sulfate, soybean oil, thyme and thyme oil, white pepper, zinc metal strips, and combinations thereof.

In certain examples, a preservative can optionally be included in a mosquito attractant composition to prevent degradation of the composition. In certain examples, the preservative can also, or alternatively, be a biocide which prevents the growth of bacteria and fungi. Suitable preservatives can include one or more of 1,2-benzisothiazolin-3-one (“BIT”), benzoic acid, benzoate salts, hydroxy benzoate salts, nitrate, nitrite salts, propionic acid, propionate salts, sorbic acid, and sorbate salts. Other suitable preservatives are known in the art.

For example, in particular embodiments that may be mentioned, the formulation further comprises one or more (e.g. one) component that is an antioxidant. Particular antioxidant compounds that may be mentioned include butylated hydroxytoluene (BHT), which is also known as dibutyl hydroxytoluene.

A fragrance can optionally be included in certain examples. As can be appreciated however, in certain examples, a mosquito attractant composition can be odorless when formed from odorless components. For example, a mosquito attractant composition formed of gellan gum, glycerol, and water can be odorless to humans as each of the components in the composition are odorless to humans. Odorless compositions may be preferred for increased consumer acceptance.

The compositions may also optionally include humectants such as glycerol to slow evaporation and maintain wetness of the compositions after application. When a humectant is included in the compositions, the humectant may constitute between about 0.5% and about 10% by weight of the compositions.

The compositions may also optionally include a foaming agent. When a foaming agent is included in the compositions, the foaming agent may constitute between about 1% and about 10% by weight of the pesticide composition. In other embodiments, the compositions do not include a foaming agent.

In some embodiments, the compositions may comprise, or the methods may employ, either within the formulation or in a formulation separate from the composition, a classical attractant, a toxicant, or mosquito growth regulators (e.g., growth inhibitors). It is specifically envisioned that growth regulators can be horizontally transferred to mosquito eggs or larvae at other locales, e.g., by transfer to adjacent water containers through skip-oviposition.

Toxicants may include, but are not limited to, larvacides, adulticides, and pesticides such as DDT. Additional components may include, but are not limited to, pesticides, insecticides, herbicides, fungicides, nematicides, acaricides, bactericides, rodenticides, miticides, algicides, germicides, repellents, nutrients, and combinations thereof. Specific examples of insecticides include, but are not limited to, a botanical, a carbamate, a microbial, a dithiocarbamate, an imidazolinone, an organophosphate, an organochlorine, a benzoylurea, an oxadiazine, a spinosyn, a triazine, a carboxamide, a tetronic acid derivative, a triazolinone, a neonicotinoid, a pyrethroid, a pyrethrin, and a combination thereof. Specific examples of herbicides include, without limitation, a urea, a sulfonyl urea, a phenylurea, a pyrazole, a dinitroaniline, a benzoic acid, an amide, a diphenylether, an imidazole, an aminotriazole, a pyridazine, an amide, a sulfonamide, a uracil, a benzothiadiazinone, a phenol, and a combination thereof. Specific examples of fungicides include, without limitation, a dithiocarbamate, a phenylamide, a benzimidazole, a substituted benzene, a strobilurin, a carboxamide, a hydroxypyrimidine, a anilopyrimidine, a phenylpyrrole, a sterol demethylation inhibitor, a triazole, and a combination thereof. Specific examples of acaricides or miticides include, without limitation, rosemary oil, thymol, spirodiclogen, cyflumetofen, pyridaben, diafenthiuron, etoxazole, spirodiclofen, acequinocyl, bifenazate, and a combination thereof.

### Method of Use

In other embodiments, the disclosure provides methods of attracting at least one mosquito to a target. The methods may comprise applying a composition, to the target. As used herein, “target” is a surface, site, or container known in the art. A container may contain a fluid such as water.

The methods of the disclosure may be carried out by applying attractant supernatants, compounds, or compositions as described herein to a target article or site to which mosquitoes are to be attracted. In some embodiments, the applying step is carried out by applying the attractant composition, optionally in sterile form, or utilizing attractant compounds as described herein.

The methods and compositions can be implemented as a mosquito trap. Such a trap may include (i) a trapping chamber or adhesive and (ii) an attractant positioned to attract mosquitoes to the trapping chamber or adhesive, wherein an attractant as described herein is utilized as the attractant. Any suitable trap configuration can be used, including, but not limited to, those described in U.S. Pat. Nos. 7,434,351; 6,718,687; 6,481,152; 4,282,673; 3,997,999; and variations thereof that will be apparent to those skilled in the art.

The mosquito attractant compositions disclosed herein can beneficially be used in combination with a wide variety of insect trapping devices to attract and remove insects, such as mosquitoes, from a space, such as a room in a residence or building. In certain examples, the mosquito attractant composition is effective enough that the devices preferably do not incorporate a CO.sub.2 generating means or emitter as an additional mosquito attractant the insect trapping device does not rely on a mechanism, such as electric fan, to induce an airflow over the mosquito attractant composition to enhance evaporation. The insect trapping devices may attract mosquitoes as well as other flying or crawling insects, such as flies, moths and gnats, for example. In this sense, the insect trapping device may be a broad-spectrum insect trap. In certain examples, the insect trapping devices can be enhanced by incorporating one or more broad spectrum one or more lights. The mosquito attractant compositions can help attract insects to an insect trapping device which permanently traps and removes the mosquitoes and other insects. A wide variety of insect trapping devices are generally known in the art and suitable for use with the compositions described herein. Some non-limiting examples are disclosed in U.S. Pat. Nos. 6,108,965; 7,191,560; PCT Patent App. No. WO 2014/134,371; PCT Patent App. No. WO 2015/081,033; and PCT Patent App. No. WO 2015/164,849, each of which is incorporated herein by reference.

Insect trapping devices may generally share a number of similar features. For example, insect trapping devices can include one or more attraction mechanisms to attract insects to the device. Examples of such insect attraction mechanisms can include a mosquito attractant composition such as the compositions disclosed herein as well as heat, light, and/or food. In certain embodiments, the insect trapping device is an electrical device, meaning it utilizes electricity to power one or more elements such as a light or heating element. Once an insect is attracted to an insect trapping device, one or more trapping mechanisms can prevent an insect from leaving the device. For example, an insect may be trapped on an adhesive sheet, enter into a chamber that is difficult to exit, or be killed (for example by electrocution).

In certain examples, an exemplary insect trapping device comprises a base unit and a disposable insect trapping portion, such as either a disposable cartridge or a disposable insert which may be inserted into a shell. The disposable cartridge and the disposable insert each further comprise a mosquito attractant composition. In certain embodiments, the insect trapping portion comprises a housing having one or more openings for receiving a flying or crawling insect and a mosquito attractant composition such as a composition disposed therein. In such examples, insects can be attracted by the composition and can be trapped within the housing by the adhesive portion. Suitable quantities of a mosquito attractant composition for an insect trapping device can vary from about 1 gram to about 50 grams in certain examples, from about 5 grams to about 40 grams in certain examples, and from about 10 grams to about 30 grams in certain examples. In certain examples, a gelled mosquito attractant composition can be formed by disposing a hot, liquid mosquito attractant composition within an insect trapping device, or a portion thereof such as a cartridge or insert, and allowing the composition to cool and form a gel. As can be appreciated, certain optional features can be included in various examples to further improve an insect trapping device.

In certain examples, the disposable cartridge and the disposable insert comprise an adhesive portion for trapping insects, which may be in the form of an adhesive sheet. The adhesive portion may comprise a substrate having an adhesive composition coated thereon. In certain such examples, the adhesive portion can divide the housing into a front enclosure and a rear enclosure. A mosquito attractant composition can be included in one, or both, of such enclosures to attract insects. The enclosures can have one or more openings to allow insects to enter. Alternatively, in certain examples, insects can be mechanically trapped within the housing through a substantially one-way opening.

Additionally, or alternatively, an insect trapping device can include additional features to attract insects. For example, in certain examples, an insect trapping device can include one or more lights to attract a variety of insects. In certain such examples, the lights can comprise a plurality of light emitting diodes (“LEDs”) and can emit light at a spectrum attractive to insects such as a substantially blue light and/or ultraviolet light. In such examples, a suitable power source such as batteries, solar panels, or connections to wired power sources or the like can be included. For example, prongs for an AC power outlet can be included in certain examples. Certain insect trapping devices can also emit heat to attractant insects. As can be appreciated, heat can be generated through an electric heating element, a chemical reaction or the like.

In certain examples, an insect trapping device can be formed of multiple parts. For example, in certain examples, an insect trapping device comprises a plug-in unit that may engage an electrical wall outlet and a disposable insect trapping cartridge. In such examples, a plug-in unit may provide structural stability, lighting, and heating elements while an insect trapping cartridge comprises a mosquito attractant composition and an adhesive portion to capture mosquitoes and other insects. In certain examples, the insect trapping device can emit heat or activate the one or more lighting elements when the insect trapping cartridge is inserted into the plug-in unit. The cartridge comprising the adhesive portion and the mosquito attractant composition may be removed from the plug-in unit and disposed of when the mosquito attractant composition is exhausted and/or when the adhesive portion is filled with insects. The spent cartridge is then replaced by a fresh, new cartridge. A kit including the plug-in unit and the insect trapping cartridge can be sold together with further replaceable insect trapping cartridges sold separately. In certain examples, the insect trapping device can be a single, disposable, item and can be sold without a separate plug-in unit.

It is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application. All U.S. patents cited herein are incorporated by reference herein in their entirety. The present disclosure is explained in greater detail in the Examples set forth below.

Those skilled in the art will recognize, or be able to ascertain using no more than routine experimentation, numerous equivalents to the specific procedures, embodiments, claims, and examples described herein. Such equivalents are considered to be within the scope of this disclosure and covered by the claims appended hereto. The contents of all references, patents, and patent applications cited throughout this application are hereby incorporated by reference. The disclosure is further illustrated by the following examples, which should not be construed as further limiting.

### EXAMPLES

A globally invasive form of the mosquito Aedes aegypti specializes in biting humans, making it an efficient disease vector¹. Host-seeking females strongly prefer human odour over the odour of non-human animals^{2,3}, but exactly how they distinguish the two is not known. Vertebrate odours are complex blends of volatile chemicals with many shared components⁴⁻⁷, making discrimination an interesting sensory coding challenge. Here we show that human and animal odour blends evoke activity in distinct combinations of olfactory glomeruli within the Aedes aegypti antennal lobe. One glomerulus in particular is strongly activated by human odour but responds weakly, or not at all, to animal odour. This ‘human-sensitive’ glomerulus is selectively tuned to the long-chain aldehydes decanal and undecanal, which we show are consistently enriched in human odour and which likely originate from unique human skin lipids. Using synthetic blends, we further demonstrate that signalling in the human-sensitive glomerulus significantly enhances long-range host-seeking behaviour in a wind tunnel, recapitulating preference for human over animal odour. Our work suggests that animal brains may distill complex odour stimuli of innate biological relevance into simple neural codes and reveals novel targets for the design of next-generation mosquito-control strategies.

The discrimination of odour cues is a challenging problem faced by animals in nature. Decades of olfactory research have revealed the principles by which animals may identify individual compounds or simple mixtures—using combinatorial codes for flexible, learned behaviours⁸⁻¹¹ or labelled lines for hard-wired, innate responses¹²⁻¹⁵. However, most natural odours are blends of tens to hundreds of compounds^{4,16,17}. How animals evolve to efficiently recognize these more complex stimuli, especially those with important innate meaning, is poorly understood¹⁸⁻²¹.

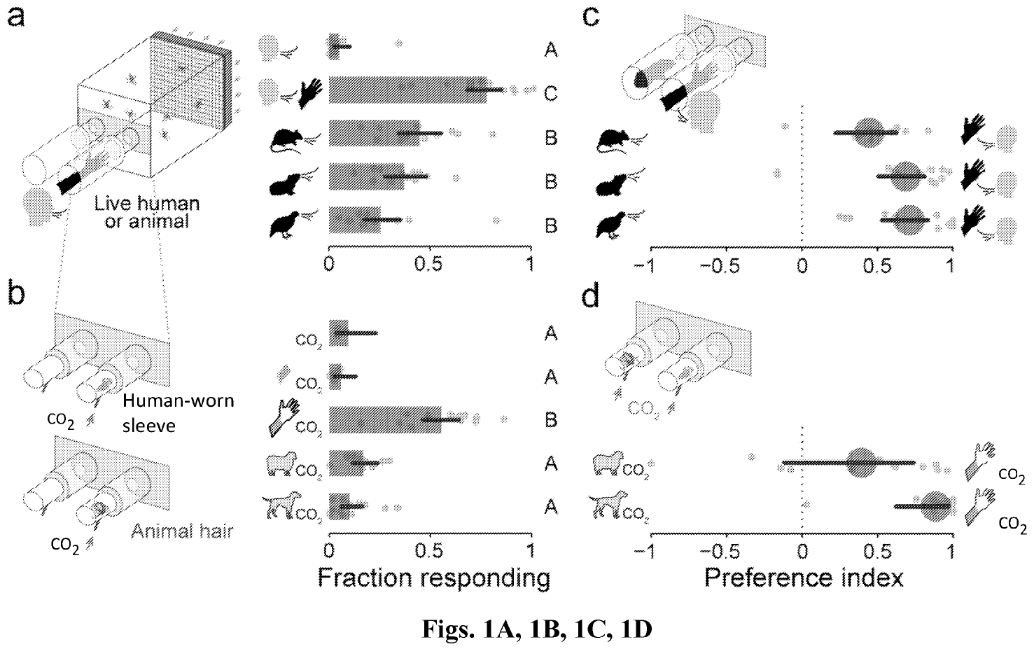

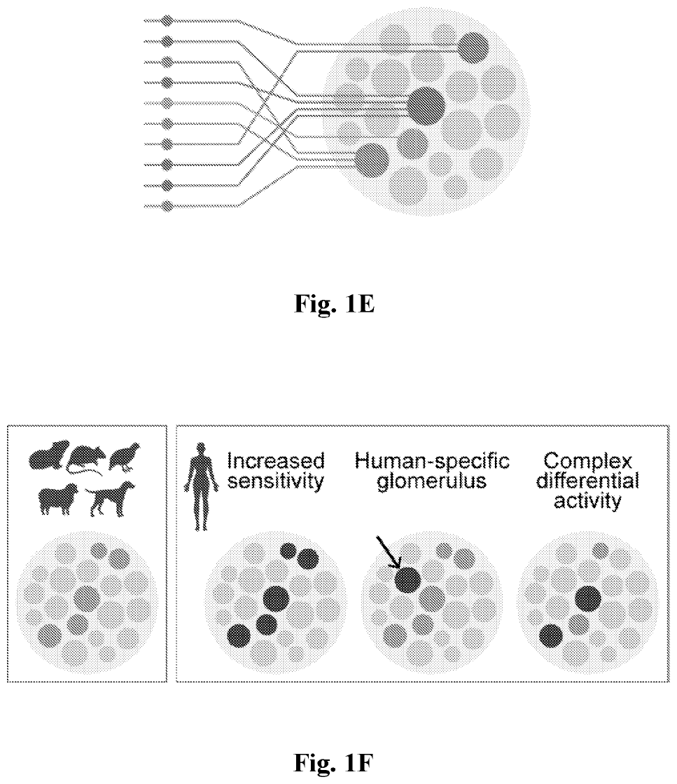

This problem is particularly relevant for Aedes aegypti mosquitoes, which have recently evolved to specialize in biting humans and thus become the primary worldwide vectors of human arboviral disease^{1,22}. Females can detect vertebrate animals using the carbon dioxide in breath and other general cues such as body heat, humidity, and visual contrast²³. However, they rely heavily on body odour for discrimination among species²⁴ and show a robust preference for human odour over the odour of non-human animals^{2,3} (hereafter ‘animals’) (FIGS. 1A-D). The apparent ease with which they distinguish these stimuli is remarkable since vertebrate body odours are complex blends of relatively common compounds that are frequently shared across species⁴⁻⁷. Females require a multi-component blend for strong attraction^{25,26} and may discriminate based on the ratios in which different components are mixed. Understanding exactly which features of human body odour are used for discrimination and how these features are detected at the neural level would provide basic insight into olfactory coding and potential targets for use in vector control.

### New Tools for Mosquito Olfactory Imaging

Mosquitoes detect most volatile chemical cues using receptors expressed in thousands of olfactory sensory neurons scattered across the antennae and maxillary palps²⁷. Neurons that express the same complement of ligand-specific receptors are believed to send axons to a single olfactory glomerulus within the antennal lobe of the brain²⁸ (FIG. 1E), making this an ideal location to decipher the coding of human odour blends across sensory neuron classes^{10,19} (FIG. 1F). We therefore developed tools to visualize odour-evoked responses in the axon terminals of olfactory sensory neurons at this critical junction. We focus in particular on the subset of neurons that express receptors in the odorant receptor (OR) family, as these play a critical role in fine-grained host discrimination: females carrying mutations in the conserved OR co-receptor orco are attracted to hosts, but discriminate only weakly between humans and animals²⁹.

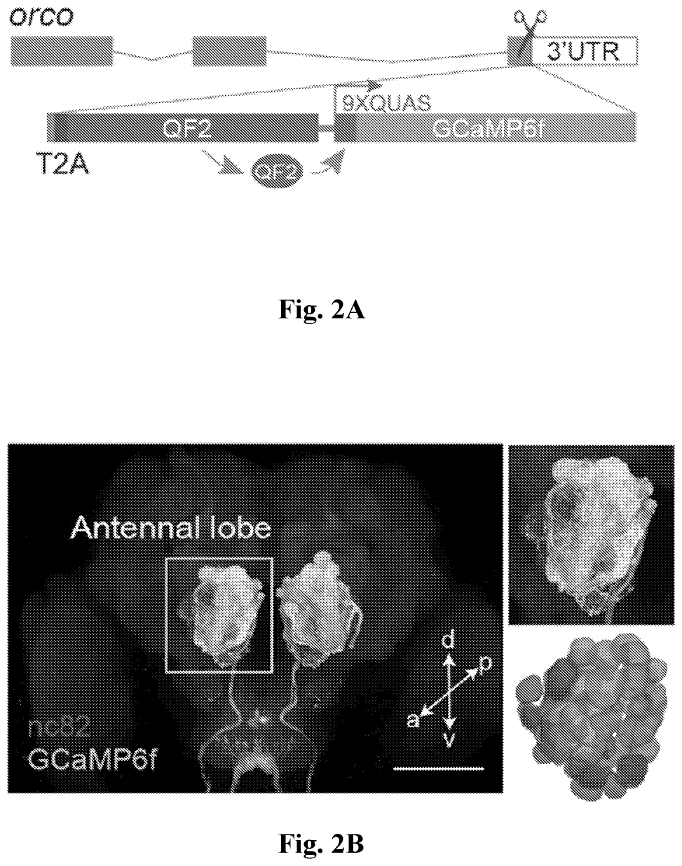

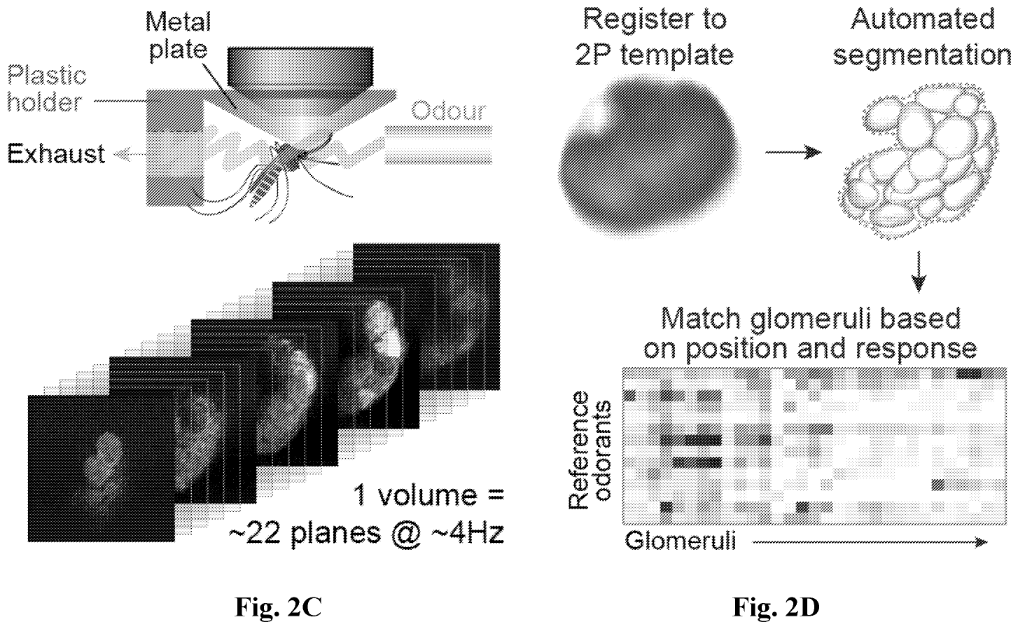

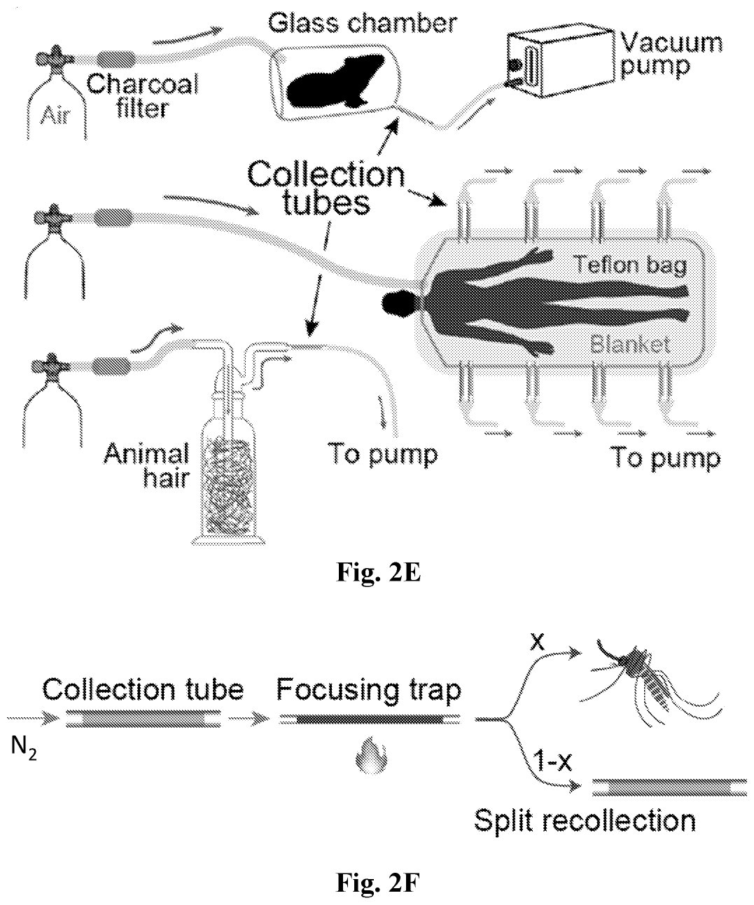

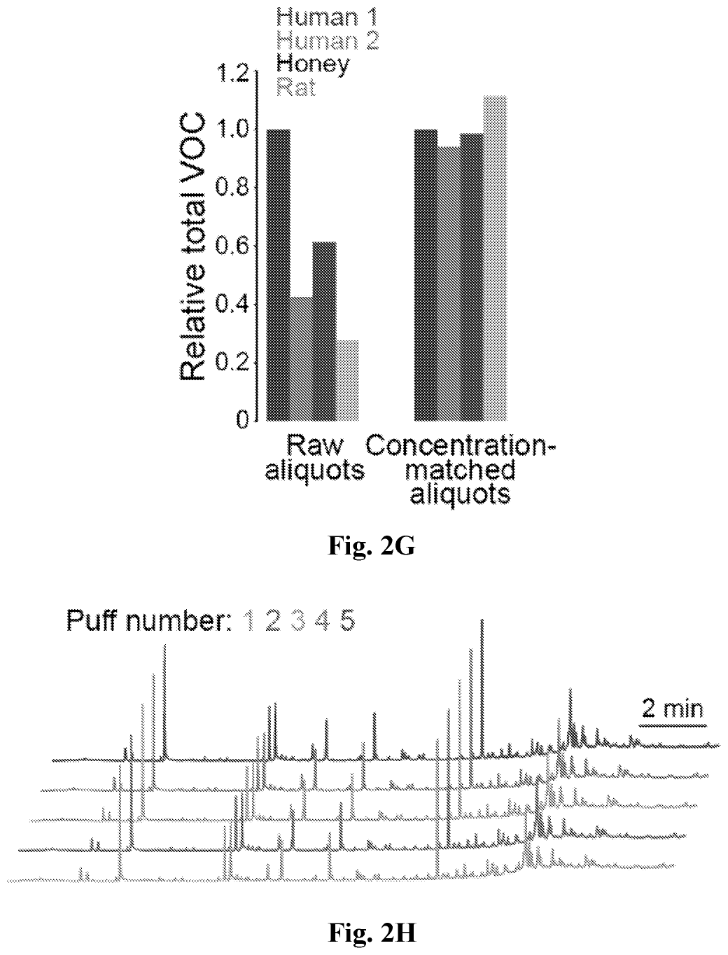

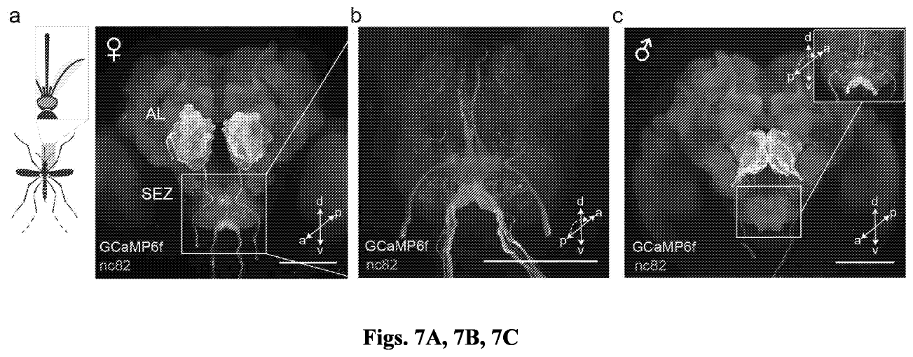

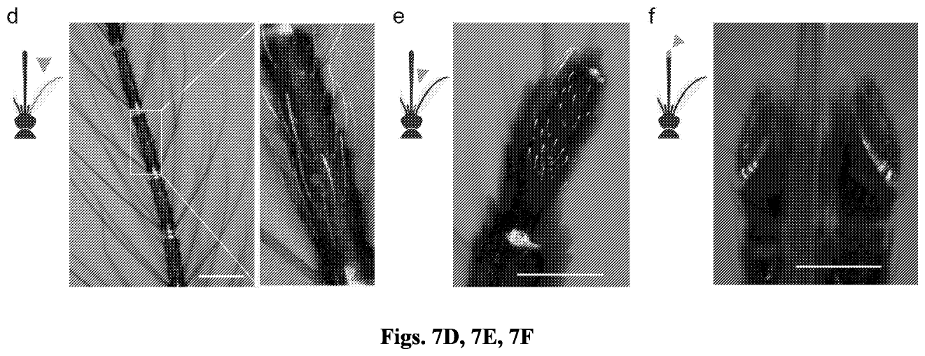

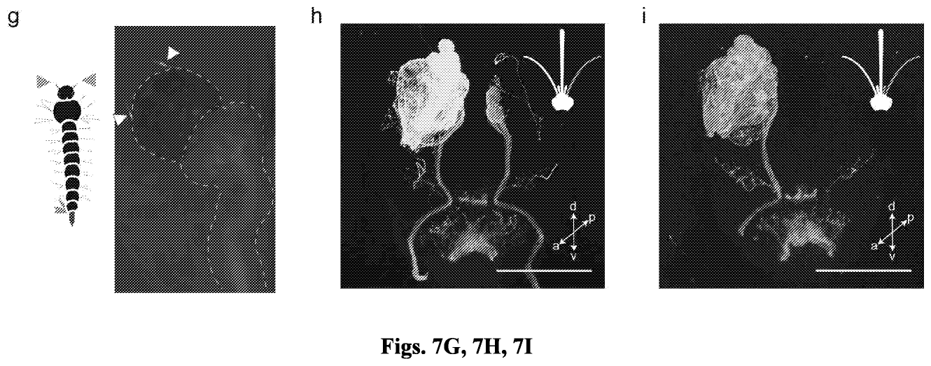

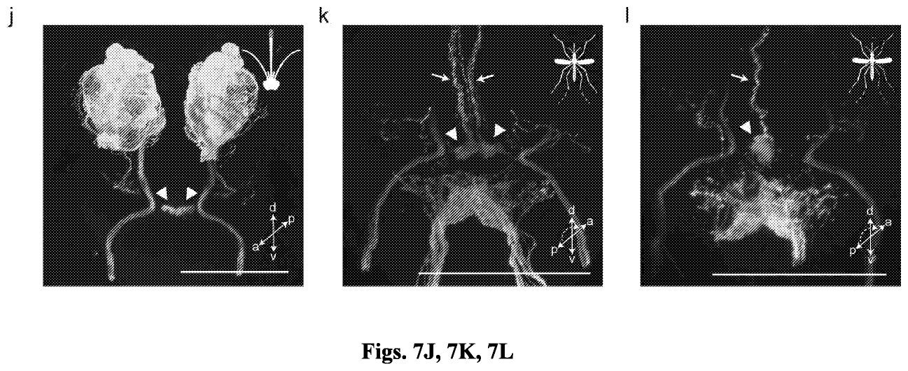

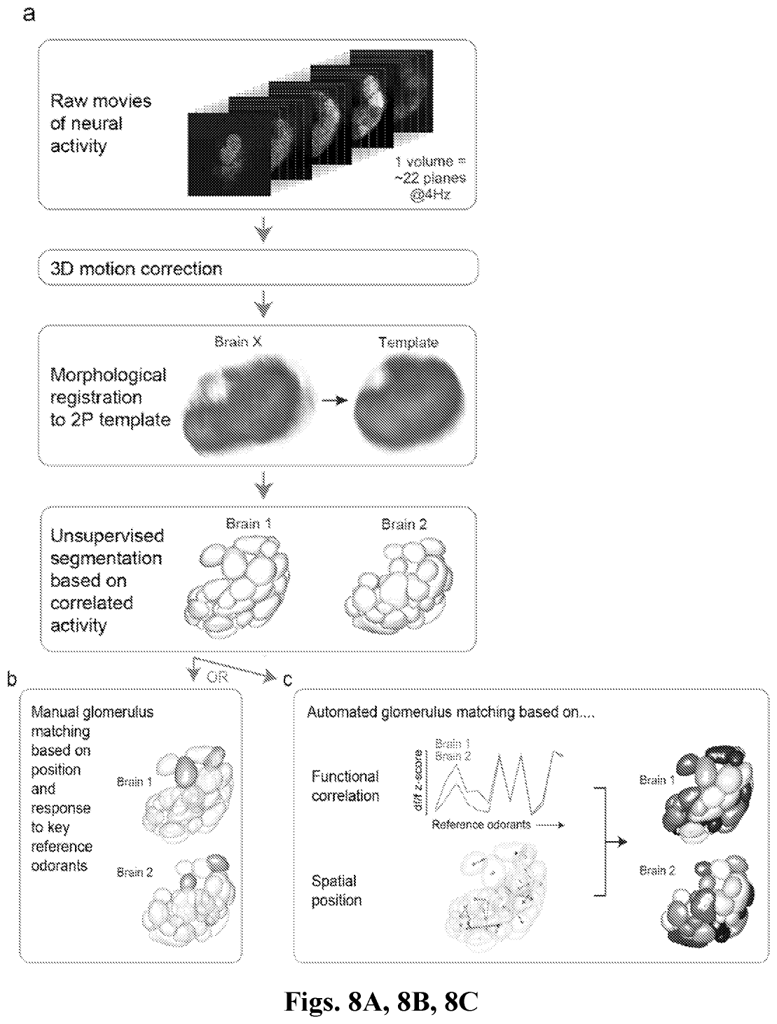

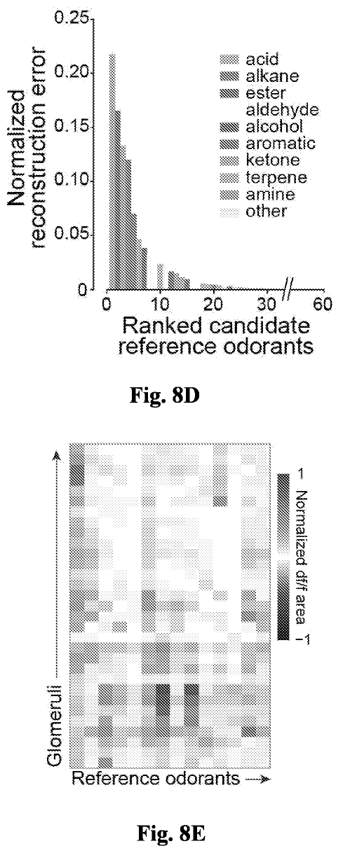

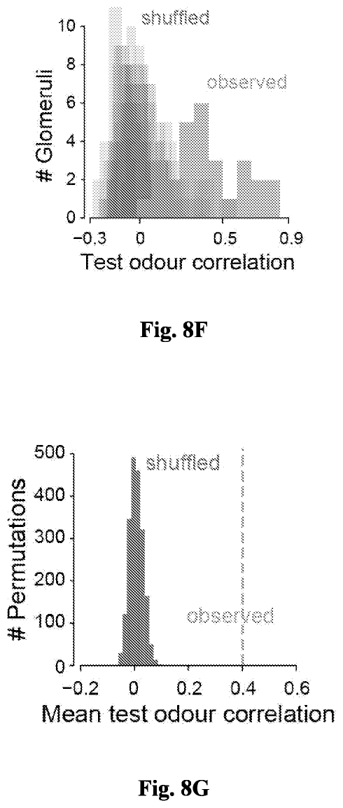

We used CRISPR/Cas9 to generate knock-in mosquitoes that express the calcium indicator GCaMP6f under the endogenous control of the orco locus³⁰ (FIG. 2A, Methods). Transgenic adults showed GCaMP6f expression in sensory neurons on the antenna and maxillary palp that project to approximately 34 of 60 glomeruli in the dorso-medial antennal lobe (FIG. 2B, FIG. 7; see Methods for discussion of variability among recent estimates of glomerulus number in Ae. aegypti). We also observed GCaMP6f in sensory neurons that project to the suboesophageal zone from the labellum³¹ and, most likely, the legs (FIG. 7J-L). Together with a two-photon microscope custom-designed for fast, volumetric imaging (FIG. 2C) and a novel analytical pipeline (FIG. 2D, FIG. 8), the new strain allowed us to capture odour-evoked responses in all Orco+ glomeruli at ˜4 Hz.

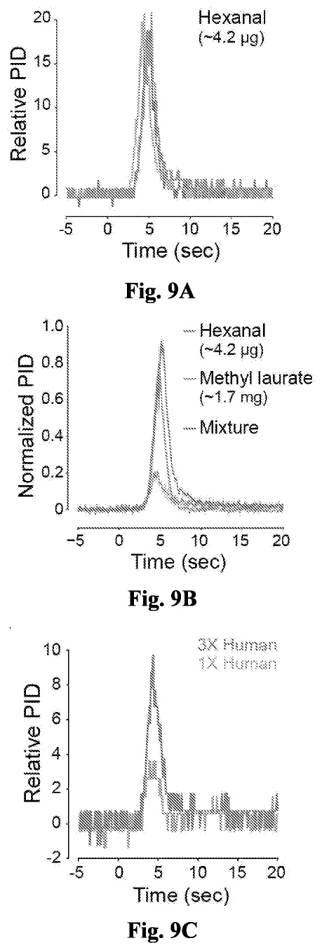

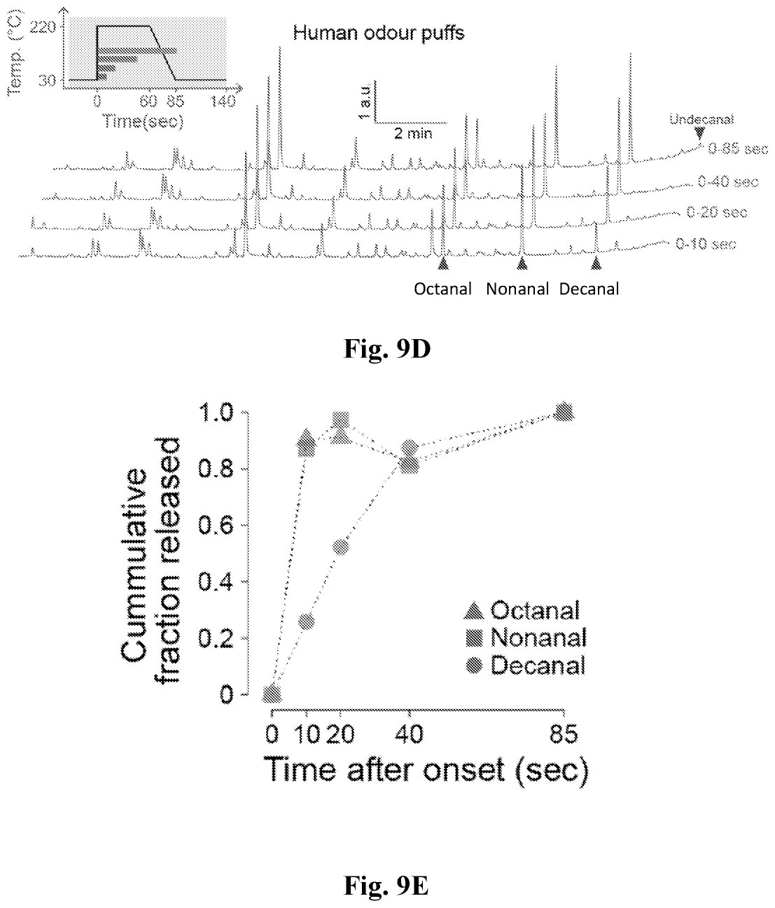

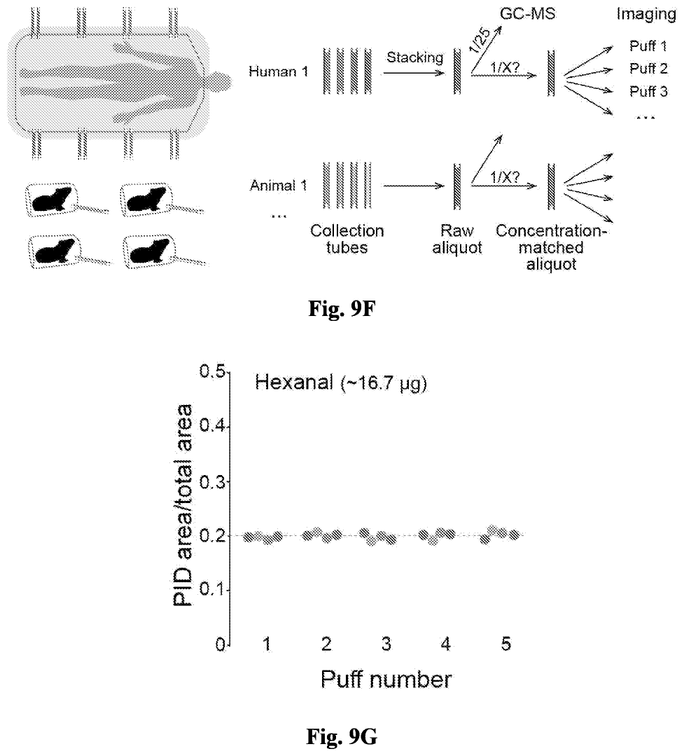

We next collected natural odours and developed methods to faithfully deliver these stimuli to mosquitoes during imaging. We sampled odour from humans (n=8), rats (n=2), guinea pigs (n=2), quail (n=2), sheep wool (n=1), dog hair (n=4), and two nectar-related stimuli that mosquitoes find attractive—milkweed flowers³² and honey²⁹ (FIG. 2E). Individual human samples were kept separate, while those from animals were pooled by species to generate independent replicates for the human-animal comparison. For delivery, most studies use a solvent to elute odour extracts from sorbent collection tubes and then allow the solution to evaporate from a vial, septum, or filter paper. However, the diverse odorants in a blend often require different solvents and will evaporate from solution at different rates based on volatility³³, changing the character of a blend over time. We therefore developed a novel odour-delivery system involving thermal desorption³⁴ that allowed us to deliver natural extracts directly from sorbent tubes to mosquitoes with precise quantitative control (FIG. 2F, FIG. 9). Importantly, we were able to match the total odour concentration of diverse samples delivered to the same mosquito (FIG. 2G) and to deliver replicate puffs of the same sample to different mosquitoes, while maintaining the original blend ratios (FIG. 2H).

### Human Odour Evokes Unique Neural Response

With these new tools and odour samples in hand, we set out to characterize the response of Orco+ glomeruli to human and animal odours. There are several ways in which the activity of key glomeruli might help female mosquitoes discriminate, including increased sensitivity to human odour, exclusive activation by human odour, or more-complex patterns (FIG. 1F). To explore these possibilities, we first imaged responses to the odour of a single human and two animal species across a concentration gradient. We chose rat and sheep for the animals because they are common in human environments and provided ample odour in our extractions. All host odours were delivered at the same four total blend concentrations, ranging from 1/25× to 5×, where 1× roughly matches the odour of a whole human body funnelled to a mosquito in real time (see Methods).

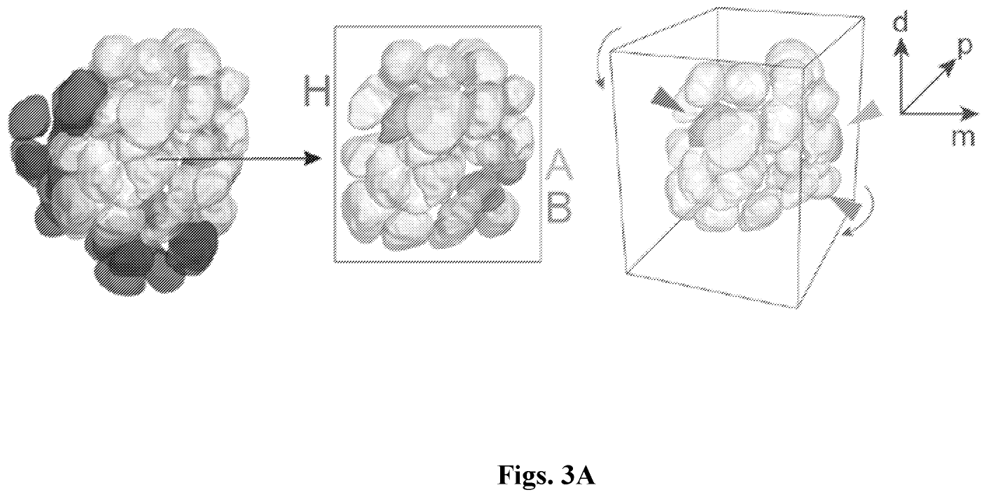

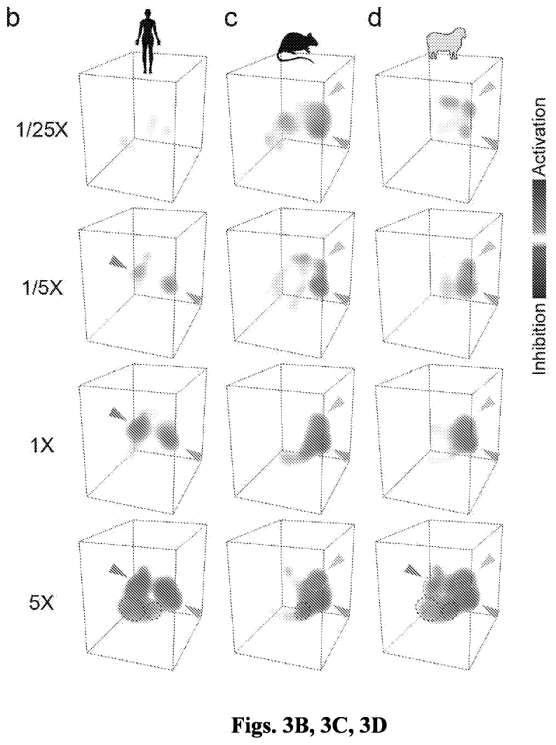

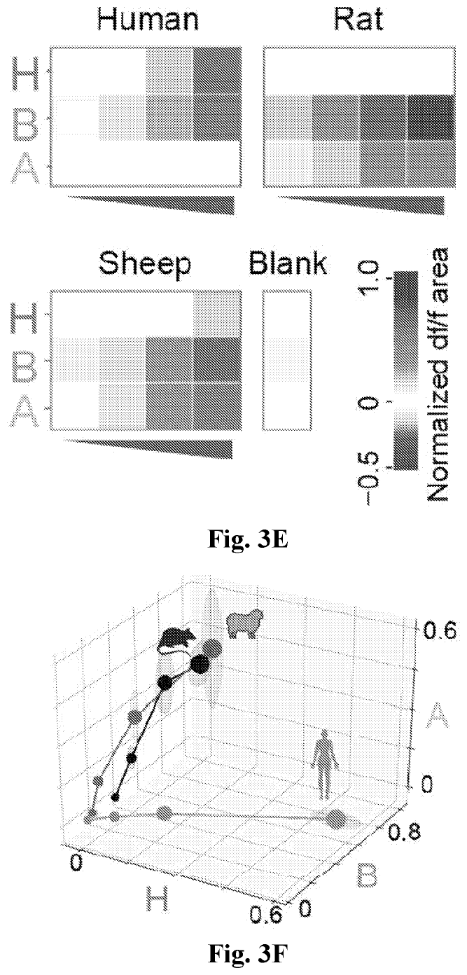

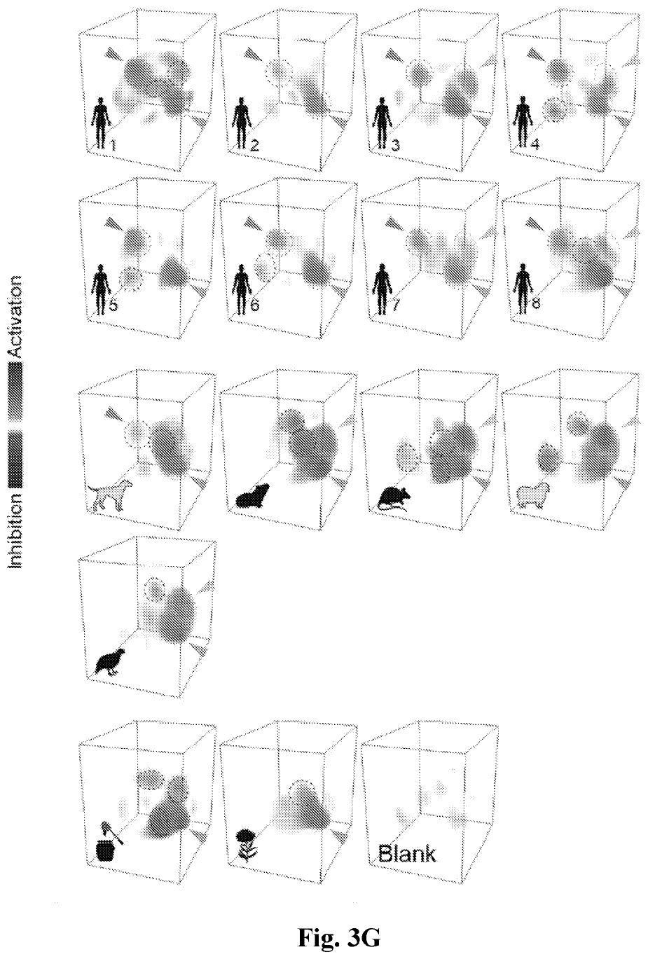

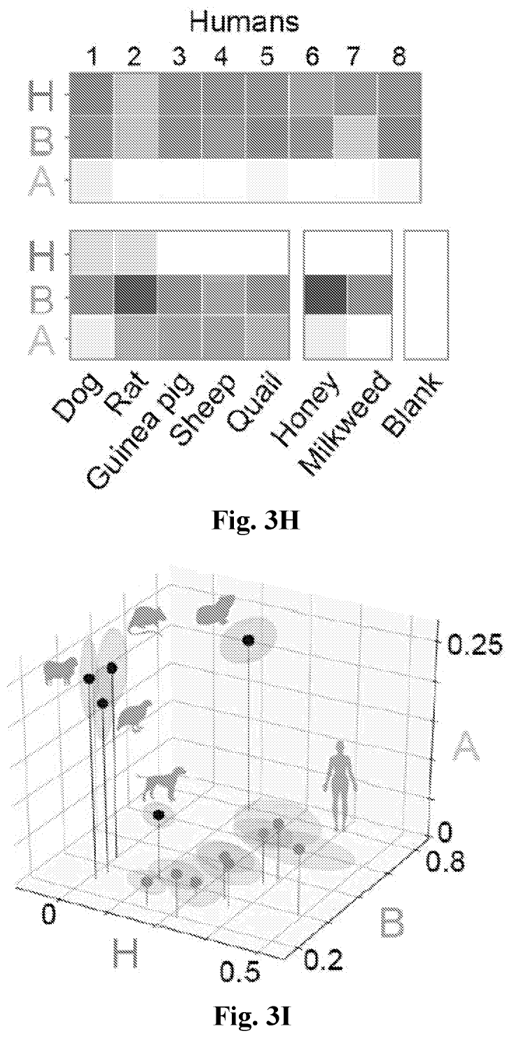

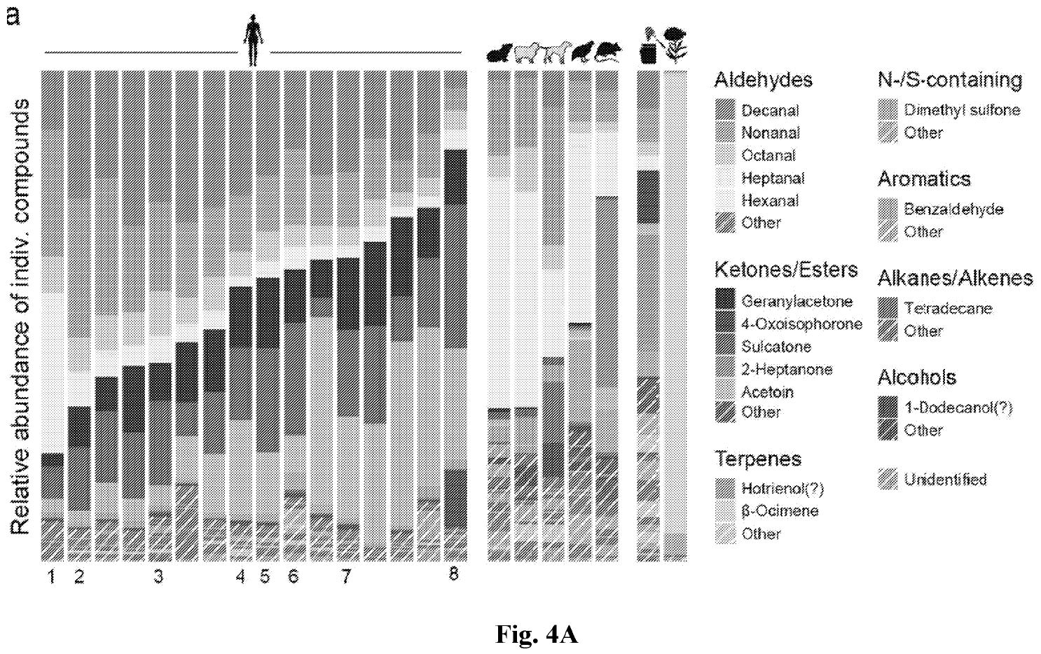

Three glomeruli dominated responses at low and middle doses (FIGS. 3A-D). One was strongly activated by the odour of all three species, while another responded strongly to human odour but was insensitive or only weakly sensitive to animals. A third glomerulus was strongly activated by both animals, but not human. We tentatively refer to these as the ‘broadly tuned’ (B), ‘human-sensitive’ (H), and ‘animal-sensitive’ (A) glomeruli, respectively. While additional glomeruli were activated by the highest dose of each host blend (FIGS. 3B-D), and there may be weak responses below the sensitivity threshold of our preparation, we were struck by the simplicity of this pattern. The relative activity of three glomeruli cleanly separated human and animal odours across the concentration gradient (FIGS. 3E-F).

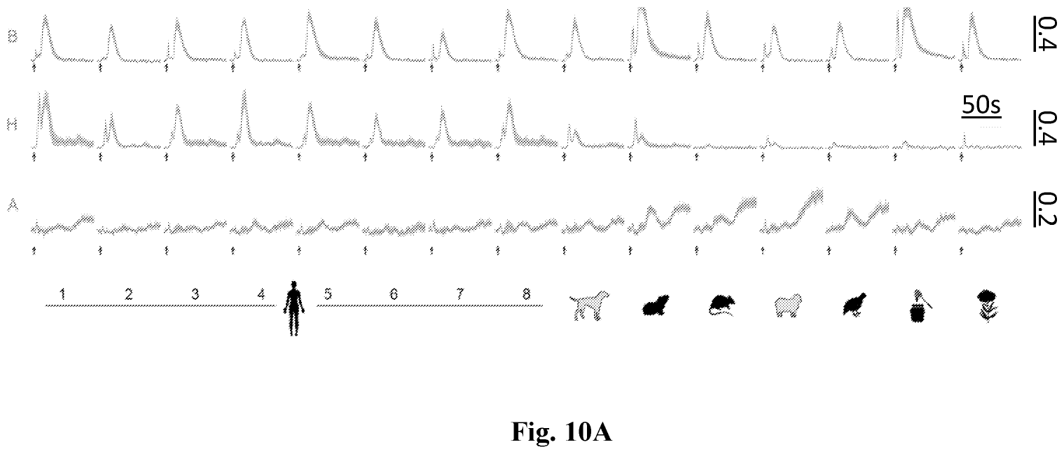

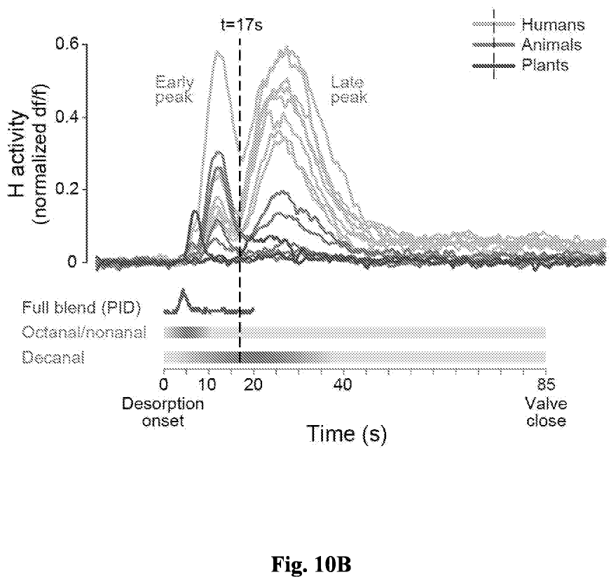

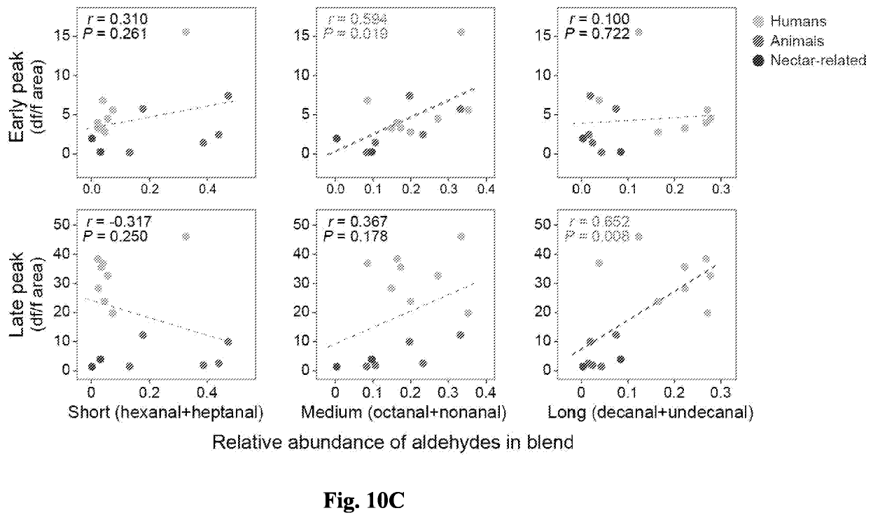

The preference of Ae. aegypti for humans over animals is robust to within-group variation, with most humans being preferred over most animals (FIG. 1A-D). We therefore asked whether the patterns of glomerular activity described above were similarly robust by imaging responses to odour from 7 additional humans (8 total), 3 more animal species (5 total), and the two nectar-related stimuli at a single concentration (1×) (FIGS. 3G-H, FIG. 10). The B glomerulus was again strongly activated by all odour extracts, including the two nectar odours, while H and A were most strongly activated by human and animal odours, respectively. The separation of human and animal odours based on activity in three glomeruli is thus robust to within-group variation (FIG. 3I). To ensure we had not missed additional discriminatory signals among Orco+ glomeruli, we also used an automated pipeline to match and quantify the response of as many glomeruli as possible across mosquitoes (FIG. 8C). B, H, and A again explained most of the variation at 1× (FIGS. 8I-L). This analysis also revealed a fourth glomerulus just posterior to B that responded to all vertebrate odours (FIGS. 8I-L) and may be the target of well-known, 1-octen-3-ol-sensing neurons that project to this region from the palp^{35,36}. In summary, our results indicate that human and animal odours activate distinct combinations of glomeruli in the antennal lobe of Ae. aegypti, including both shared signals and those selectively tuned to either human or animal blends.

### Human Odour is Enriched for Key Compounds

The neural response to human odour must be traceable to chemical features of human odour blends. Human blends contain an array of common volatile compounds that originate from skin secretions, the skin microbiome, or their interaction⁴. They differ consistently from animal blends in the relative abundance of at least two or three components, but quantitative, cross-species comparisons are rare and usually focus on a single compound^{3,6,7,37,38}. We therefore lack a clear picture of the relative ratios and other chemical features mosquitoes may use to discriminate.

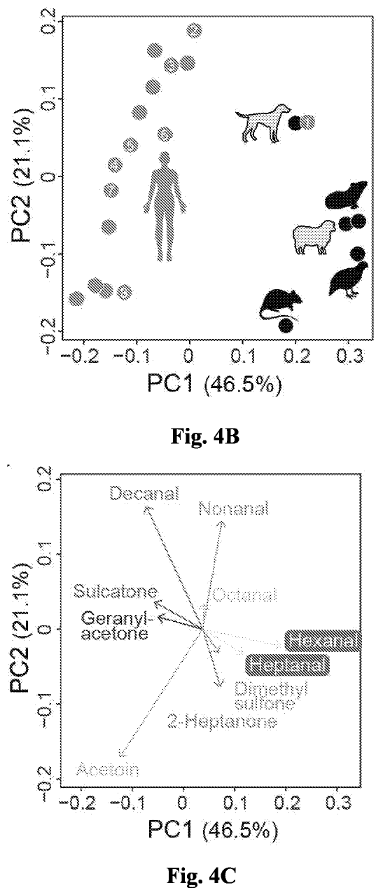

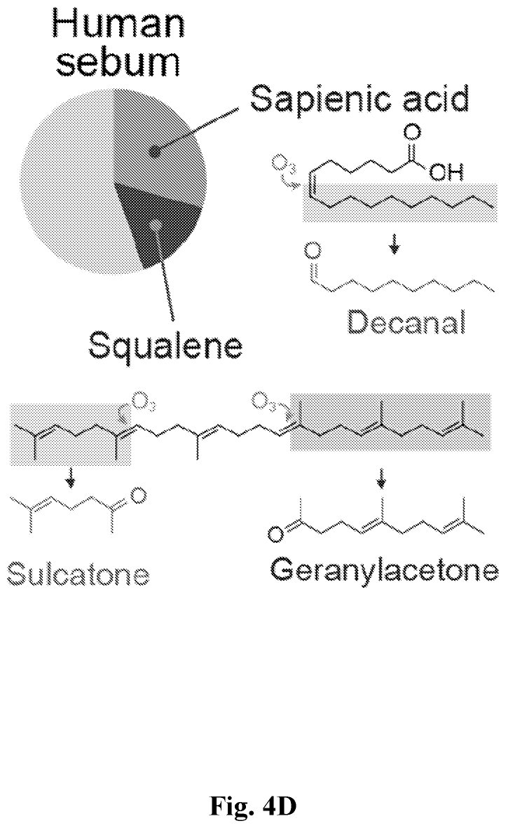

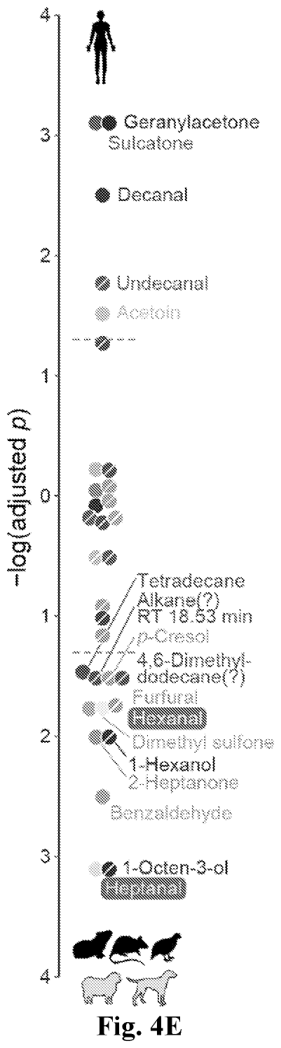

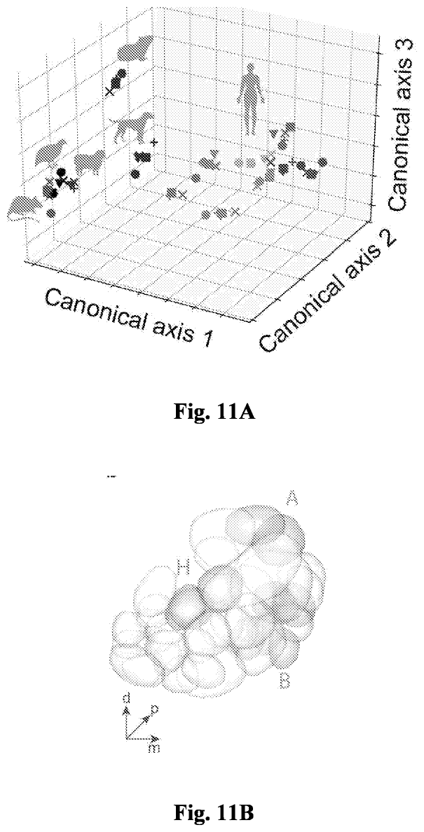

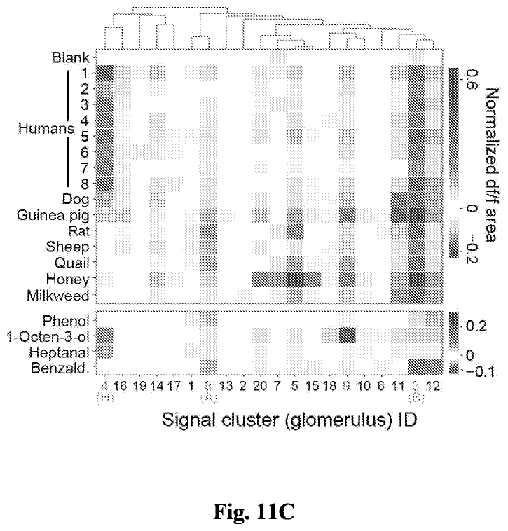

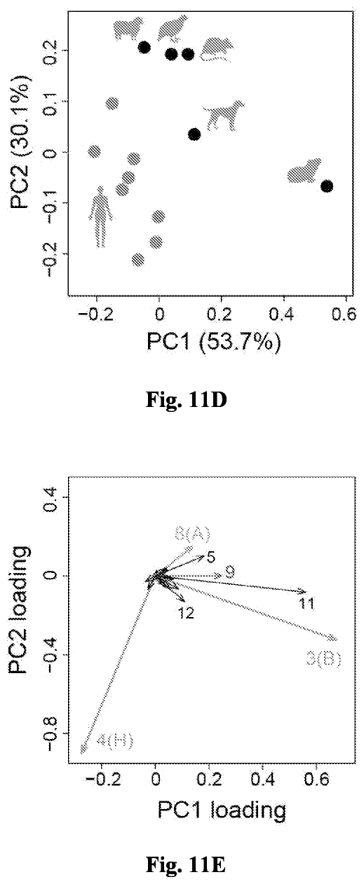

To help fill this gap, we analysed the composition of the human, animal, and nectar-related odour samples used for imaging, plus 8 new human samples (FIG. 4A, FIGS. 11A-D). Importantly, we quantified the abundance of all compounds that made up at least 2% of any blend, excluding acids (sensed primarily by non-OR pathways^{39,40}) and other highly polar or volatile compounds that cannot be quantified reliably within the same framework (see Methods). Consistent with previous work, the vertebrate odours were dominated by aliphatic aldehydes^{4,5,7}, whereas nectar odours were enriched in terpenes¹⁶ (FIG. 4A). Also as expected, human and animal odours shared almost all components (FIG. 11C).

Despite the overlap in blend components, human and animal samples differed consistently in blend ratios, leading to clear separation in a principal components analysis (PCA) (FIG. 4B, FIG. 11E). Loadings on the human-animal axis of the PCA showed that human odour was enriched in three ketones: sulcatone, geranylacetone, and acetoin (FIG. 4C). Human odour also stood out for its high relative abundance of the long-chain aldehyde decanal (10 carbons) and low relative abundance of the short-chain aldehydes hexanal and heptanal (6 and 7 carbons) (FIGS. 4A and C). Sulcatone, geranylacetone, and decanal are widely recognized as abundant in human odour⁴, but consistent enrichment compared to animal odours has only been previously documented for sulcatone³. Interestingly, these three compounds are oxidation products of squalene and sapienic acid⁴¹, unique components of human sebum that may play a role in skin protection^{42,43} (FIG. 4D).

The unscaled PCA gives the most weight to abundant compounds. When we extended our analysis to minor components via compound-specific comparisons (FIGS. 11F and G) we found that human odour is also enriched for a second long-chain aldehyde: undecanal (11 carbons). An independent analysis that considers all detected ions, rather than a subset of curated compounds, identified a largely overlapping set of human- and animal-enriched odorants (FIGS. 11H and I). Taken together, human odour can be distinguished from animal odours by the relative abundance of a diverse set of compounds, none of which are unique to humans, but which come together in characteristic ratios to produce a uniquely human bouquet.

### H Glomerulus is Tuned to Long-Chain Aldehydes

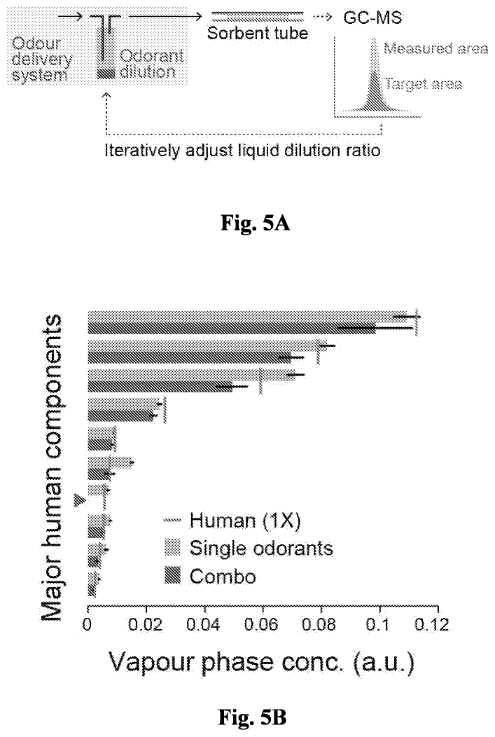

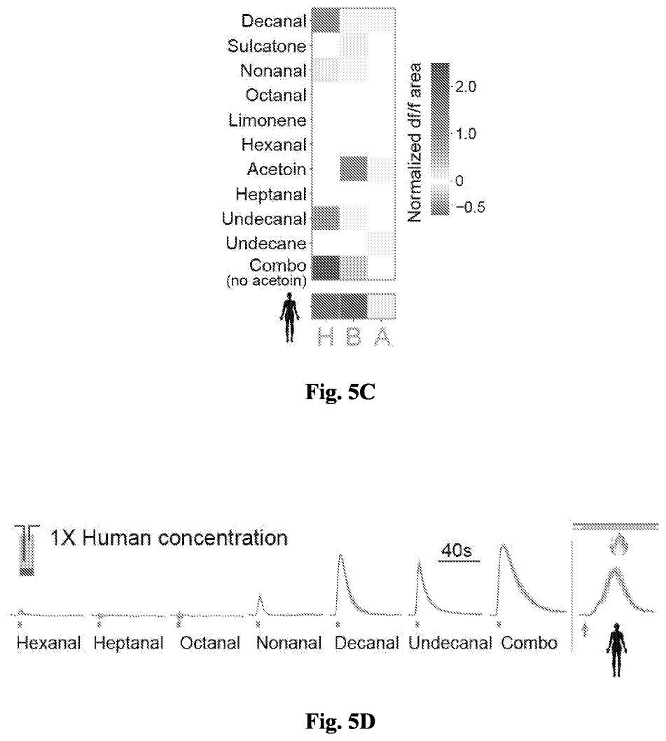

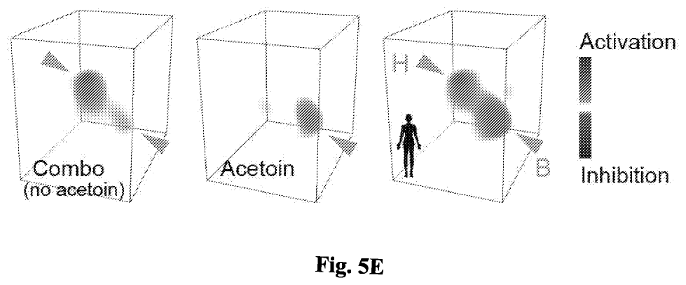

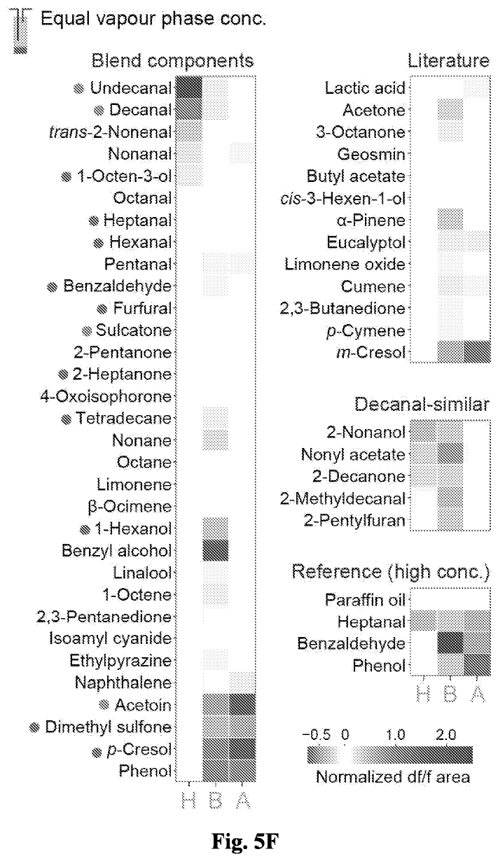

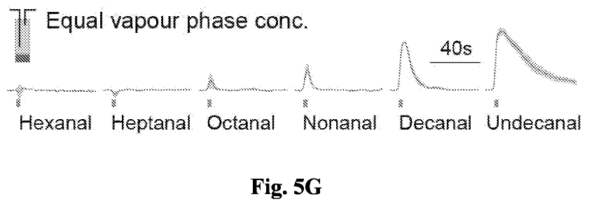

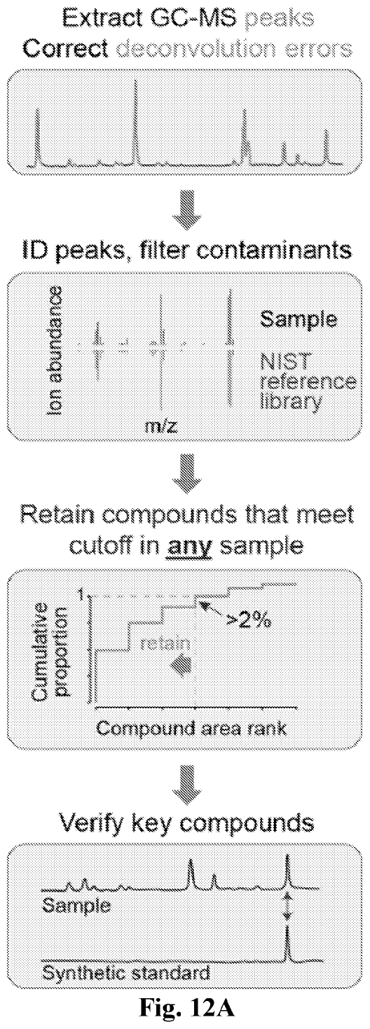

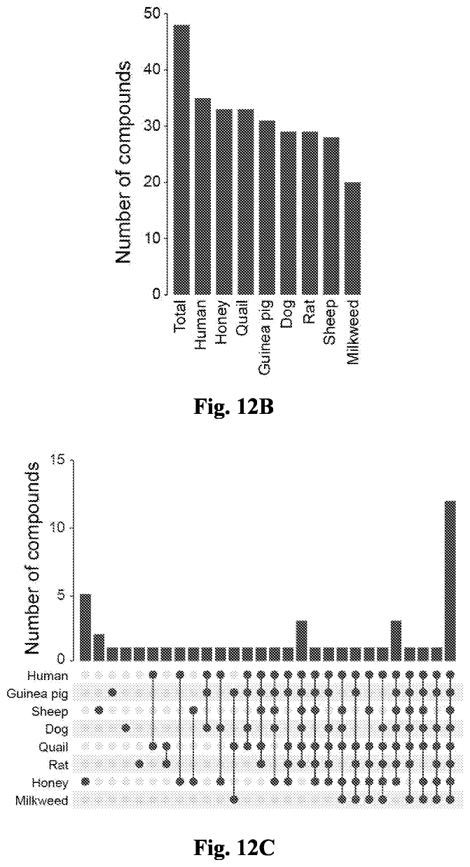

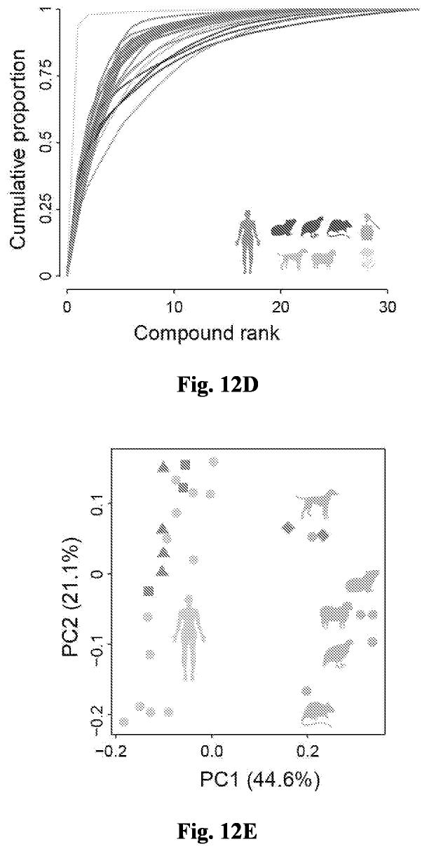

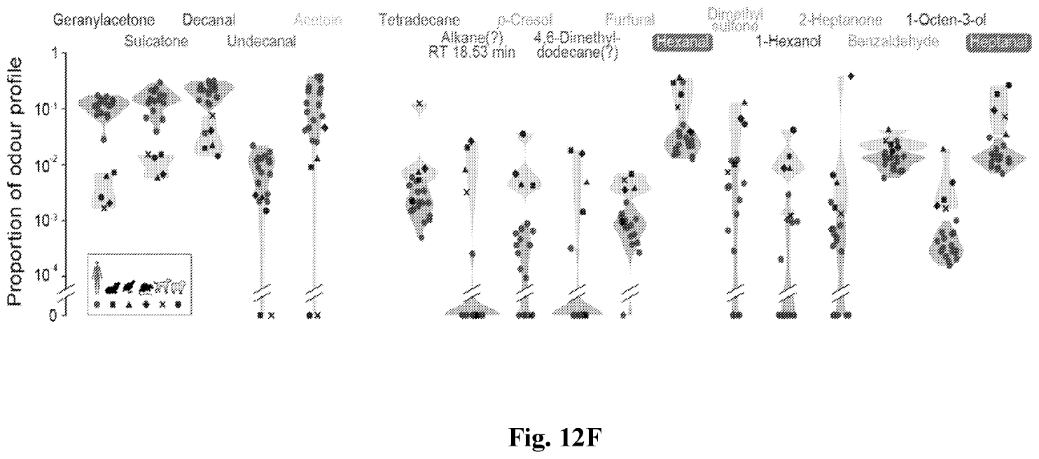

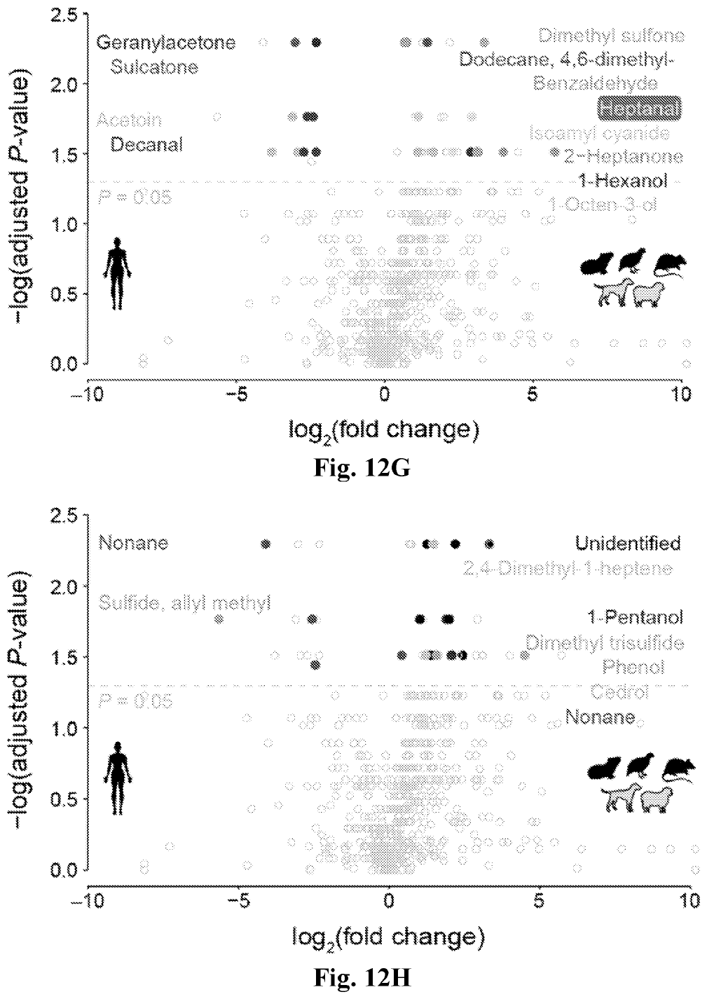

To connect the unique pattern of neural activity evoked by human odour (FIG. 3) to its chemical composition (FIG. 4), we conducted additional imaging with synthetic odorants and blends delivered using standard approaches (FIG. 12). We first asked if the neural response to a representative human sample could be explained by the response to its major components delivered either individually or in a ‘combo’ blend. We considered each of the 11 most abundant compounds in the human sample with two exceptions: geranylacetone was excluded because it is unstable under lab conditions, and acetoin was delivered singly but absent from the combo since it requires a different solvent. We carefully calibrated the liquid dilution ratio of each stimulus (FIG. 5A) to generate vapour-phase concentrations characteristic of the human odour sample at 1× (FIG. 5B).

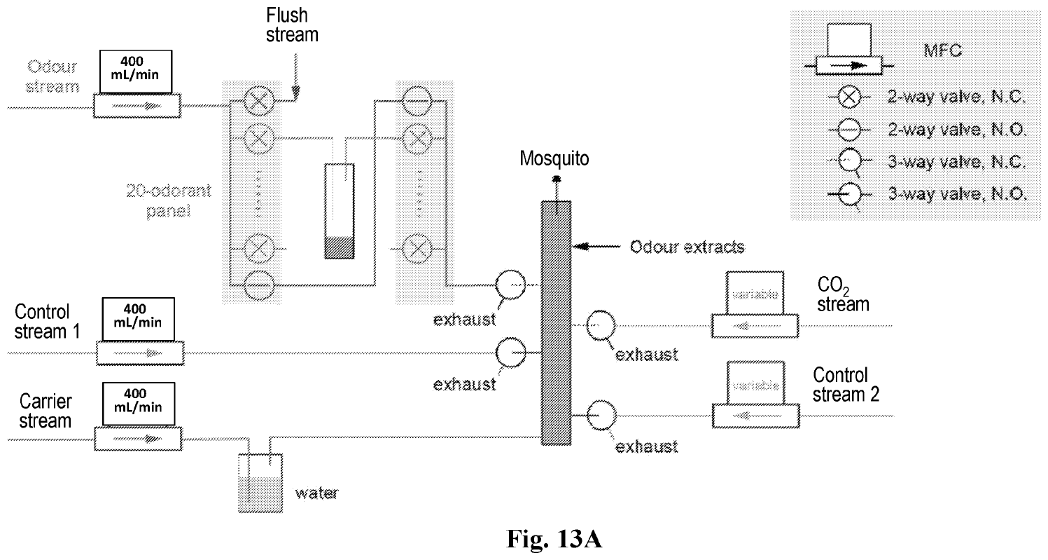

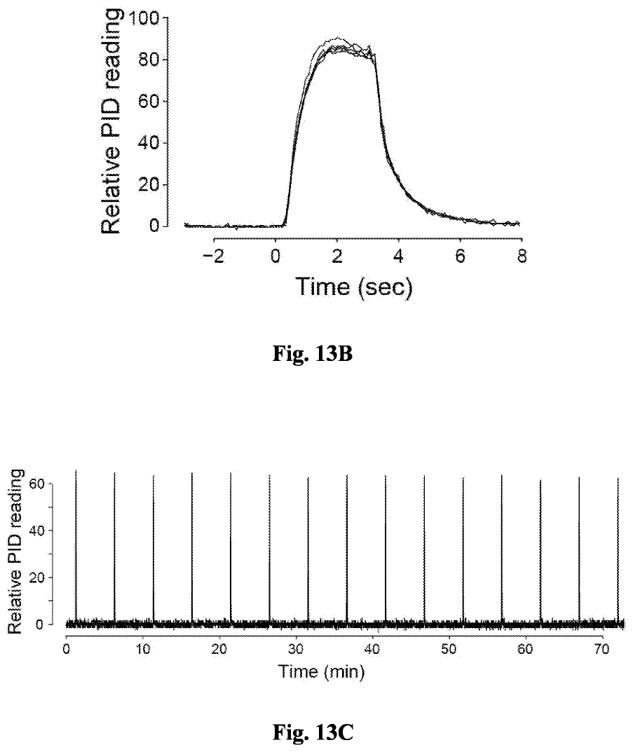

Decanal, undecanal, and the combo stimulus that contained them all evoked strong and prolonged activity in H (FIG. 5C-E, FIG. 13A). The B glomerulus was strongly activated by acetoin and modestly activated by the combo of non-acetoin compounds (FIGS. 5 C and E), likely the sum of a number of weak individual responses (FIG. 13A). No human odour components evoked activity in the A glomerulus at physiological concentrations. Previous work implicated a sulcatone-sensitive receptor in Ae. aegypti preference for humans³. While we did not see consistent activity in response to this compound at its concentration in 1× human odour (FIG. 5C), several glomeruli responded at higher doses (data not shown), suggesting it may be more relevant to behaviour at close range. Taken together, the antennal lobe response to 1× human odour is largely explained by individual responses to a subset of perceptually dominant components, including long-chain aldehydes and acetoin (FIG. 5E).

The strong response of the H glomerulus to physiological concentrations of decanal and undecanal in human odour (FIG. 5D) suggests it may be selectively tuned to long-chain aldehydes. To rigorously test this hypothesis and more broadly explore the tuning of all three focal glomeruli, we next imaged the response of H, B, and A to a panel of 50 compounds all delivered at approximately the same vapour-phase concentration (FIG. 5F, FIGS. 13B-D, target concentration set to that of sulcatone in 1× human odour). The panel included compounds that were (1) identified in our odour extracts (≥0.1% abundance in any host blend), (2) suggested by the literature to be ecologically relevant for mosquitoes, or (3) structurally similar to decanal/undecanal (see Methods for details).

As hypothesized, the H glomerulus responded selectively to long-chain aldehydes (FIG. 5F, FIG. 13B). Both response amplitude and duration increased with aldehyde chain length, from the 6-carbon hexanal that evoked no response to the 11-carbon undecanal that evoked strong activity lasting 40+ seconds beyond the 3-second puff (FIG. 5G). Compounds chosen for their chemical similarity to decanal and undecanal sometimes generated modest responses, but these were weaker than those evoked by the long-chain aldehydes themselves (FIG. 5F, FIG. 13B). The B glomerulus, in contrast, showed broad tuning. It responded to more than half of all compounds in the panel, including human-biased, animal-biased, and unbiased odorants (FIG. 5F, FIG. 13B), consistent with its broad response to all complex blends in our sample.

The A glomerulus was strongly activated by four compounds found in our host odour blends (FIG. 5F). One of these (acetoin) was human-biased (FIG. 4C), but present in 1× human odour at a concentration too low to evoke consistent activity in A (FIG. 5C). The other three (dimethyl sulfone, phenol, p-cresol) were animal-biased in our samples (FIGS. 11F and I). However, they were previously shown to be enriched in vertebrate faeces and urine^{17,44}, which were occasionally passed by the smaller animal species during odour extraction (FIG. 2E). Further work will therefore be needed to determine whether the A glomerulus truly provides an animal-biased signal useful for host discrimination. In contrast, it is clear that H is selectively activated by human odour due to its narrow tuning to long-chain aldehydes, and B responds to a wide array of natural blends due to broad tuning at the single-odorant level.

### H Glomerulus Activation Enhances Host-Seeking

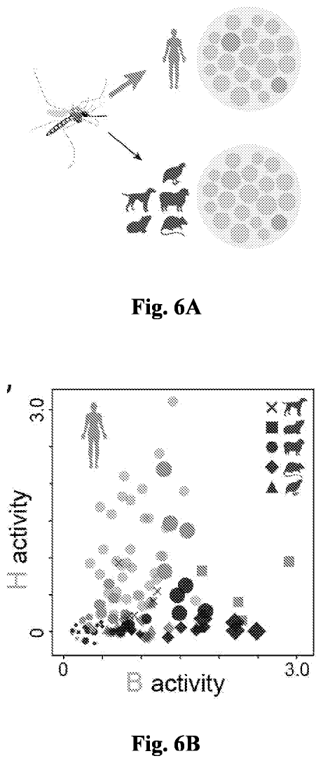

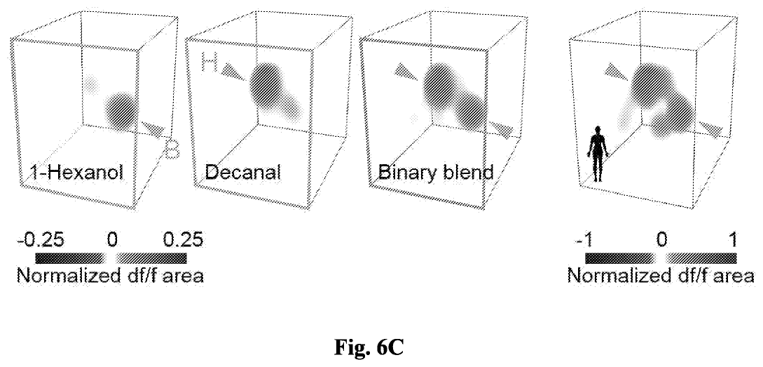

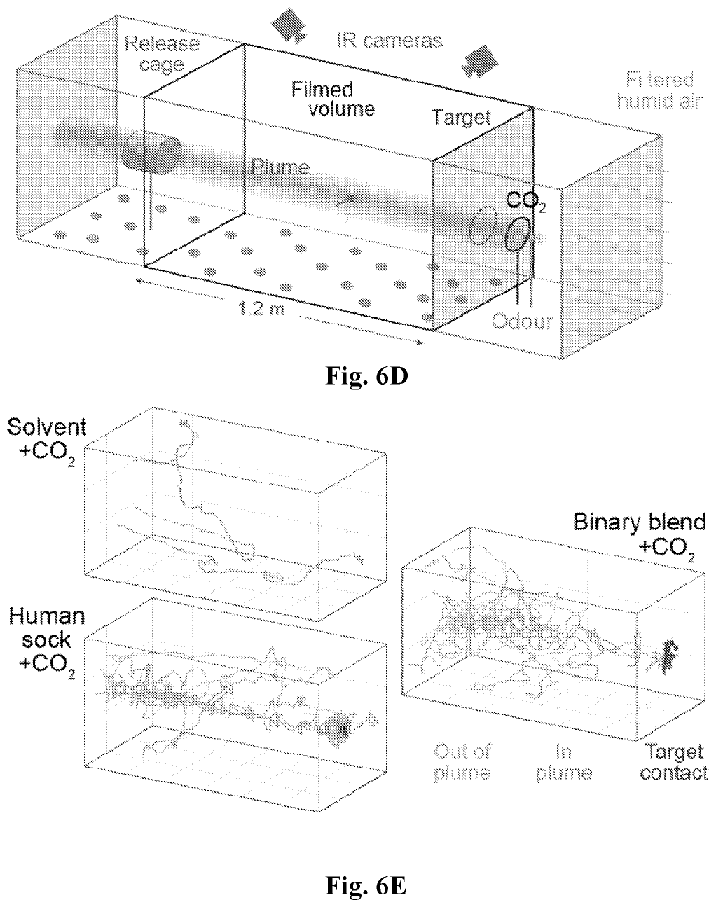

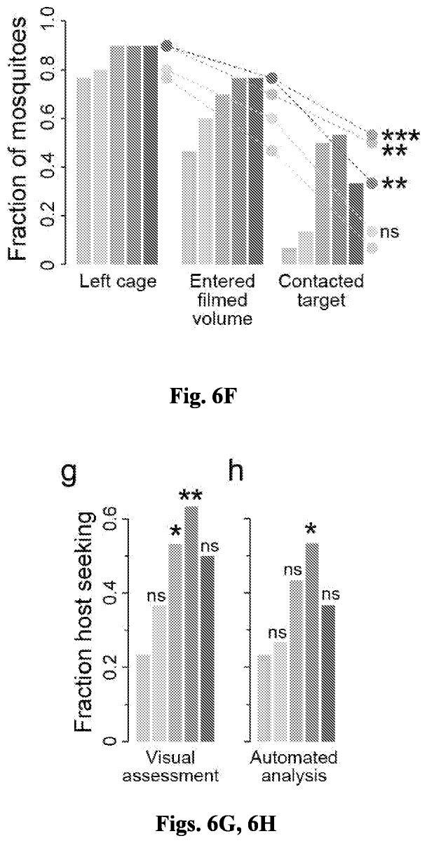

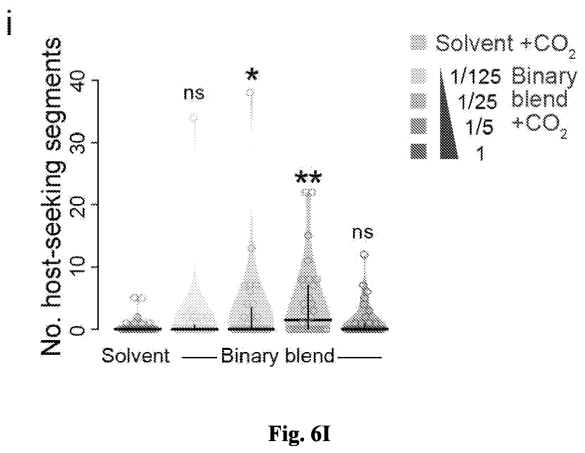

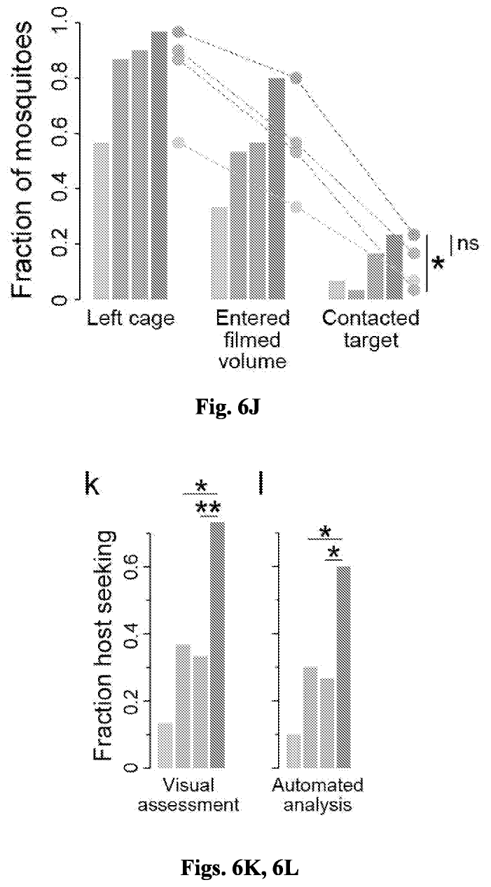

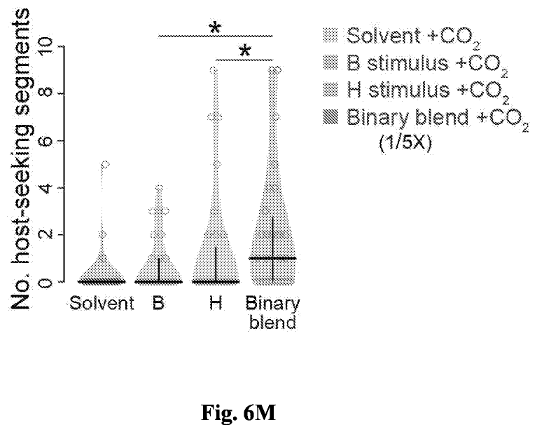

Human odour evoked consistent activity in both B and H glomeruli, while animal odour evoked strong activity in B, but no activity or only weak activity in H (FIG. 6A). While not the only host-responsive signals in the antennal lobe, these two glomeruli alone generate a simple neural code capable of robustly separating human and animal blends at the single-trial level (FIG. 6B). Do female mosquitoes leverage these signals for host seeking and discrimination? To answer this question, we characterized the behaviour of females exposed to a synthetic binary blend that is distinct from human odour but formulated to evoke similar strong activity in B and H glomeruli (FIG. 6C, see Methods). We specifically tested long-range attraction in a wind tunnel (FIG. 6D), reasoning that this stage of the host-seeking behavioural sequence is likely to rely on the olfactory responses that dominate at low to moderate host-odour concentrations. Signals evoked by more concentrated host odour, as well as thermal and visual cues, likely come into play at close range²³.

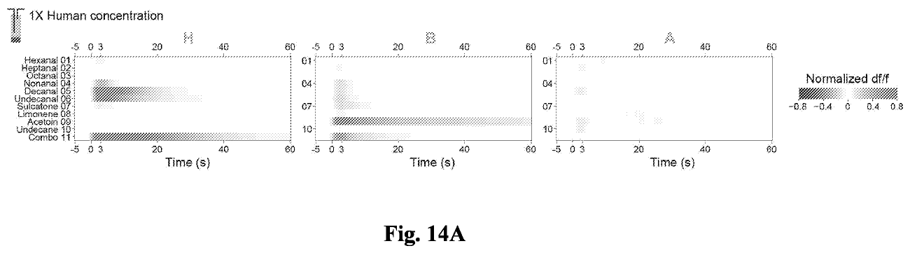

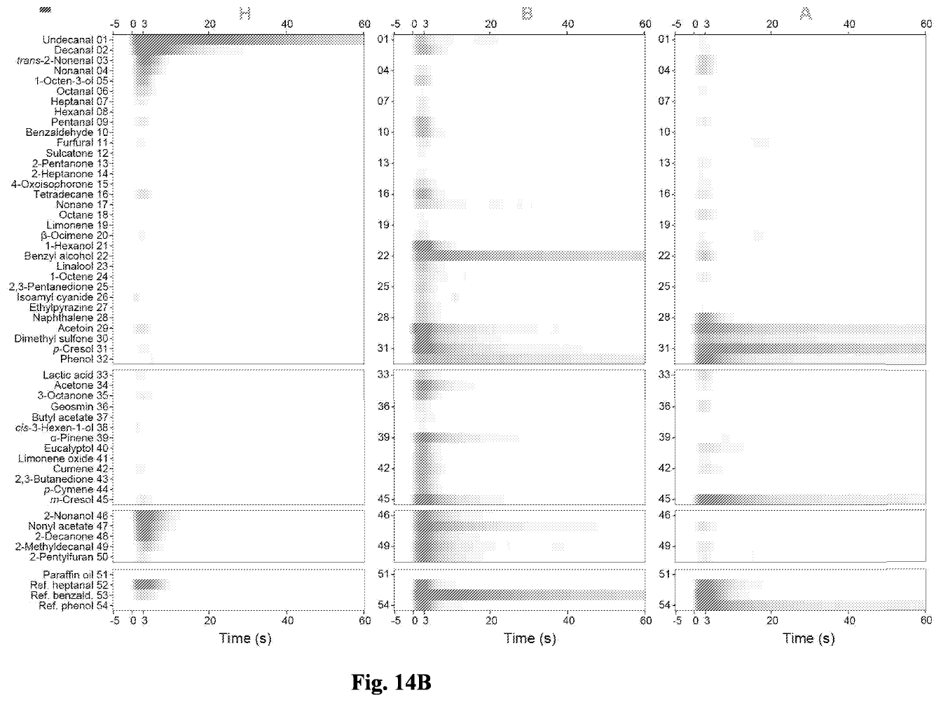

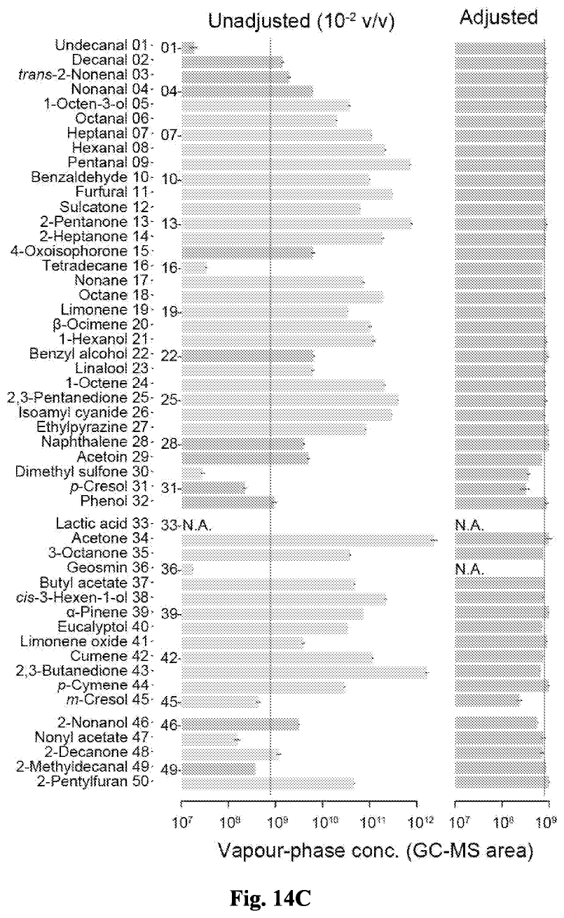

When combined with the mosquito activator carbon dioxide, the binary blend evoked a characteristic plume-tracking behaviour similar to that evoked by a human-worn sock but rarely observed in response to a solvent control⁴⁵ (FIG. 6E). This behaviour was dose-dependent, peaking at a concentration that generated neural activity similar to ⅕× human odour (FIGS. 6F-I, FIG. 14). It also depended on activity in both B and H, as revealed by testing of single blend components that activate either glomerulus individually (FIGS. 6J-M, FIG. 14). Most importantly, coactivation of B and H elicited stronger host seeking than activation of B alone (FIGS. 6J-M), just as human odour elicits stronger host seeking than animal odour (FIGS. 1A-D).

### Discussion

Animal survival and reproduction often depend on the ability to discriminate among complex odour blends without prior experience. Here we investigate the innate preference of Ae. aegypti mosquitoes for human odour, offering insight into how such discrimination is achieved at the neural level. We show that human odour is enriched in long-chain aldehydes and that these aldehydes generate strong and prolonged activity in a selectively tuned olfactory glomerulus within the mosquito brain. Activation of this glomerulus alongside a second, broadly tuned glomerulus drives robust host seeking, resulting in a binary signal with the potential to explain preference for human over animal odour at long range. The simplicity of this pattern belies the complexity of the underlying stimuli and suggests that sparse coding may be a general feature of innate olfactory responses, even to multi-component blends^{18,19}.

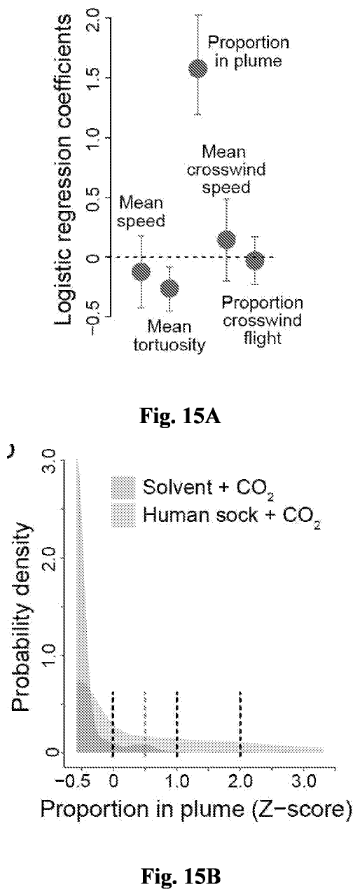

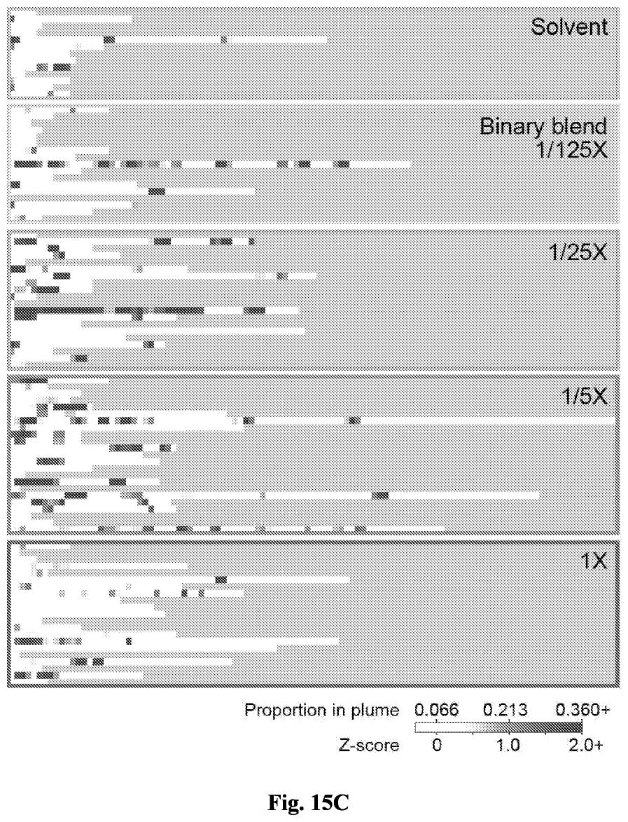

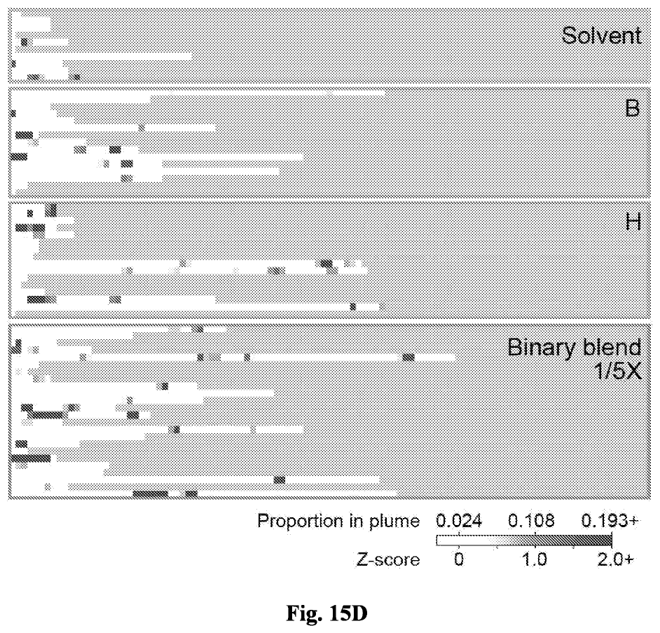

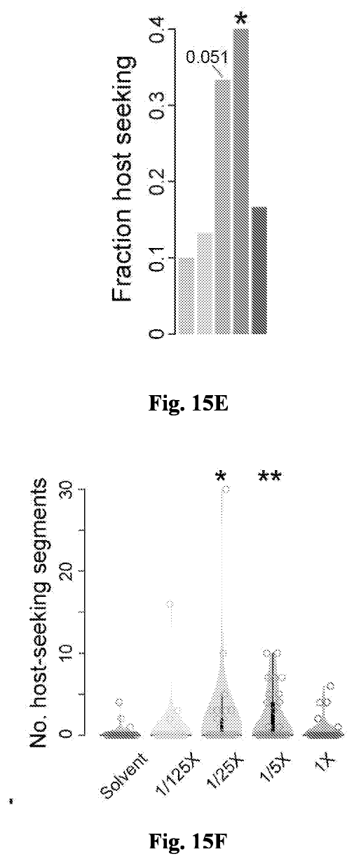

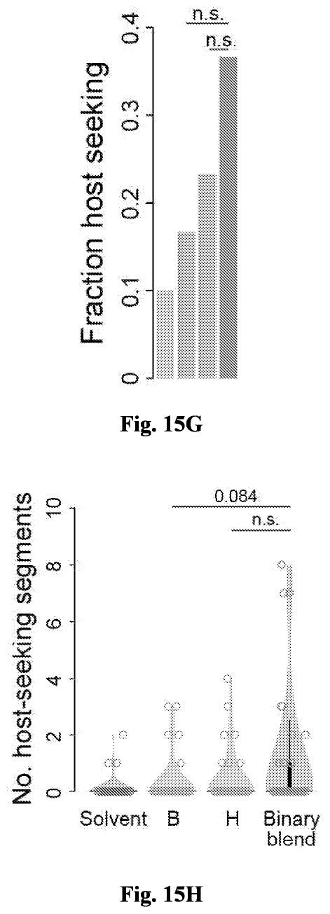

While we have shown that activation of H enhances host-seeking, current knowledge and genetic tools do not yet allow us to conduct the converse experiment—to silence H and measure the extent to which it is required for host-seeking and preference. We expect H will be required for robust discrimination between humans and animals in at least some contexts. After all, H represents the most prominent human-biased signal in the OR/Orco pathway, which is itself required for such behaviour²⁹. Nevertheless, other Orco+ glomeruli may contribute, including those that respond only at high odour concentrations (FIGS. 3B-D). It is also important to note that even orco mutants are strongly attracted to host odour and retain a weak preference for humans in olfactometer assays²⁹. These residual responses must be largely mediated by the second major olfactory pathway in mosquitoes, made up of acid- and amine-sensing neurons that express ionotropic receptors (IRs)^{38-40,46}. Our own preliminary imaging in mosquitoes that express GCaMP in all glomeruli revealed additional host-responsive signals in non-Orco regions of the antennal lobe, but no clear human-biased activity (FIG. 15). A more complete characterization of IR-based responses to human and animal odours is nevertheless an important area for future research.

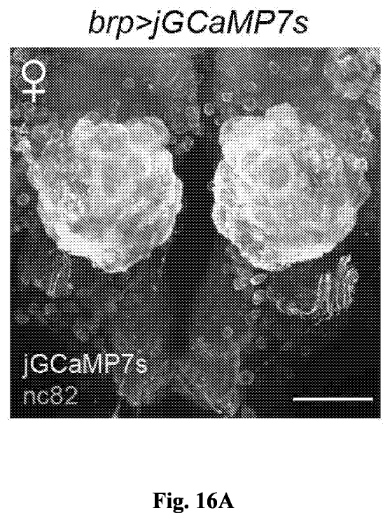

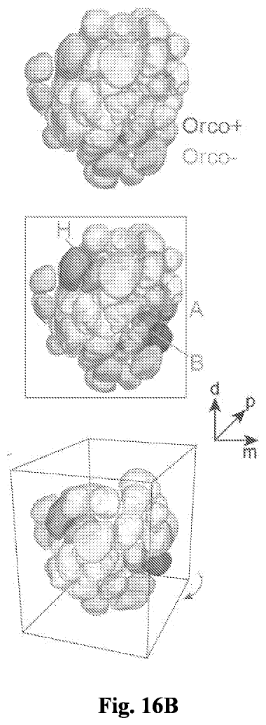

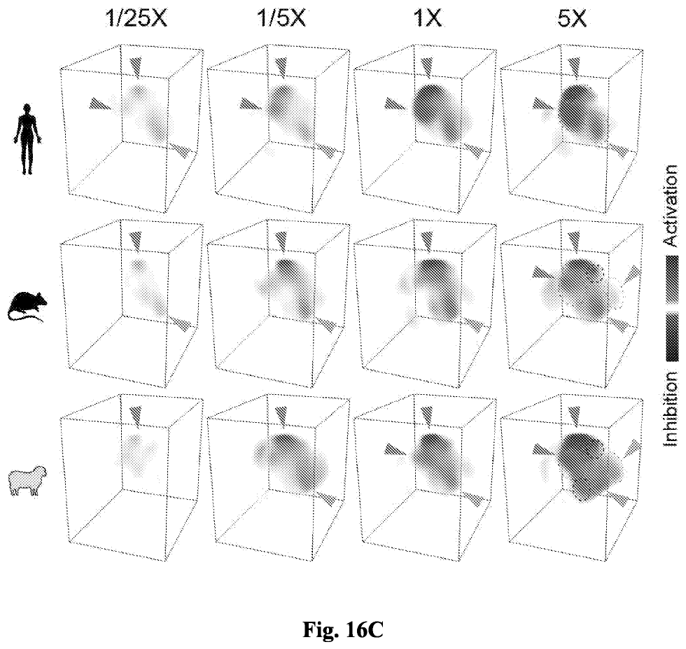

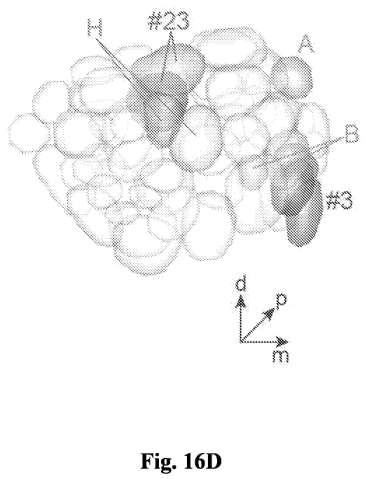

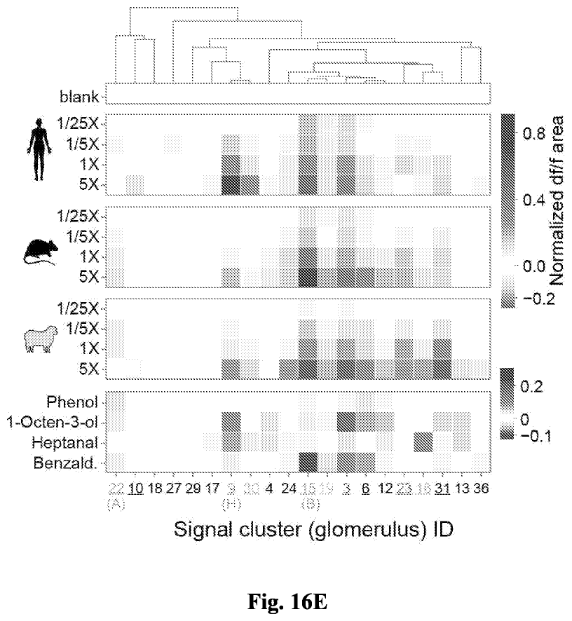

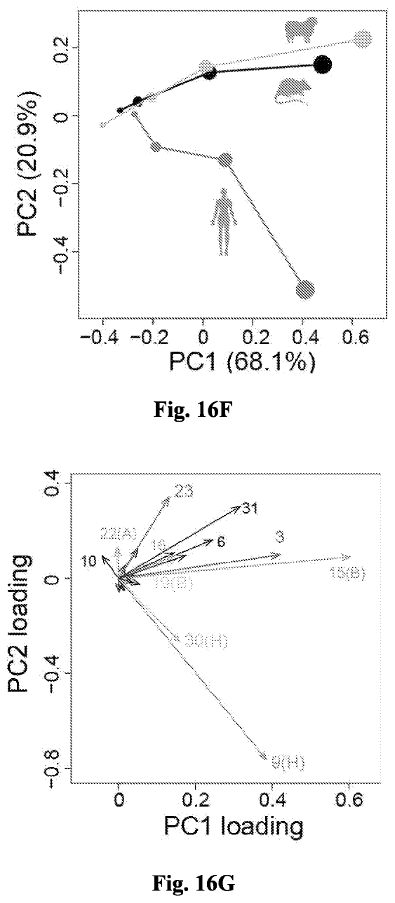

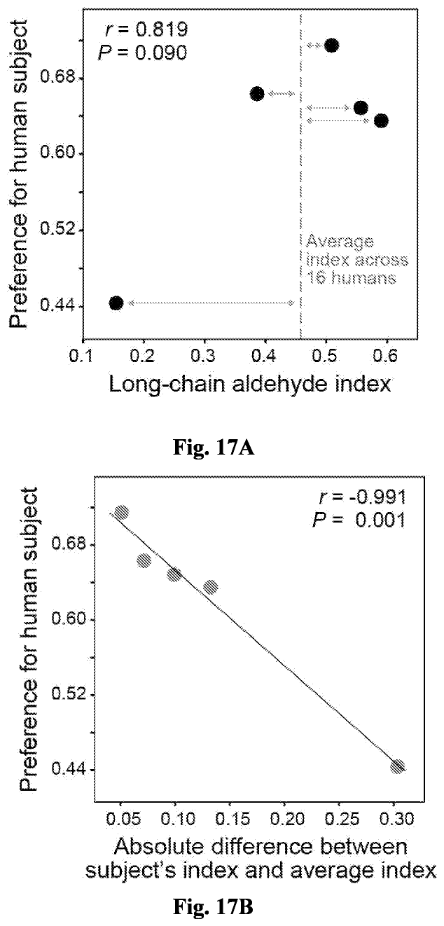

Our work also sheds light on the compounds mosquitoes may be using to discriminate among hosts. Most people associate human body odour with sweat, but the odorants we found to be important for host discrimination are likely derived from sebum (FIG. 4D), an oily substance secreted at the base of hair follicles. Sebum composition tends to be species-specific⁴⁷, and its output is temporally stable—as high at rest as when active⁴⁸. These features make sebum derivatives reliable targets for human-seeking mosquitoes. Interestingly, sebum composition⁴⁹ and long-chain aldehyde levels (FIG. 4A) also vary among individual humans, albeit on a smaller scale than the difference between humans and animals. Moreover, among the handful of people who participated in our preference assays (FIG. 1), those with long-chain aldehyde levels close to the human average were more likely to be targeted by Ae. aegypti than those with lower or higher levels (FIG. 16, see also recent work linking preference for individual humans to sebum-derived acids⁴⁶). This raises the intriguing possibility that the evolution of preference for humans over animals spills over to affect the choices mosquitoes make when targeting individual humans. Altogether, our work provides new insight into mosquito preference for humans and the neural coding of complex olfactory stimuli that animal brains have evolved to discriminate.

### REFERENCES

1. Powell, J. R., Gloria-Soria, A. & Kotsakiozi, P. Recent history of Aedes aegypti: vector genomics and epidemiology records. BioScience 68, 854-860 (2018).
2. Gouck, H. K. Host preferences of various strains of Aedes aegypti and A. simpsoni as determined by an olfactometer. Bull. World Health Organ. 47, 680-683 (1972).
3. McBride, C. S. et al. Evolution of mosquito preference for humans linked to an odorant receptor. Nature 515, 222-227 (2014).
4. Dormont, L., Bessière, J.-M. & Cohuet, A. Human skin volatiles: a review. J. Chem. Ecol. 39, 569 578 (2013).
5. Jaleta, K. T., Hill, S. R., Birgersson, G., Tekie, H. & Ignell, R. Chicken volatiles repel host-seeking malaria mosquitoes. Malar. J. 15, 354 (2016).
6. Verhulst, N. O. et al. Do apes smell like humans? The role of skin bacteria and volatiles of primates in mosquito host selection. J. Exp. Biol. 221, (2018).
7. Syed, Z. & Leal, W. S. Acute olfactory response of Culex mosquitoes to a human- and bird-derived attractant. Proc. Natl. Acad. Sci. 106, 18803-18808 (2009).
8. Malnic, B., Hirono, J., Sato, T. & Buck, L. B. Combinatorial receptor codes for odors. Cell 96, 713-723 (1999).
9. Chong, E. et al. Manipulating synthetic optogenetic odors reveals the coding logic of olfactory perception. Science 368, (2020).
10. Wang, J. W., Wong, A. M., Flores, J., Vosshall, L. B. & Axel, R. Two-photon calcium imaging reveals an odor-evoked map of activity in the fly brain. Cell 112, 271-282 (2003).
11. Joerges, J., Küttner, A., Galizia, C. G. & Menzel, R. Representations of odours and odour mixtures visualized in the honeybee brain. Nature 387, 285-288 (1997).
12. Ruta, V. et al. A dimorphic pheromone circuit in Drosophila from sensory input to descending output. Nature 468, 686-690 (2010).
13. Stensmyr, M. C. et al. A conserved dedicated olfactory circuit for detecting harmful microbes in Drosophila. Cell 151, 1345-1357 (2012).
14. Demir, E. et al. The pheromone darcin drives a circuit for innate and reinforced behaviours. Nature 578, 137-141 (2020).
15. Nakagawa, T., Sakurai, T., Nishioka, T. & Touhara, K. Insect sex-pheromone signals mediated by specific combinations of olfactory receptors. Science 307, 1638-1642 (2005).
16. Knudsen, J. T., Eriksson, R., Gershenzon, J. & St\dot{a}hl, B. Diversity and distribution of floral scent. Bot. Rev. 72, 1 (2006).
17. Mansourian, S. et al. Fecal-derived phenol induces egg-laying aversion in Drosophila. Curr. Biol. 26, 2762-2769 (2016).
18. Lin, D. Y., Shea, S. D. & Katz, L. C. Representation of natural stimuli in the rodent main olfactory bulb. Neuron 50, 937-949 (2006).
19. Semmelhack, J. L. & Wang, J. W. Select Drosophila glomeruli mediate innate olfactory attraction and aversion. Nature 459, 218-223 (2009).
20. Riffell, J. A., Lei, H., Christensen, T. A. & Hildebrand, J. G. Characterization and coding of behaviorally significant odor mixtures. Curr. Biol. 19, 335-340 (2009).
21. Schubert, M., Hansson, B. S. & Sachse, S. The banana code-natural blend processing in the olfactory circuitry of Drosophila melanogaster. Front. Physiol. 5, 59 (2014).
22. Rose, N. H. et al. Climate and urbanization drive mosquito preference for humans. Curr. Biol. 30, 3570-3579.e6 (2020).
23. Cardé, R. T. Multi-cue integration: how female mosquitoes locate a human host. Curr. Biol. 25, R793 R795 (2015).
24. Takken, W. & Verhulst, N. O. Host preferences of blood-feeding mosquitoes. Annu. Rev. Entomol. 58, 433-453 (2013).
25. Geier, M., Bosch, O. J. & Boeckh, J. Ammonia as an attractive component of host odour for the yellow fever mosquito, Aedes aegypti. Chem. Senses 24, 647-653 (1999).
26. Bernier, U. R., Kline, D. L., Allan, S. A. & Barnard, D. R. Laboratory comparison of Aedes aegypti attraction to human odors and to synthetic human odor compounds and blends. (2007).
27. Mclver, S. B. Sensilla of mosquitoes (Diptera: Culicidae). J. Med. Entomol. 19, 489-535 (1982).
28. Vosshall, L. B. & Stocker, R. F. Molecular architecture of smell and taste in Drosophila. Annu. Rev. Neurosci. 30, 505-533 (2007).
29. DeGennaro, M. et al. orco mutant mosquitoes lose strong preference for humans and are not repelled by volatile DEET. Nature 498, 487 491 (2013).
30. Kistler, K. E., Vosshall, L. B. & Matthews, B. J. Genome engineering with CRISPR-Cas9 in the mosquito Aedes aegypti. Cell Rep. 11, 51-60 (2015).
31. Riabinina, O. et al. Organization of olfactory centres in the malaria mosquito Anopheles gambiae. Nat. Commun. 7, 1-12 (2016).
32. Vargo, A. M. & Foster, W. A. Responsiveness of female Aedes aegypti (Diptera: Culicidae) to flower extracts. J. Med. Entomol. 19, 710-718 (1982).
33. Brockerhoff, E. G. & Grant, G. G. Correction for differences in volatility among olfactory stimuli and effect on EAG responses of Dioryctria abietivorella to plant volatiles. J. Chem. Ecol. 25, 1353-1367 (1999).
34. Woolfenden, E. Thermal desorption for gas chromatography. in Gas chromatography (ed. Poole, C. F.) 235-289 (Elsevier, 2012). doi:10.1016/B978-0-12-385540-4.00010-9.
35. Ignell, R., Dekker, T., Ghaninia, M. & Hansson, B. S. Neuronal architecture of the mosquito deutocerebrum. J. Comp. Neurol. 493, 207-240 (2005).
36. Cook, J. I. et al. Enantiomeric selectivity in behavioural and electrophysiological responses of Aedes aegypti and Culex quinquefasciatus mosquitoes. Bull. Entomol. Res. 101, 541-550 (2011).
37. Majeed, S., Hill, S. R., Birgersson, G. & Ignell, R. Detection and perception of generic host volatiles by mosquitoes modulate host preference: context dependence of (R)-1-octen-3-ol. R. Soc. Open Sci. 3, 160467 (2016).
38. Dekker, T., Steib, B., Cardé, R. T. & Geier, M. L-lactic acid: a human-signifying host cue for the anthropophilic mosquito Anopheles gambiae. Med. Vet. Entomol. 16, 91-98 (2002).
39. Pitts, R. J., Derryberry, S. L., Zhang, Z. & Zwiebel, L. J. Variant ionotropic receptors in the malaria vector mosquito Anopheles gambiae tuned to amines and carboxylic acids. Sci. Rep. 7, 40297 (2017).
40. Raji, J. I. et al. Aedes aegypti mosquitoes detect acidic volatiles found in human odor using the IR8a pathway. Curr. Biol. 29, 1253-1262.e7 (2019).
41. Wisthaler, A. & Weschler, C. J. Reactions of ozone with human skin lipids: sources of carbonyls, dicarbonyls, and hydroxycarbonyls in indoor air. Proc. Natl. Acad. Sci. 107, 6568-6575 (2010).
42. Huang, Z.-R., Lin, Y.-K. & Fang, J.-Y. Biological and pharmacological activities of squalene and related compounds: potential uses in cosmetic dermatology. Molecules 14, 540-554 (2009).
43. Prouty, S. M. & Pappas, A. Sapienic acid: species-specific fatty acid metabolism of the human sebaceous gland. in Lipids and skin health (ed. Pappas, A.) 139-157 (Springer International Publishing, 2015). doi:10.1007/978-3-319-09943-9_10.
44. He, X. & Slupsky, C. M. Metabolic fingerprint of dimethyl sulfone (DMSO2) in microbial-mammalian co-metabolism. J. Proteome Res. 13, 5281-5292 (2014).
45. Dekker, T. & Carde, R. T. Moment-to-moment flight manoeuvres of the female yellow fever mosquito (Aedes aegypti L.) in response to plumes of carbon dioxide and human skin odour. J. Exp. Biol. 214, 3480-3494 (2011).
46. Obaldia, M. E. D. et al. Differential mosquito attraction to humans is associated with skin-derived carboxylic acid levels. bioRxiv 2022.01.05.475088 (2022) doi:10.1101/2022.01.05.475088.
47. Nicolaides, N. Skin lipids: their biochemical uniqueness. Science 186, 19-26 (1974).
48. Kligman, A. M. & Shelley, W. B. An investigation of the biology of the human sebaceous gland. J. Invest. Dermatol. 30, 99-125 (1958).
49. Green, S. C., Stewart, M. E. & Downing, D. T. Variation in sebum fatty acid composition among adult humans. J. Invest. Dermatol. 83, 114-117 (1984).
50. Pappas, A., Johnsen, S., Liu, J.-C. & Eisinger, M. Sebum analysis of individuals with and without acne. Dermatoendocrinol. 1, 157-161 (2009).

### Methods

### Ethics and Regulatory Information

The use of live non-human animals and non-human animal hair in olfactometer trials and odour extractions was approved and monitored by the Princeton University Institutional Animal Care and Use Committee (protocol #1999-17 for live guinea pigs and rats; #2113-17 for live quail; #2136F-19 for animal hair). The participation of human subjects in this research was approved by the Princeton University Institutional Review Board (protocol #8170 for olfactometer trials, #10173 for odour extractions). All human subjects gave their informed consent to participate in work carried out at Princeton University. Human-blood feeding conducted for mosquito colony maintenance did not meet the definition of human subjects research, as determined by the Princeton University IRB (Non Human-Subjects Research Determination #6870).

### Mosquito Rearing and Colony Maintenance

All mosquitoes used in this research were reared at 26° C., 75% RH on a 14:10 light/dark cycle. Larvae were hatched in deoxygenated water and fed Tetramin Tropical Tablets (Pet Mountain, 16110M). Pupae were transferred to plastic-bucket or bugdorm cages, and adults were provided access to 10% sucrose solution ad libitum. Females were allowed to blood-feed on a human arm prior to egg collection. The Orlando (ORL) laboratory strain was used for both host-preference-behaviour testing, wind-tunnel experiments, and the generation of the orco-T2A-QF2-QUAS-GCaMP6f and QUAS-GCaMP7s transgenic strain. Imaging was conducted in orco-T2A-QF2-QUAS-GCaMP 6f heterozygote females or the female offspring of a cross between brp-T2A-QF2w55 and QUAS-jGCaMP7s strains.

### Host-Preference Assays

We tested the host preference of mated, non-blood-fed, 7-14 day old females that had been housed overnight with access to water only (no sucrose). We used a two-port olfactometer for choice and no-choice tests involving live hosts (FIGS. 1A and C) or sleeves/hair (FIGS. 1B and D) as previously described3. We first acclimated 75-100 female mosquitoes in the olfactometer for 5 min, then opened a sliding door and activated a fan to pull air through the two host chambers and expose mosquitoes to host odour. Mosquitoes were able to fly upwind, sample the host-odour streams, and choose to enter either host port. After 6 min, we counted the number of mosquitoes trapped in each host port. For two-choice trials with live hosts, one chamber contained a human hand and arm up to the elbow (belonging to one of six 22-43 year old individuals: 3 female, 3 male; 3 Caucasian, 2 East Asian, 1 South Asian). The human exhaled gently near the opening of the chamber once every 30 sec to provide a source of breath. The other chamber contained a guinea pig (Cavia porcellus; one of two 4-5 year old pigmented females), rat (Rattus norvegicus domesticus; one of two 2-6 month old Sprague-Dawley males), or button quail (Coturnix coturnix; one 2-3 year old female). For two-choice trials with animal hair, one chamber contained an arm-length section of a nylon stocking (L'eggs knee highs, black, 100% nylon) worn on a human arm for 24 hours and then stored at −20° C. (same human subjects as in live-host trials). The other chamber contained a fist-sized wad of sheep wool (Ovis aries; from one female Romney sheep) or dog hair (Canis lupus familiaris; from one of four pet dogs-one Portuguese Water Dog, one Bichon, one Yorkie, one Old English Sheepdog). Sheep wool and dog hair was obtained from freshly shorn animals (from a sheep shearer, from a dog-grooming salon, or directly from dog owners) and stored at −20° C. in sealed glass jars or odour-resistant nylon bags for up to 8 months before use. Both human-worn sleeves and animal wool/hair were supplemented with 1 sec on/1 sec off pulses of synthetic CO₂ (˜1200 ppm). No-choice trials included the human or animal stimulus in one port with the second port left empty (air only).

We used a beta-binomial mixed generalized linear model (R⁵⁶ package glmmTMB⁵⁷) to model the probability of an individual mosquito choosing human versus each animal species in two-choice tests while accounting for overdispersion caused by trial-to-trial variation. Animal host species was included as a fixed factor, and date and individual human as random factors. We then extracted the model-estimated mean probability of choosing human with 95% confidence intervals (R package emmeans⁵⁸) and converted this probability (p) to a preference index (PI=2p−1) for data visualization. For no-choice trials, we used the same type of model to estimate the probability of responding to the given host, with host species included as a fixed factor and date as a random factor. The R function cld was used for pairwise comparison of least-square means.

### Generation of Orco-T2A-QF2-QUAS-GCaMP6f Strain

We used CRISPR-mediated homologous recombination (as described³⁰) to knock in the QF2 transcription factor^{55,59,60} followed by the QUAS promoter (9 copies) and GCaMP6f⁶¹ coding sequence into the endogenous orco (AAEL005776) locus of the Ae. aegypti genome. We designed an sgRNA targeting the last exon of orco (GTCACCTACTTCATGGTGTTGG, PAM sequence underlined), generated template DNA by primer annealing with the NEBNext High-Fidelity polymerase (NEB, M0541S), and carried out in vitro transcription using the HiScribe T7 Kit (NEB, E2040S) by incubating at 37° C. for 8 hours. We purified the transcription products using RNAse-free SPRI beads (Agencourt RNAclean XP, Beckman-Coulter A63987) and eluted them in Ambion nuclease-free water (Life Technologies, AM9937). We constructed the T2A-QF2-9×QUAS-GCaMP6f-3XP 3-dsRed donor plasmid (FIG. 2a) using the InFusion HD Kit (Clontech, 638910). To preserve the orco coding sequence, the final 6 codons downstream of the cut site were included in the donor plasmid 5′ of the T2A, with synonymous codon substitutions incorporated to protect the sequence from Cas9 cleavage and minimize homology between the plasmid insert and the targeted locus. Homology arms (˜1 kb) flanking the Cas9 cut site were amplified from ORL-strain genomic DNA via PCR. We found two divergent orco haplotypes segregating in ORL at similar frequency and therefore generated two versions of the donor plasmid with distinct homology arms. These two donors were mixed together for embryo injection (450 ng/μL each), along with sgRNA (80 ng/μL) and Cas9 protein (300 ng/μL; PNA Bio, CP01-200). A total of 1500 ORL embryos were injected at the Insect Transformation Facility at the University of Maryland Institute for BioScience & Biotechnology, yielding two independent transgenic lines with the construct inserted into the two distinct endogenous orco haplotypes. Insertion sites and sequences were verified by PCR and sequencing. The two lines showed indistinguishable patterns of GCaMP expression in the brain and peripheral organs, so we focused on the one corresponding to the major orco haplotype found in the AaegL5 reference genome⁶². This line was outcrossed to ORL for 8-9 generations. All experiments were carried out in heterozygotes, which displayed normal fitness and olfactory behaviours including strong attraction to/preference for human odour (data not shown). Homozygotes are also viable and appear healthy.

### Plasmids and Primers:

Plasmid backbone: psL1180, linearized with
restriction enzymes NsiI-HF (New England Biolabs
#R3127S) and AvrII (New England Biolabs #R0174S).
sgRNA template:
forward 5′-GAAATTAATACGACTCACTATAGTCACCTACTTCATGGT
GTGTTTTAGAGCTAGAAATAGC-3′,
reverse 5′-AAAAGCACCGACTCGGTGCCACTTTTTCAAGTTGATAAC
GGACTAGCCTTATTTTAACTTGCTATTTCTAGCTCTAAAAC-3′
Donor plasmid homology arms haplotype 1: left arm,
forward 5′-CAGGCGGCCGCCATAGAGTTTCGCTTTTCCACGCG-3′,
reverse 5′-CCCTCTCCCGATCCATCCTTGAGTTGAACGAGAACCATG
AAGTAGGTGACGACC-3′;
right arm,
forward 5′-TGTATCTTATCCTAGTGTTGGTGCAGTTGAAATAATT
C-3′,
reverse 5′-TATTAATAGGCCTAGAACTTACTTAAATCTGTGAAAT
CTCAGACC-3′.
Donor plasmid homology arms haplotype 2: left arm,
forward 5′-CAGGCGGCCGCCATA TTCAACGAGAGAAACGAAAGT
T-3′,
reverse 5′-CCCTCTCCCGATCCATCCTTGAGTTGAACGAGAACCATG
AAGTAGGTGACGACC-3′;
right arm,
forward 5′-TGTATCTTATCCTAGTGTTGGTGCAGTTGAAATAATT
C-3′,
reverse 5′-TATTAATAGGCCTAGTCCACCTACGTATCATGACTA
G-3′.
Sanger sequencing verification:
forward 5′-AGCTGACCCTGTTGGCTTAC-3′,
reverse 5′-CTTCAGCTTCAGGGCCTT-3′.

### Characterization of GCaMP Expression in Orco-T2A-QF2-QUAS-GCaMP6f Strain

Brain. Brain immunostaining was carried out as previously described⁶⁰. Heads of 7-10 day old mated mosquitoes were fixed in 4% paraformaldehyde (Electron Microscopy Sciences, 15713-S) for 3 hours at 4° C. Brains were dissected in PBS and blocked in normal goat serum (2%, Fisher Scientific, 005-000-121) for 2 days at 4° C. We then incubated brains in primary antibody solution for 2-3 days, followed by secondary antibody solution for another 2-3 days at 4° C. Brains were mounted in Vectashield (Vector, H-1000) with the anterior or posterior side facing the objective. Confocal stacks were taken with a 20× or 40× oil lens with an XY resolution of 1024×1024 and Z-step size of 1 μm. Primary antibodies: rabbit anti-GFP (1:10,000 dilution, ThermoFisher, A-11122) and mouse nc82 (1:50 dilution, DHSB, AB_2314866). Secondary antibodies: goat-anti-rabbit Alexa 488 (1:500 dilution, ThermoFisher, A27034SAMPLE), goat-anti-mouse CF680 (1:500 dilution, Biotium, 20065-1) and goat-anti-mouse Cy3 (1:500 dilution, Jackson ImmunoResearch, 115-165-062). We also dissected and stained the brains of 7-10 day old females whose sensory appendages had been removed with sharp forceps or micro-knives 5 days earlier.

### Peripheral Organs.

We removed the antenna, maxillary palp, or proboscis of 7-10 day old female mosquitoes with sharp forceps. We then dipped them in pure ethanol for ˜15 sec and mounted them on slides in pure glycerol for direct confocal imaging.

### Reconstruction of Glomeruli.

We manually traced and reconstructed glomeruli according to the atlas in an early neuroanatomical study³⁵ using the TrakEM2 package⁶³ in ImageJ⁶⁴, with two modifications: (1) We could not reliably identify 5 glomeruli in the original atlas (CD1-4, PD7). (2) We and others^{51,65} have found that a large portion of the anterior AL, previously termed the Johnston's organ centre³⁵ (JOC), is innervated by Orco+axons, consistent with recent work in Anopheles gambiae³¹. We therefore divided the JOC into 9 glomeruli based on nc82 neuropil staining, noting that the glomerular boundaries in this region were less clear than in other parts of the AL. Together with the ˜50 glomeruli from the original atlas, we find a total of ˜60 glomeruli. This number is similar to the ˜65 total glomeruli reported in a second recent study that used nc82 staining in transgenic mosquitoes⁵¹. However, a third recent study that employed both nc82 and phalloidin staining reported ˜80 glomeruli, with the extra glomeruli falling within the former JOC region⁶⁵. We consider our number (˜60) to be a conservative estimate, but acknowledge that consensus has not yet been reached, and estimates may change in future. When describing the orientation of the AL in text and figures (e.g. FIG. 2b, FIG. 3), we and other recent studies^{51,65} differ from the original atlas³⁵ in specifying the ventral/dorsal and anterior/posterior axes in the same way as they are specified in Drosophila⁶⁶.

### Generation of QUAS-jGCaMP7s-T2A-tdTomato Strain

We used pBac-mediated transposition according to a previously published method⁶⁷ to generate a QUAS-jGCaMP7s-T2A-tdTomato effector strain that could be used in concert with a pan-neuronal driver⁵⁵ to image from all glomeruli (Extended Data FIG. 9). Briefly, we generated the template for in vitro transcription of pBac mRNA via PCR amplification from a plasmid containing the pBac coding sequence (primers forward 5′-GAAACTAATACGACTCACTATAGGGAGAGCCGCCACATGGGTAGTTCTTT AGACGATG-3′, reverse 5′-CTTATTAGTCAGTCAGAAACAAC-3′). The PCR amplicon was purified using RNAse-free SPRI beads (Agencourt RNAclean XP, Beckman-Coulter A63987) and then used for in vitro transcription with the HiScribe T7 ARCA mRNA Kit (with tailing, NEB, E2060S). Transcription products were purified using RNAse-free SPRI beads, and eluted in Ambion nuclease-free water (Life Technologies, AM9937). The transgene plasmid was generated using the InFusion HD Kit (Clontech, 638910) and the NucleoBond Xtra Midi EF Kit (Macherey-Nagel, 740420.10). jGCaMP7s was cloned from a Drosophila melanogaster fly that contained the jGCaMP7s transgene (a gift from Mala Murthy; primers forward 5′-CGCGGCTCGAGCAAAATGGGCTCACATCATCACCA-3′, reverse 5′-GGCCCTCTCCCGATCCTTTGGCGGTCATCATTTGTACG-3′). A mixture of transgene plasmid (500 ng/μL) and pBac mRNA (300 ng/μL) was injected into 181 ORL embryos. We obtained 48 GO adults and outcrossed them individually to ORL wildtype. Eleven G1 families were 3XP3-ECFP positive and further outcrossed to ORL. Ten families remained positive at G2. We outcrossed positive families to ORL for more generations and then randomly chose one family to cross with the brp-T2A-QF2w driver line⁵⁵. For the chosen QUAS-jGCaMP7s-T2A-tdTomato family (P1), the insertion was mapped to Chr3: 191,630,173 via the TagMap method⁶⁸.

### Two-Photon Imaging

### Microscope Design.

We designed a two-photon microscope that incorporates both resonant scanning⁶⁹ and remote focusing^{70,71} to achieve rapid, volumetric, in vivo neural imaging. Remote focusing allows rapid switching of the imaging plane by moving a small, lightweight mirror located upstream in the imaging path. This alternative focusing method does not involve mechanical movements near the specimen, thereby avoiding specimen agitation and permitting axial scan speeds faster than those associated with traditional piezo-objective units. In diagnostic tests, transition times for switching between two planes were less than 6 ms. The combination of an 8 kHz resonant scanner and remote focusing resulted in volumetric-stack-imaging speeds of 512 pixels×512 lines×10 planes at 3 Hz.

The microscope uses a pulsed (80 MHz) Ti: Sapphire laser (Coherent Chameleon Vision II) tuned to 920 nm, with laser intensity rapidly controlled on the us timescale with a pockel cell (Conoptics 350-80-LA-02 KD*P). The beam entering the microscope is first sent through a half-wave plate (Thorlabs AHWP10M-980), a polarizing beam splitter cube (Thorlabs PBS252), and a quarter-wave plate (Thorlabs AQWP10M-980) before entering the remote objective (Olympus UPLFLN40×). It is then reflected on a 7 mm mirror (Thorlabs PF03-03-P01) mounted on a voice coil (Equipment Solutions LFA2004). The beam then crosses the remote objective and the quarter-wave plate in reverse direction before being reflected by the polarizing beam splitter cube. It then enters a non-magnifying relay telescope made of two identical achromatic lenses (Thorlabs AC254-150-B) that brings it to the scanning unit located in a plane conjugated to the remote focus objective back aperture. The scanning unit includes an 8 kHz resonant scanner (Cambridge Technologies CRS8) for the fast axis and a 6 mm galvanometer scanner (Cambridge Technologies 6215H). The beam then travels through the 150 mm scan lens (Thorlabs AC508-150-B) and a 200 mm tube lens (2 identical lenses, Thorlabs AC508-400-B) to reach the imaging objective (Olympus LUMPLFL 40× Water, NA 0.8), whose back aperture is conjugated to the scanning unit. The distance between the scan lens and the tube lens is precisely set to be the sum of their respective focal lengths, a condition that minimizes optical aberrations when using remote focusing^{70,71}. The microscope's field of view is 550 μm in diameter.

The quantity of glass present in the optical path of this microscope generates significant group-delay dispersion, for which the laser internal pre-compensator cannot fully compensate. This results in lower fluorescence excitation. We therefore added another compensator made of a pair of SF10 prisms (Newport 06SF10), through which the beam passes before entering the microscope. We adjusted the distance between prisms to roughly maximize the fluorescence signal, then relied on the laser internal pre-compensation unit for fine maximization.

The fluorescence signal is separated from the laser path by a dichroic mirror (Semrock FF670-SDiO1) and detected by GaAsP photomultipliers (PMT; Hamamatsu H10770PA-40) after successively passing through a multiphoton short-pass emission filter (Semrock FF01-720sp), a dichroic mirror (Semrock FF555-Dio3), and a band-pass filter (Semrock FF02-525/40-25 for the green channel; Semrock FF01-593/40-25 for the red channel). The PMT output signals are amplified (Edmund Optics 59-179) and digitized (National Instrument PXIe-7961R FlexRIO). The microscope is controlled by the ScanImage (Vidrio) software using additional analogue output units (PXIe-6341, National Instruments) for the laser-power control, the scanners control, and the voice-coil control.

Mosquito preparation.

We custom-designed a mosquito holder with a 3D-printed plastic frame and thin stainless-steel plate (FIG. 2C, thickness 0.001 inch). A tiny mosquito-head-sized hole was photo-chemically etched on the plate (ETCHIT Company). To prepare for imaging, we anaesthetized a female on ice for ˜1 min, pushed the anterodorsal side of her head into the hole, and fixed it with UV glue (RapidFix 6121830ES). The antennae, maxillary palps, and proboscis remained below the metal plate and contacted neither the plate nor the glue. We added room-temperature saline (103 mM NaCl, 3 mM KCl, 5 mM TES, 26 mM NaHCO₃, 1 mM NaH₂PO₄, 1.5 mM CaCl₂), 4 mM MgCl₂, 10 mM Trehalose, 10 mM Glucose; pH 7.1) to the holder and used sharp forceps to remove a section of the head capsule (including both cuticle and the edge of the eyes) from the part of the head protruding through the metal plate. During imaging, we continuously perfused saline bubbled with carbogen (5% CO₂, 95% O₂) through the holder and across the open head capsule at 125 ml/hour.

### Data Acquisition.

We used the ScanImage⁷² package in Matlab to control the microscope and acquire images. For each individual, we chose either the right or left antennal lobe (AL) and recorded movies of odour-evoked activity (starting 7-30 sec before and continuing 20-60 sec after synthetic-odorant puffs; ˜30 sec before, ˜140 sec after puffs of complex extract). The movies covered the entire AL in Z-stacks that were 4 μm apart at 128×128 pixel resolution (22 stacks total, green channel only for the orco-T2A-QF2-QUAS-GCaMP 6f strain; 28 stacks, green and red channels for the brp>jGCaMP7s strain). The resulting voxel size was approximately 0.9×0.8×4 μm³, and the volumetric imaging rate was 3.76 Hz for the orco-T2A-QF2-QUAS-GCaMP 6f strain and 2.95 Hz for the brp>jGCaMP7s strain. We increased the laser power exponentially with depth (ranging from 7.5 to 10 mW) to account for light decay and scattering in deeper tissues. Laser power as measured at the sample plane was 10 mW. After recording odour-evoked activity, we acquired 30-40 high-resolution structural volumes at high laser power to aid registration and downstream analysis. For this, we imaged the AL in 120-180 z-stacks, 1 μm apart, at 256×256 pixel resolution.

### Two-Photon Data Analysis

### Reference-Odorant Selection.

We selected reference odorants based on a preliminary imaging data set comprising the glomerular responses to 60 candidate odorants (n=2 mosquitoes). After extracting glomerular signals, we obtained a (glomerulus×odorant) matrix A of mean odorant responses. We then employed the ConvexCone algorithm (see below) to select c=1, . . . , N columns (corresponding to odorants) from A into a series of matrices C₁, . . . , C_{N} and measured the respective norm error ∥A−C_{c}×_{c}∥. This norm error decreased quickly with increasing c (FIG. 8D), suggesting that a small subset of odorants can account for a large part of the matrix norm (variance/glomerular activity). Accordingly, we chose the 11 odorants that best reduced the norm error, along with three odorants that were of special interest (sulcatone, 1-octen-3-ol, phenylethylamine), as reference odorants for all subsequent imaging.

### Motion Correction and Morphological Registration.

We first performed 3D motion correction on each volumetric movie of odour-evoked activity using the NoRMCorre package⁷³. For the orco-T2A-QF2-QUAS-GCaMP6f strain, images in the green channel were used for motion correction; for the brp>jGCaMP7s strain, the red channel was used. We then used the warp function in the Computational Morphometry Toolkit (CMTK, http://nitrc.org/projects/cmtk) to correct for potential motion and brain deformation between movies from the same brain. We created the two-photon AL template by iteratively registering and averaging the ALs from 13 high-quality brains with the CMTK warp and avg_adm functions. We registered each AL to the two-photon template, again using the CMTK warp function, so all brains were aligned in the same coordinates and had similar shape (FIG. 8A).

### Unsupervised Segmentation Based on Activity.

An odour-response recording Rᵢ contains a 3D volume for each time point: it is a tensor with three spatial dimensions (x=128, y=128, z=24) and one time dimension: Rᵢ=(1:x, 1:y, 1:z, 1:t). For each time point tₚ, we performed spatial smoothing of Rᵢ(:, :, :, tₚ) with a 3D Gaussian kernel. We used a moving-average filter for temporal smoothing along the time dimension of Rᵢ. A mask M covering the AL served to cut out the background by element-wise multiplication with each Rᵢ. Due to elevated baseline calcium levels within the AL area, we could obtain a mask by simple Otsu thresholding of an average volume for the pre-stimulus interval. For each AL, we extracted functional clusters, i.e. clusters of voxels with correlated activity in R=[R₁, . . . , R_{N_odours}]. These clusters can be interpreted as glomeruli, especially if they have a spatial-functional match in another AL. For functional clustering, we employed a non-negative matrix-decomposition scheme solved with the ConvexCone algorithm⁷⁴ that has a track record of successful application to imaging data from different species. Briefly, R is reshaped to a matrix A with m=x*y*z rows (voxel vectors) and n=odours*time columns (time series vectors). We then decompose A into a matrix of the c most relevant time series C∈A and their spatial mappings in X, such that ∥A−CX∥_{Fr} is minimized subject to a non-negativity constraint on X. In practice, this is carried out on a rank k=50 representation of A obtained by SVD.

The continuous-valued and non-negative X acts as a fuzzy cluster membership indicator, locating the time series signals from C in space and also encoding cluster overlap due to signal mixtures, i.e. a voxel can ‘belong’ to several clusters to different degrees. For creating the 3D AL map visualizations (FIG. 8), we binarized the continuous X with algorithm 2 from a previous study⁷⁵. The solid clusters obtained were then rendered as 3D objects. We observed cases of apparent overclustering, where two or more overlapping clusters with distinguishable, but nevertheless similar, odour responses were found. This could be due to the ability to resolve actual glomerular subcompartments, or due to signal bleed-through from upper layers, which creates different signal mixtures in different subvolumes of a glomerulus. In order to resolve overclustering, we merged clusters that overlapped in the 3D AL maps and had odour-response profile (mean df/f responses) correlations greater than 0.7.

### Automated Glomerulus Matching Across Brains.

We matched glomeruli across brains if they were similar in both odour-response properties and relative position, allowing for a certain degree of physiological and anatomical variation (FIG. 8C). To simplify functional and spatial comparisons, we compressed the glomerular time series to the mean df/f responses for each odour. We then performed pairwise matching of all subject ALs to a single target AL. Matching a subject to the target can be cast as an assignment problem on a bipartite graph G=(V=(S, T), E), where the glomeruli in the subject and target AL are represented as vertices S and T, respectively, that have to be connected by a set of edges E in a way that optimizes a cost criterion. For a given cost criterion, the optimal assignment can be computed with the Hungarian algorithm^{76,77}. We minimized the (weighted) functional-spatial distance d(a,b)=w_{f}*d_{functional}(a, b)+wₛ*dₛₚₐₜᵢₐₗ(a, b), where d_{functional}(a,b) denotes the Euclidean distance between the odour-response profiles (mean df/f responses) of glomeruli a and b, while dₛₚₐₜᵢₐₗ(a, b) refers to the Euclidean distance between the centroids of glomeruli a and b that have been pre-registered into the same 3D space. All distances were normalized to remove scaling differences between functional and spatial distances.

Global optimization of d leads to a complete assignment of all glomeruli from S to all glomeruli from T. However, due to missing (glomeruli that were not detected) or additional clusters (overclustering or non-glomerular clusters) in either brain, not all glomeruli may have a meaningful match. We thus employed the Hungarian algorithm to compute all glomerulus matches that are feasible under functional and spatial constraints:
d is set to infinity if dₛₚₐₜᵢₐₗ(a, b)>cₛₚₐₜᵢₐₗ (e.g. the diameter of a typical glomerulus)
d is set to infinity if the odour response profile correlation corr(a, b)>c_{functional}

These constraints specify the criteria we demand for an acceptable match (in terms of response similarity and spatial distance), while the optimal assignment under these constraints is left to the algorithm. Whenever the constraints led to infeasible matches, the respective subject AL glomeruli were excluded from further analysis.

### Across-Matrix PCA of Common Odour Response Space.

We also pursued the alternative strategy of constructing a common odour-response space for all mosquito brains, allowing us to visualize distances between odour responses in a way that is unaffected by parameter settings (such as the number of clusters) or possible matching errors of the glomerulus-matching approach (FIG. 8H). There are N_{odours} odour-response recordings for the jth mosquito brain, R^{(j)}=[R₁, . . . , R_{N_odours}], where the sequence of odours is assumed to be the same across brains. After preprocessing the R^{(j)} (see above), we performed df/f normalization for all voxel time series in the R^{(j)}, followed by spatial median filtering to remove a few extremely high df/f values in individual voxels. The time series in the R^{(j)} were then reduced to mean odour responses during an interval after odour presentation and reshaped to matrices A^{(j)} with m=#voxels rows and n=#odours columns. We then constructed A^{(all)}=[A^{(1)T} . . . , A^{(N_brains)T}]^{T}, i.e. the (Nᵥₒₓₑₗₛ*N_{brains})×N_{odours} matrix containing the row-concatenated and whitened matrices A^{(j)}. The principal components of A^{(all)} are across-matrix principal components that span a common odour-response space for all brains. PCA provides the best rank-k approximation to A^{(all)} in the sense that it finds matrices U, V that minimize ∥A^{(all)}−UV∥_{Fr}, where V is a k×(Nᵥₒₓₑₗₛ*N_{brains}) matrix that can be partitioned as V=[V⁽¹⁾, . . . , V^{(N_brains)}]. By projecting the A^{(j)} onto the V^{(j)}, we can obtain the positions of the odour/brain combinations in the space of the top-k across-matrix principal components.

### Manual Identification of Target Glomeruli.

The three target glomeruli could be reliably identified across brains based on position and responses to key reference odorants. Human-sensitive glomerulus H was located in the anterior AL, adjacent to a landmark non-Orco glomerulus in our two-photon images (unlabeled area surrounded by Orco+ glomeruli; FIGS. 8A-B), and responded to 10⁻² heptanal. Animal-sensitive glomerulus A was located in the dorsal AL and responded to 10⁻² phenol. Broadly tuned glomerulus B was located in the posterior-medial AL and responded to 10⁻² benzaldehyde. Glomeruli H, A, and B tentatively correspond to V3, MD2, and PD1, respectively, in a previously published atlas³⁵, but we cannot be sure without molecular markers.

### Summarizing Neural Activity.

We used area under df/f curves as a metric for neural activity. For single-odorant stimuli, which evoked single df/f peaks, we defined the peak boundaries by first locating the max (for activation) or min (for inhibition) points in the df/f curve and then extending from the max/min point until df/f dropped to background levels. For natural odour extracts, which sometimes evoked multiple peaks, we integrated df/f values from desorption of the focusing trap to the end of neural recording (0 to 140 sec). To account for variation in responsiveness across brains, we normalized area values for single odorants by the response of glomerulus H to decanal (at whatever concentration was used in the given experiment), and we normalized area values for natural odour extracts by the strongest response evoked in a given brain by any odour extract used in the experiment (min-max normalization, where min is zero). We used the paraView software to render the neural responses into 3D plots⁷⁸.

### Headspace Odour Extraction

Extraction from Human Volunteers.

We modified a previously published protocol for human-body headspace odour extraction⁷⁹. Subjects were asked to bathe using an unscented soap 3 days before odour collection and then avoid the use of all soaps, skin products, swimming pools, and hot tubs thereafter. Subjects were also asked to avoid all water baths/showers, spicy food, and alcohol for 24 hours before collection. At the time of extraction, subjects lay nude inside a custom-made 80″×48″ Teflon FEP bag with 4 ports on each side (FIG. 2E middle) and covered by a privacy blanket over the bag. The bag's opening was loosely cinched around each subject's neck, and a pair of Tenax TA tubes (Markes International Inc., C1-CAXX-5003) was inserted into each of the 8 ports. A Teflon tube pushed into the bag through the neck hole provided a source of charcoal-filtered zero-grade air at 3.6 L/min (filter: Whatman 67221001; air: Airgas AIZ300). Two vacuum pumps (KNF Neuberger, UN811 KV.45P115V) were used to pull air out of the bag through the 8 ports at 400 ml/min per port (200 ml/min per Tenax tube) for 2 hours while the subject watched a movie or listened to music. We confirmed that the Tenax tubes captured all major odorants (no breakthrough) at the given flow rate and duration in test extractions where two tubes were placed in series. The bag was washed (Babyganics fragrance-free dish soap and DI water) and autoclaved before each use. Three subjects underwent replicate extractions weeks to months apart, demonstrating moderate within-individual consistency of the odour profile over time (FIG. 11E).

Extraction from Non-Human Animals, Plants, and Honey.

We collected headspace odour from quail, guinea pigs, rats, and milkweed flowers using custom-designed glass extraction chambers (FIG. 2E top; 14 cm diameter x 24 cm long or 8 cm diameter x 30 cm long). A single rat, a single guinea pig, a pair of quail, or several freshly cut milkweed inflorescences (Asclepias syriaca, leaves removed) were placed in the chamber for each extraction. We collected headspace odour from sheep wool, dog hair, and honey using a 250 ml glass gas-washing bottle (FIG. 2E bottom). Twenty-five grams of hair were packed into the bottle and heated to approximate homeothermic-vertebrate body temperature in a 37° C. water bath. For honey, we smeared 25 grams across the inner face of the bottle without heating. We used the same live animals and hair described under ‘Host-preference assays’ except that there were two quail instead of one and the pet dogs were a German Shepherd, a Yorkie, and two Portuguese Water Dogs. All extractions were supplied by charcoal-filtered zero-grade air that was pulled through one or two Tenax TA tubes (Markes International Inc., C1-CAXX-5003) using a vacuum pump (Sensidyne, Gilian 800i). Flow rate and extraction duration: rats, 200 ml/min through 1 Tenax tube for 2 hours; quail, 200 ml/min through each of 2 Tenax tubes for 2 hours; guinea pigs, milkweed, sheep wool, dog hair, and honey, 400 ml/min through 1 Tenax tube for 1 hour. We confirmed that the Tenax tubes captured all major odorants (no breakthrough) at the given flow rate and duration in test extractions where two tubes were placed in series. The glass extraction chamber and gas-washing bottle were washed (Babyganics fragrance-free dish soap and DI water) and rinsed with methanol (HPLC-grade, ≥99.9%, Sigma Aldrich) and hexane (≥99.8% for GC-MS, SupraSolv) before each extraction.

Animal waste was sometimes present in the odour-extraction chambers for guinea pig, rat, and quail and thus may have contributed to the corresponding odour samples and to the list of animal-enriched compounds^{17,44} (e.g. p-cresol and dimethyl sulfone in FIG. 11F). However, sheep odour, which came from unsoiled wool, was nested among the other animals in almost all compound-specific analyses (FIG. 11G).

### Processing of Odour Extracts.

We generated 16 Tenax tubes for each individual human (FIG. 2E middle). Since tubes had the potential to vary depending on their position in the extraction bag, we decided to pool the 16 tubes into 4 more-homogeneous aliquots using the ‘stacking’ feature of our Markes thermal desorption system (see Delivery of host-odour extracts via thermal desorption, below; FIG. 9F). Each of the 4 aliquots represented a pool of one tube from each of the four bag positions (shoulder, waist, knee, foot). We then used the Markes system to puff a small portion of the first aliquot to a new Tenax tube for GC-MS analysis and reserved the remaining samples (1 partial aliquot+3 full aliquots) for imaging. We similarly stacked and aliquoted the 12-16 tubes obtained for each animal species and for honey. For these samples, each tube or pair of tubes came from a separate extraction and had the potential to vary due to individual or day-to-day variation. For milkweed, we used a single tube without stacking because of the high odour concentration.

### Odour Analysis

### TD-GC-MS Settings.

We used an Agilent GC-MS system (Agilent Technologies, GC 7890B, MS 5977B, high-efficiency source) outfitted with a DB-624 fused-silica capillary column (30 m long x 0.25 mm I.D., d.f.=1.40 μm, Agilent 122-1334UI). Tenax tubes were inserted into a Gerstel TD3.5+ thermal-desorption unit (Gerstel Inc.) mounted on a PTV inlet (Gerstel CIS 4) with a glass-wool-packed liner. Tubes were heated in the TD unit from 50° C. to 280° C. at a rate of 400° C./min, then held at 280° C. for 3 min. During the TD heating time, volatiles were swept splitless into the cold inlet (−120° C.) under helium flow of 50 ml/min. After the tube was removed and the inlet repressurized, the inlet began heating at a rate of 720° C./min to a 3 min hold temperature of 275° C. The GC oven program began simultaneously with inlet heating, starting at an initial temperature of 40° C. and ramping at a rate of 8° C./min to a 10 min hold temperature of 220° C. Transfer from the inlet to the GC column was performed at a 20:1 split ratio (40:1 split for milkweed). Carrier-gas flow rate was 40 cm/s. The MS was operated in EI mode, scanning from m/z 40 to 250 at a rate of 6.4 Hz.

### Peak Detection.

The major steps in our analysis pipeline are illustrated in FIG. 11A. We imported the raw GC-MS data into Agilent's MassHunter Unknowns Analysis program (version B.09.00, build 9.0.647.0) and extracted peaks using the built-in deconvolution algorithm with window sizes of 25, 50, 100, and 200. We also extracted peaks using the TIC (total ion chromatogram) analysis option with a window size of 100. The deconvolution algorithm looks for correlated peaks in ion abundances and can pull apart partially co-eluting peaks. TIC analysis integrates the entire area under peaks in the total ion chromatogram. We used both algorithms in order to cast an initial broad net that would capture all potential peaks. In most cases of non-overlapping peaks, the deconvolution algorithm gave similar peak areas to TIC integration. Therefore, for the final dataset, we selected peaks found by TIC integration only in the very small number of cases where the deconvolution algorithm had clearly truncated the edges of the peak. Estimates of compound abundance directly correspond to peak areas.

### Preliminary Compound Identification.

We identified peaks by using Unknowns Analysis to search the NIST17 MS EI library for matches. The program finds the best match in the reference library for each peak (with a minimum match score of 70), then for each compound selects the peak with the highest match score. We manually selected alternate best-hit peaks (sometimes with match score below 70) if the automated choice looked non-Gaussian or was composed of misaligned component-ion peaks (implying the peak was made up of multiple co-eluting compounds). We also manually selected alternate peaks if there was an excess of background ions in the automated choice. We ensured that retention times for each compound matched across samples.

### Targeted Search for 1-Octen-3-Ol.

Because 1-octen-3-ol is known to be an important mosquito attractant despite its low abundance in host odours^{80,81}, we performed a targeted search for this compound. In 19 out of 21 samples where 1-octen-3-ol was present, the level was too low to be detected by the automated pipeline, particularly because 1-octen-3-ol co-elutes with the common compound benzaldehyde. Therefore, we wrote custom R scripts to quantify the amount of 1-octen-3-ol in our samples. We used the mzR package⁸² to access the raw GC-MS data from .mzxml files. For each sample, we fit Gaussian curves to the m/z 51 and m/z 57 ion peaks under the shared 1-octen-3-ol/benzaldehyde peak; at this retention time, these ions are diagnostic for benzaldehyde and 1-octen-3-ol, respectively. The abundance ratio of the two ions is directly proportional to the abundance ratio of the two compounds. We used this ratio to infer the amount of 1-octen-3-ol present in every sample by extrapolating from the two samples where the deconvolution algorithm successfully pulled out and integrated a separate 1-octen-3-ol peak.

### Criteria for Including Compounds in the Analysis.

In the final dataset for analysis, we retained only compounds eluting between 6 and 22 minutes. We ignored early-eluting compounds because breakthrough analysis suggested we were not able to obtain quantitative estimates of their abundance. Few compounds eluted after 22 minutes; these tended to be less volatile and more difficult to identify because of the high background. We also removed obvious contaminants: siloxane column artefacts, 4-cyanocyclohexene (a compound likely from nitrile gloves⁸³), and other components not plausibly produced by biological metabolism because they contained heteroatoms other than O, N, and S. Finally, we ignored carboxylic acids because (1) they are difficult to quantify reliably without derivatizing samples, and (2) they are not typically detected by the Orco+ neurons⁸⁴ on which we focus in this study.

We set an abundance criterion for including compounds in the analysis: for a focal compound X to qualify, it must have constituted at least 2% of the ‘odour profile’ of at least one sample, where the ‘odour profile’ comprises non-contaminant compounds just as or more abundant than X in the given sample (FIG. 11A). Because we had a large number of human samples, and in order to avoid unfairly including an excess of compounds prevalent among humans, we randomly selected a single sample to serve as the human representative for this compound-qualification step. Forty-eight compounds met our criteria (FIGS. 11B-C) and were thus quantified across all samples, regardless of abundance in any given sample.

Verification with Synthetic Standards.

We used retention-time and mass-spectrum information from external standards to verify the identities of all compounds mentioned in FIGS. 11F-I. Sources of external standards are listed in. Of the 48 compounds included in the analysis, 25 were verified by external standards, 18 were identified based only on a mass-spectrum match to the NIST 17 library, 4 were assigned a compound class but not a precise identification based on mass-spectrum characteristics, and 1 remained unidentified. Even when the identity of a compound was uncertain, we were able to use retention time and mass spectrum to reliably locate it across samples.

### XCMS-Based Analysis.

Our main odour analysis only considered compounds that constituted at least 2% of the odour profile of at least one sample. To ensure we had not overlooked any human-biased compounds that failed to meet this threshold, we also used an R implementation of XCMS metabolomics software to analyse the odour profiles of all 16 humans and 5 animals. XCMS detects and aligns peaks of component ions across samples⁸⁵. XCMS identified 1067 component ions in our dataset. We then grouped ions that eluted less than 10 s apart and whose abundance across our samples had a Pearson correlation >0.5 (suggesting they were component ions from the same compound). This grouping procedure reduced our total to 672 components. For each component, we used a Kolmogorov-Smirnov test to look for enrichment in human or animal samples, applying the Benjamini-Hochberg procedure to correct for multiple testing (FIGS. 6H-I). We manually assigned significantly enriched components to compounds using retention-time and mass-spectral information. Note that the grouping algorithm failed to group all components that correspond to a given compound.

### Odour Stimulus Preparation and Delivery

### Delivery of Host-Odour Extracts Via Thermal Desorption.

We adapted a thermal-desorption (TD) system marketed for GC-MS applications to deliver complex odour extracts from Tenax tubes to mosquitoes during imaging. The Unity-Ultra-xr TD system from Markes International Inc. uses a 2-step desorption procedure (FIG. 2F). The sorbent tube containing the sample is heated slowly to a high temperature to desorb odorants, which are carried by nitrogen flow to a cold, sorbent-filled focusing trap. The focusing trap is extremely narrow and can therefore be heated ballistically (to 220° C. in 3 sec) to release all odorants during a very short time window-more or less simultaneously. For GC-MS applications, the odorants then enter the GC, and the focusing step serves to narrow the GC-MS peaks. In our case, we connected the output flow of the TD system to the mixing manifold of our odour-delivery system (see below, Delivery of synthetic odorants and blends) and used a thermocouple thermometer (AMPROBE, TMD-52) to confirm that the final mixed flow (TD output+carrier air) was at room temperature. We then optimized puff shape and duration for imaging by increasing the flow rate through the cold focusing trap (to 30-120 ml/min depending on split-flow ratio) and setting a high dilution ratio at the mixing manifold (1:30, TD output to carrier air). Using a photoionization detector (PID; Aurora, 200B), we observed a single ˜3 sec peak for single odorants, mixtures of two odorants, and human extracts (FIGS. 9A-C). However, not all compounds in the odour extracts are detected well by a PID. We therefore also collected on a Tenax tube the odour stream coming from the delivery system for 10, 20, or 30 seconds following the odour-release command and analysed the collected volatiles via GC-MS. Most components were released within the first 3-7 seconds (10 sec relative to the release command given a 3-sec delivery delay), with a few late-eluting compounds requiring longer to fully desorb (FIG. 9D-E).

We relied on two additional features of the Unity-Ultra-xr TD system to precisely control and standardize odour stimuli across individual puffs and mosquitoes. First, we used the ‘stacking’ feature to pool multiple odour tubes from the same or different extractions and thereby generate concentrated, homogeneous extracts for each animal species or human individual (FIG. 9F; see also Headspace odour extraction—Processing of odour extracts, above). Stacking is achieved by desorbing tubes onto the focusing trap one after the other, while maintaining the trap at a constant, low temperature (30° C.). The accumulated odour is then released via ballistic heating and collected on a new tube.

Second, we used the ‘split-recollect’ feature to dispense concentration-matched aliquots for use in imaging (FIGS. 2F-G; FIG. 9F). This feature allowed us to puff a specific percentage of a sample to a new tube (or the mosquito) by splitting the flow during desorption of the focusing trap. Moreover, the leftover portion can be recollected for future use. The percentage puffed is precisely determined by the split-flow ratio. We adjusted the ratio based on the total volatile content of a stacked sample (estimated via prior GC-MS analysis) to generate aliquots of equivalent dose across diverse odour stimuli (FIG. 2G; FIG. 9F).

We also used the split-recollect feature to deliver a prespecified percentage of each concentration-matched aliquot to the mosquito during imaging and recollect the remainder. We desorbed the sample tube for 2 min with the temperature ramping to 200° C. and then desorbed the focusing trap for 1 min at 220° C. (FIG. 9D). The trap was then cooled to 30° C. over a period of 25 sec, with continuing nitrogen flow, before the output valve closed. We adjusted the split-flow rate (fraction of odour puffed versus recollected) to standardize dose across mosquitoes. For each mosquito, we randomized the order of delivery of stimuli and waited for approximately 10 min between stimuli. We used a PID and GC-MS to verify that both the absolute quantity of odour extract delivered and the ratios of constituent components were stable across at least 10 replicate puffs using this split-recollect feature (FIG. 2H; FIG. 9G).

To define a standard dose, we selected one reference subject whose total odour content was approximately average among all human subjects. We then defined the 1× human dose such that the release rate from the odour-delivery system was approximately equal to the release rate from the reference subject's body during odour extraction. This is similar to funnelling all the odour from a human subject into a narrow tube and aiming it at the mosquito in real time. Our calculation took into account the duration of the odour extraction, the number of collection tubes, the duration of the odour puff, and dilution of the odour stream by the carrier stream in our odour-delivery system. 1× doses of other stimuli were defined as having the same total odour content as 1× human.

### Selection of Single-Odorant Panel.

Our single-odorant panel was made up of three groups of compounds. The first group included compounds identified in our human or animal odour samples-more specifically those that made up ≥0.1% of the extract of any species (after averaging across individuals within the species). The second group included 13 compounds that were not identified in our samples, but suggested by previous research to be relevant to mosquitoes. The third group included five compounds that are chemically similar to decanal and undecanal (i.e., similar chemical formula and general molecule shape, but in most cases with different functional groups) and had been documented at least once in nature. In order to make the final panel, compounds in all three groups also had to be (1) commercially available, (2) stable during delivery, and (3) volatile enough to be detectable by GC-MS for dose calibrations. Altogether, the panel comprised 50 compounds.

### Estimation of Vapour-Phase Concentration of Synthetic Odorants and Blends.

We developed a method to measure the volatility of single odorants based on a previously published study⁸⁶ (FIG. 5A). We first made standard dilutions of single odorants in paraffin oil or water. For a given odorant, the exact dilution ratio (neat, 10⁻², 10⁻³, or 10⁻⁴) was chosen based on published or predicted vapour pressure (SRC PHYSPROP Database) in order to keep concentrations within a similar range appropriate for GC-MS analysis. We then used our high-throughput odour-delivery system (see next section) to sequentially puff the odorants to a conditioned Tenax tube (instead of to a mosquito). Each Tenax tube contained single puffs of 4-6 different odorants, and each odorant was puffed to 3 independent tubes. We then analysed the tubes via TD-GC-MS, quantified the peak area for each odorant, averaged across replicates, and back-calculated the volatility of each odorant in our set-up. These estimates were used to calculate new liquid dilution factors and the entire process repeated until we achieved desired vapour-phase concentrations (FIG. 5A).

### Delivery of Synthetic Odorants and Blends.

We designed and built a high-throughput system to deliver synthetic odorants and blends during imaging. Our design was inspired by the commercial Aurora 206A system but has 20 odour channels and a flush stream. We briefly describe the system here, with more detail in FIG. 12. The system includes a humidified carrier air stream, an odour stream with separate channels for twenty 40 ml odour-dilution bottles (Scientific, 12-100-108), and a CO₂ stream. The odour and CO₂ streams are also each coupled to their own control stream that serves to equalize total flow when the stimulus is not being delivered. A final high-flow flush stream purges the flow path of the odour stream between puffs to remove traces of the previous stimulus. Mass-flow controllers (Aalborg, GFCS-010007 and GFCS-010008) dynamically regulate the flow through all streams except the flush, and a PTFE manifold (Cole-Palmer, EW-31521-13) acts as a final mixing station. All valves (3-way, Cole-Palmer UX-01540-11; 2-way, Pneumadyne S10MM-20-12-3 and MSV10-12) and mass-flow controllers are controlled by Arduino boards (Arduino Mega 2560 r3, Uno r3). We wrote an open-source GUI in Python to control the odour-delivery system and trigger image acquisition

We prepared an odorant panel by filling each of the twenty 40 ml odour vials with 3 ml of odorant dilution. When switching in a new odorant panel, we flushed the flow path of the system with hexane and purged it overnight with filtered air to remove potential traces of the previous panel. We characterized the puff shape (FIG. 12B) and long-term stability (FIG. 12C) of our system using a PID, with 2-heptanone as the test odorant.

During imaging, we recorded the neural response of each mosquito to 2-3 replicate, 3-second puffs per odorant, presented in random order with an inter-puff interval of 60-90 sec. We also recorded the baseline response for a given odour channel (clean air passing through the channel's valves/tubing but bypassing the odour bottle) and the response to solvent only and subtracted these from the response to stimulus. We used odorants of the highest commercially available purity and diluted them in paraffin oil (Hampton Research, HR3-421) or ultrapure water (Table 2).

### Wind Tunnel Assays

### Wind Tunnel Setup and Trials.

The wind tunnel system, flight arena and data acquisition were previously described in detail⁸⁷. In brief, laminar, carbon-filtered, and conditioned air (27° C., 70% RH, wind speed 0.22 m/s) was passed through a pre-chamber, where carbon dioxide (CO₂) and the specific odour stimuli were presented, and into the flight arena, where individual mosquitoes were released (FIG. 6D). Two infrared (IR) sensitive cameras recorded the reflection of IR light on the bodies and wings of the mosquitoes at 60 frames/s. The volume covered by both cameras included 120 cm at the upwind end of the flight chamber (filmed volume; blue box in FIG. 6D). The flight arena was adjusted for day-active mosquitoes by adding visual cues to the floor of the wind tunnel (metal washers, 20 mm diameter) and increasing the intensity of visible white light to 10-50 lux.

We tested females that were 7-12 days old (post-eclosion), mated (housed with males), and non-blood-fed. Females were deprived of sucrose, but not water, and transferred to individual release cages 17-20 h before testing. For each trial, a release cage containing a single female was placed at the downwind end of the flight chamber. After an acclimation period of 2 min, the door of the release cage was gently opened and the mosquito was given 5 min to enter the filmed volume. If the mosquito entered the filmed volume, the filming continued for 10 min or until either (1) the mosquito landed and remained at rest for 10 s or (2) the mosquito left the filmed volume towards the downwind end of the flight arena and remained out of view for 1 min. We tested thirty females per treatment, and each mosquito was tested once. All trials were conducted within a 3-hour period before scotophase.

### Formulation of the Binary Blend.

We used 2P calcium imaging to identify concentrations of 1-hexanol and decanal that evoked activity in their cognate glomeruli (B and H, respectively) at a level approximately equal to ⅕th that evoked by 1× human odour. The odorants were diluted in paraffin oil and calibrated separately before creating a binary mixture with the same respective concentrations. This binary mixture, which we defined as the 1/5× blend, evoked simultaneous activity in B and H at the expected level, but no detectable activity in any other Orco+glomeruli (FIG. 6C).

The odour-delivery system we use for imaging is designed to generate consistent 3-sec puffs of odour, but we needed to stably deliver the blend for 10 minutes or more during behavioural trials. We therefore switched from the 3 ml stimulus solution in a 40 ml vial to a 50 ml solution in a 100 ml flask. To ensure that the vapour-phase release rates of each blend component in the new high-volume system matched those used for imaging, we captured and quantified the odour released by both systems over a given period of time using Tenax collection tubes and GC-MS (as in Estimation of vapour-phase concentration of synthetic odorants and blends). The liquid-phase dilution factors for the ⅕× blend in the high-volume system were then repeatedly adjusted to achieve the release rates of the imaging system. Finally, we increased the concentration of the high-volume ⅕× blend by 5 to obtain the 1× dose and serially diluted by factors of 5 to obtain the 1/25× and 1/125× doses. See Table 2, below, for recipe and final dilution factors.

TABLE 2
Recipe for binary blends used in the wind tunnel experiments (FIG. 6, FIG. 14).

| | | | 1- | | | | |
|---|---|---|---|---|---|---|---|
| | | Decanal | Hexanol | | | | |
| | Odour | target | target | | Solvent | | |
| Blend | delivery | dilution | dilution | | (paraffin | | Total |
| dose | system | (v/v) | (v/v) | Odorant input | oil) | | volume |
| 1X | Wind- | 4.13E−03 | 6.50E−04 | 268.5 ul pure decanal; | 60.51 | ml | 65 ml |
| | tunnel | | | 4225 ul 1.00E−02 | | | |
| | setup | | | 1-hexanol | | | |
| 1/5X | Wind- | 8.27E−04 | 1.30E−04 | 13 ml 1X blend | 52 | ml | 65 ml |
| | tunnel | | | solution | | | |
| | setup | | | | | | |
| 1/25X | Wind- | 1.65E−04 | 2.60E−05 | 13 ml 1/5X blend | 52 | ml | 65 ml |
| | tunnel | | | solution | | | |
| | setup | | | | | | |
| 1/125X | Wind- | 3.31E−05 | 5.20E−06 | 10 ml 1/25X blend | 40 | ml | 50 ml |
| | tunnel | | | solution | | | |
| | setup | | | | | | |
| 1/5X | Imaging | 2.56E−03 | 2.11E−04 | 25.6 ul pure decanal; | 9.76 | ml | 10 ml |

| | |
|---|---|
| setup | 211 ul 1.00E−02 |
| | 1-hexanol |

### Odour Delivery in Wind Tunnel.

CO₂ was delivered alongside the specific odour stimulus in all trials. Metered CO₂ of 1200 ppm (in 20.0% O₂, 79.9% N₂; Strandmöllen A B, Ljungby, Sweden) was presented using a glass hoop with equidistant holes to create a turbulent flow⁴⁵, adjusted to a flow rate of 0.4 L/min. The synthetic binary blend, its individual components, and solvent controls were delivered by pumping carbon-filtered, humidified air at 0.4 L/min through a 100 ml Erlenmeyer flask containing 50 ml of the stimulus (see above). The system terminated in a glass tip, pointing upwind to generate a homogeneous plume. The shape and dimensions of both the CO₂ and specific odour plumes were verified using smoke paper (Günther Schaidt SAFEX Chemie GmbH, Tangstedt, Germany). To help characterize host-seeking flight patterns, we also conducted trials with a cotton sock that had been worn by a human for 20 h. The sock was suspended from a metal hook in the pre-chamber⁸⁷.

### Wind Tunnel Data Analysis

Spatial Progression within the Flight Arena.

We manually recorded whether each mosquito (1) left the release cage within 5 min and (2) entered the filmed volume (FIG. 6D). Using data from the flight trajectories of mosquitoes that entered the filmed volume (see below), we also determined (3) whether they made contact with the target area of the upwind screen (16 cm diameter×2 cm length cylinder centred over the odour plume; red dashed circle in FIG. 6D). The fraction of mosquitoes sequentially reaching each of these behavioural stages was calculated and the progression treated as survival data for statistical analysis (FIG. 6F-J). To test the effect of the odour treatment on the sequential progression and for pairwise comparison between treatments, we used Cox proportional hazards models and likelihood ratio tests, implemented in R⁵⁶ (versions 3.5.1, 4.1.0) using the survival package (version 3.2.11).

### Flight-Trajectory Reconstruction.

Mosquito flight trajectories were reconstructed, processed, and analysed as previously described⁸⁷, using Etho Vision XT 40 and Track 3D (Noldus Information Technology), as well as customized Matlab scripts (version R2020a; MathWorks, Natick, MA, US). Variables calculated and used for subsequent analyses included the position in three dimensions (x, y, z), flight speed in 3D, tortuosity in 3D, and heading angle in the vertical plane.

### Identification of Host-Seeking Flight.

Host-seeking flight was assessed visually and via automated analysis. Visual classification of host seeking was conducted by the experimenter based on, e.g., zigzagging crosswind flight, sharp crosswind turns upon exiting the approximated volume of the plume, and a generally high flight speed (e.g. ref^{45,88} for Aedes aegypti). A mosquito exhibiting even a relatively short bout of such behaviour was considered to have displayed host seeking (FIGS. 6G and K).

To identify host-seeking mosquitoes more objectively, we also conducted an automated analysis aimed at both (1) assessing whether an individual showed even a single short bout of host seeking (FIGS. 6H and L) and (2) quantifying the amount of time a mosquito spent host seeking (FIGS. 6J and M). We first divided the flight trajectories of each mosquito that entered the filmed volume into 10-second segments (sliding window with 5-second overlap; other segment durations produced similar final results). We then calculated five flight parameters for each segment: mean speed, mean tortuosity in 3D, proportion of flight inside the plume, proportion of flight in crosswind direction, and mean flight speed in crosswind direction. The plume was approximated as a cylinder with a diameter of 14 cm, centred within the flight arena (FIGS. 6D-E). Crosswind flight was defined as flight with a heading angle of 60-120° or 240-300°, where 180° corresponds to straight upwind flight. For variable calculation, positions within 6 cm of the upwind screen were excluded to diminish the effect of the physical boundary. We then assessed the extent to which each of these parameters could predict host-seeking flight by asking whether they contributed to the separation of flight segments from human-worn sock trials and solvent control trials in a multivariable logistic regression. One parameter, proportion of time spent in the plume, had much more predictive power than any of the others (FIG. 14A); mosquitoes exposed to human-worn socks spent much more of each segment in the plume than those exposed to solvent (FIG. 14B). We therefore decided to set a simple threshold, whereby flight segments during which a mosquito spent more than X proportion of their time in the plume were considered ‘host-seeking’. Since behavioural intensity can vary from experiment to experiment based on mosquito condition and external factors (e.g. barometric pressure), we separately normalized proportion-in-plume data from the dose-response experiment (FIGS. 6H and I) and binary blend vs individual-component experiment (FIGS. 6L-M), setting a z-score threshold of 0.5. While arbitrary, this threshold allowed separation of human-worn sock and solvent segments (FIG. 14B), and alternative cutoffs ranging from 0 to 2 produced the same qualitative results. We assessed whether individual mosquitoes displayed at least a single bout of host seeking (≥1 segment above threshold; FIGS. 6H and L) and the number of bouts of host seeking displayed by each mosquito (FIGS. 6I and M). Females that did not enter the filmed volume were classified as having displayed no host seeking.

We also conducted a second analysis in which all five parameters were used to classify host-seeking segments. We used k-means clustering to separate into three clusters the pooled segments from all mosquitoes in a given experiment. Three clusters were used because we wanted to separate host-seeking flight from non-host-seeking flight, while also accounting for the fact that many 10-second segments included very little flight at all (zero values for one or more parameters). The results were similar to those obtained with the simple proportion-in-plume threshold (FIGS. 14E-H).

### SUPPLEMENTARY REFERENCES

51. Younger, M. A. et al. Non-canonical odor coding ensures unbreakable mosquito attraction to humans. bioRxiv 2020.11.07.368720 (2020) doi:10.1101/2020.11.07.368720.
52. Shankar, S. et al. Synergistic coding of human odorants in the mosquito brain. (2020) doi:10.1101/2020.11.02.365916.
53. Yang, L., Agramonte, N., Linthicum, K. J. & Bloomquist, J. R. A survey of chemoreceptive responses on different mosquito appendages. J. Med. Entomol. (2020) doi:10.1093/jme/tjaa154.
54. Chen, Z., Liu, F. & Liu, N. Human odour coding in the yellow fever mosquito, Aedes aegypti. Sci. Rep. 9, 13336 (2019).
55. Zhao, Z., Tian, D. & McBride, C. S. Development of a pan-neuronal genetic driver in Aedes aegypti mosquitoes. Cell Rep. Methods 1, (2021).
56. R Core Team. R: A language and environment for statistical computing. (2018).
57. Brooks, M. E. et al. glmmTMB balances speed and flexibility among packages for zero-inflated generalized linear mixed modeling. R J. 9, 378-400 (2017).
58. Lenth, R., Singmann, H., Love, J., Buerkner, P. & Herve, M. Emmeans: estimated marginal means, aka least-squares means. R Package Version 1, (2018).
59. Riabinina, O. et al. Improved and expanded Q-system reagents for genetic manipulations. Nat. Methods 12, 219-222 (2015).
60. Matthews, B. J., Younger, M. A. & Vosshall, L. B. The ion channel ppk301 controls freshwater egg-laying in the mosquito Aedes aegypti. eLife 8, e43963 (2019).
61. Chen, T.-W. et al. Ultrasensitive fluorescent proteins for imaging neuronal activity. Nature 499, 295-300 (2013).
62. Matthews, B. J. et al. Improved reference genome of Aedes aegypti informs arbovirus vector control. Nature 563, 501-507 (2018).
63. Cardona, A. et al. TrakEM2: software for neural circuit reconstruction. PLOS ONE 7, e38011 (2012).
64. Rueden, C. T. et al. ImageJ2: ImageJ for the next generation of scientific image data. BMC Bioinformatics 18, 529 (2017).
65. Shankar, S. & McMeniman, C. J. An updated antennal lobe atlas for the yellow fever mosquito Aedes aegypti. PLOS Negl. Trop. Dis. 14, e0008729 (2020).
66. Grabe, V., Strutz, A., Baschwitz, A., Hansson, B. S. & Sachse, S. Digital in vivo 3D atlas of the antennal lobe of Drosophila melanogaster. J. Comp. Neurol. 523, 530-544 (2015).
67. Jové, V. et al. Sensory discrimination of blood and floral nectar by Aedes aegypti mosquitoes. Neuron 108, 1163-1180.e12 (2020).
68. Stern, D. L. Tagmentation-based mapping (TagMap) of mobile DNA genomic insertion sites. http://biorxiv.org/lookup/doi/10.1101/037762 (2016) doi:10.1101/037762.
69. Fan, G. Y. et al. Video-rate scanning two-photon excitation fluorescence microscopy and ratio imaging with cameleons. Biophys. J. 76, 2412-2420 (1999).
70. Botcherby, E. J., Juškaitis, R., Booth, M. J. & Wilson, T. An optical technique for remote focusing in microscopy. Opt. Commun. 281, 880-887 (2008).
71. Botcherby, E. J. et al. Aberration-free three-dimensional multiphoton imaging of neuronal activity at kHz rates. Proc. Natl. Acad. Sci. 109, 2919-2924 (2012).
72. Pologruto, T. A., Sabatini, B. L. & Svoboda, K. ScanImage: flexible software for operating laser scanning microscopes. Biomed. Eng. OnLine 2, 13 (2003).
73. Pnevmatikakis, E. A. & Giovannucci, A. NoRMCorre: an online algorithm for piecewise rigid motion correction of calcium imaging data. J. Neurosci. Methods 291, 83-94 (2017).
74. Strauch, M., Rein, J., Lutz, C. & Galizia, C. G. Signal extraction from movies of honeybee brain activity: the ImageBee plugin for KNIME. BMC Bioinformatics 14, S4 (2013).
75. Strauch, M., Rothermel, M., Wachowiak, M. & Merhof, D. Smoothness-constrained convex cone analysis for signal extraction from calcium imaging movies. in 2016 IEEE 13th International Symposium on Biomedical Imaging (ISBI) 612-616 (2016). doi:10.1109/ISBI.2016.7493342.
76. Kuhn, H. W. The Hungarian method for the assignment problem. Nav. Res. Logist. Q. 2, 83-97 (1955).
77. Cao, Y. Hungarian algorithm for linear assignment problems (V2.3). MATLAB Central File Exchange https://www.mathworks.com/matlabcentral/fileexchange/20652-hungarian-algorithm-for-linear-assignment-problems-v2-3 (2020).
78. Ahrens, J., Geveci, B. & Law, C. ParaView: an end-user tool for large-data visualization, in Visualization Handbook 717-731 (Elsevier, 2005). doi:10.1016/B978-012387582-2/50038-1.
79. Harraca, V., Ryne, C., Birgersson, G. & Ignell, R. Smelling your way to food: can bed bugs use our odour? J. Exp. Biol. 215, 623-629 (2012).
80. Takken, W. & Kline, D. L. Carbon dioxide and 1-octen-3-ol as mosquito attractants. J. Am. Mosq. Control Assoc. 5, 311-316 (1989).
81. Hall, D. R., Beevor, P. S., Cork, A., Nesbitt, B. F. & Vale, G. A. 1-Octen-3-ol. A potent olfactory stimulant and attractant for tsetse isolated from cattle odours. Int. J. Trop. Insect Sci. 5, 335-339 (1984).
82. Chambers, M. C. et al. A cross-platform toolkit for mass spectrometry and proteomics. Nat. Biotechnol. 30, 918-920 (2012).
83. Oishi, G. Y., Brown, J. L., Shimelis, O. I. & Schultz, K. L. Sampling technique for qualitative volatile headspace outgassing from solid matrices. Supelco Report. 31.3, 19-21 (2013).
84. Silbering, A. F. et al. Complementary function and integrated wiring of the evolutionarily distinct Drosophila olfactory subsystems. J. Neurosci. 31, 13357-13375 (2011).
85. Smith, C. A., Want, E. J., O'Maille, G., Abagyan, R. & Siuzdak, G. XCMS: processing mass spectrometry data for metabolite profiling using nonlinear peak alignment, matching, and identification. Anal. Chem. 78, 779-787 (2006).
86. Cometto-Muñiz, J. E., Cain, W. S. & Abraham, M. H. Quantification of chemical vapors in chemosensory research. Chem. Senses 28, 467-477 (2003).
87. Hinze, A., Lantz, J., Hill, S. R. & Ignell, R. Mosquito Host Seeking in 3D Using a Versatile Climate-Controlled Wind Tunnel System. Front. Behav. Neurosci. 15, (2021).
88. Dekker, T., Geier, M. & Cardé, R. T. Carbon dioxide instantly sensitizes female yellow fever mosquitoes to human skin odours. J. Exp. Biol. 208, 2963-2972 (2005).

1: A composition for attracting or repelling mosquitoes comprising:
a first component capable of activating or inhibiting a broadly-tuned glomerulus of a mosquito;
a second component capable of activating or inhibiting a human-sensitive glomerulus of the mosquito; and
a solvent.

2: The composition of claim 1, wherein the first component is capable of activating the broadly-tuned glomerulus, and the second component is capable of activating the human-sensitive glomerulus.

3: The composition of claim 1, wherein the first component is capable of inhibiting the broadly-tuned glomerulus, and the second component is capable of inhibiting the human-sensitive glomerulus.

4: The composition of claim 1, wherein the first component is 1-hexanol.

5: The composition of claim 1, wherein the second component is an aldehyde.

6: The composition of claim 5, wherein the aldehyde is a substituted or unsubstituted alkyl aldehyde with a carbon chain length of at least 6.

7: The composition of claim 5, wherein the aldehyde comprises one or more of octanal, nonanal, decanal, and undecanal.

8-9. (canceled)

10: The composition of claim 1, wherein the concentration of the first component (v/v) is between 0.001% (v/v) and 0.5% (v/v) or between 0.015% (v/v) and 0.1% (v/v).

11. (canceled)

12: The composition of claim 1, wherein the concentration of the second component (v/v) is between 0.0001% (v/v) and 0.1% (v/v) or between 0.001% (v/v) and 0.02% (v/v).

13. (canceled)

14: The composition of claim 1, wherein the ratio of the concentration of the first component (v/v) to the concentration of the second component (v/v) in the is between 0.01:1 and 10:1 or between 0.1:1 and 0.2:1.

15-16. (canceled)

17: A method of attracting or repelling mosquitos, comprising:
providing a composition comprising:
a first component capable of activating or inhibiting a broadly-tuned glomerulus of a mosquito; and
a second component capable of activating or inhibiting a human-sensitive glomerulus of the mosquito; and
a solvent; and
allowing the composition to be detected by the mosquito.

18: The method of claim 17, wherein the broadly-tuned glomerulus and the human-sensitive glomerulus both activate, thereby attracting the mosquito.

19: The method of claim 17, wherein at least one of the broadly-tuned glomerulus and the human-sensitive glomerulus are inhibited, thereby repelling the mosquito.

20: A mosquito attractant formulation comprising:
1-hexanol;
an aldehyde component of one or more aldehydes; and
a solvent;
wherein the formulation mimics the neural activity evoked by human odor in the mosquito brain.

21: The formulation of claim 20, wherein the aldehyde component comprises one or more of octanal, nonanal, decanal, and undecanal.

22. (canceled)

23: The formulation of claim 20, further comprising a mosquito toxicant and/or a mosquito growth regulator.

24: The formulation of claim 20, wherein the formulation is essentially free of one or more oflimonene, pinene, benzaldehyde, tetradecane, 1-octen-3-ol, acetoin, dimethylsulfone, or p-cresol.

25-27. (canceled)

28: The formulation of claim 20, further comprising a ketone component of sulcatone and/or geranyl-1 acetone.

29-30. (canceled)

31: A mosquito trap comprising: a) a trapping chamber or adhesive; and b) a mosquito attractant composition positioned to attract a mosquito, wherein the mosquito attractant composition comprises a suitable carrier and an effective amount of the formulation of claim 20.

32.: A method of attracting mosquitos comprising:
applying to an area a formulation of claim 20; and
allowing the formulation to be detected by the mosquito.

33-37. (canceled)
